(19) United States
(12) Patent Application Publication
(10) Pub. No.: US 2025/0106630 A1
(43) Pub. Date: Mar. 27, 2025

(54) SYSTEM AND MANAGEMENT SERVER

(71) Applicant: TOYOTA JIDOSHA KABUSHIKI KAISHA, Toyota-shi (JP)

(72) Inventors: Teruyoshi FUJIWARA, Toyota-shi (JP); Iwao Nitta, Nagoya-shi (JP); Ryota Suzuki, Ikeda-shi (JP)

(73) Assignee: TOYOTA JIDOSHA KABUSHIKI KAISHA, Toyota-shi (JP)

(21) Appl. No.: 18/804,265

(22) Filed: Aug. 14, 2024

(30) Foreign Application Priority Data
Sep. 22, 2023 (JP) 2023-159194

(51) Int. Cl. H04W 12/069; H04W 4/02; H04W 4/40; H04W 4/80

(52) U.S. Cl. CPC H04W 12/069; H04W 4/025; H04W 4/40; H04W 4/80

(57) ABSTRACT

A management server according to one aspect of the present disclosure accepts setting of a correspondence relation between a first target and a second target in response to a linking demand. In a case where a predetermined condition is not satisfied, the management server acquires authentication results of both the first target and the second target and sets the correspondence relation in accordance with success in authentication of both the first target and the second target in the acquired authentication results. On the other hand, in a case where the predetermined condition is satisfied, authentication of at least one target out of the first target and the second target is omitted. The management server acquires an authentication result of the other target and sets the correspondence relation in accordance with success in authentication of the other target in the acquired authentication result.

### CROSS REFERENCE TO THE RELATED APPLICATION

This application claims the benefit of Japanese Patent Application No. 2023-159194, filed on Sep. 22, 2023, which is hereby incorporated by reference herein in its entirety.

### BACKGROUND

### Technical Field

The present disclosure relates to a system, a management server, and a program.

### Description of the Related Art

Japanese Patent Laid-Open No. 2022-140747 proposes a charge collection system for collecting a charge for a service from a user of a vehicle by utilizing a medium such as a card. Specifically, the charge collection system proposed in Japanese Patent Laid-Open No. 2022-140747 is configured to allocate a charge of a toll of an expressway by a target hired car to a target user based on a correspondence relation (charge information, registration information, payment information, and use information) of an ID of an electronic toll collection system (ETC) card, a car rental company, date and time of use of the hired car, and a user of the hired car.

### SUMMARY

One of the objects of the present disclosure is to provide a technique for tracking a use relation between a first target and a second target while maintaining security and reducing trouble of the tracking.

A system according to a first aspect of the present disclosure includes a management server, a first terminal of a first target, and a second terminal of a second target. At least one of the first terminal or the second terminal is configured to transmit a linking demand to the management server in accordance with occurrence of a use relation between the first target and the second target. The management server is configured to set a correspondence relation between the first target and the second target based on the linking demand. Setting the correspondence relation includes, in a case where a predetermined condition is not satisfied, setting the correspondence relation between the first target and the second target in accordance with acquisition of authentication results of both the first target and the second target and success in authentication of both the first target and the second target in the acquired authentication results of the first target and the second target, and in a case where the predetermined condition is satisfied, setting the correspondence relation between the first target and the second target in accordance with, while omitting authentication of one target out of the first target and the second target, acquisition of an authentication result of the other target and success in authentication of the other target in the acquired authentication result.

A management server according to a second aspect of the present disclosure includes a processor configured to execute setting of a correspondence relation between a first target and a second target based on a linking demand transmitted from at least one of a first terminal of the first target or a second terminal of the second target upon occurrence of a use relation between the first target and the second target. Setting the correspondence relation includes, in a case where a predetermined condition is not satisfied, setting the correspondence relation between the first target and the second target in accordance with acquisition of authentication results of both the first target and the second target and success in authentication of both the first target and the second target in the acquired authentication results of the first target and the second target, and in a case where the predetermined condition is satisfied, setting the correspondence relation between the first target and the second target in accordance with, while omitting authentication of one target out of the first target and the second target, acquisition of an authentication result of the other target and success in authentication of the other target in the acquired authentication result.

A program according to a third aspect of the present disclosure is a program for causing a management server to set a correspondence relation between a first target and a second target by causing a first terminal of the first target to transmit a linking demand to the management server or transmit the linking demand in cooperation with a second terminal of the second target or causing the second terminal to transmit the linking demand upon occurrence of a use relation between the first target and the second target. In a case where a predetermined condition is not satisfied, the linking demand includes authentication requests for the first target and the second target, and setting the correspondence relation between the first target and the second target includes setting the correspondence relation between the first target and the second target in accordance with success in authentication of both the first target and the second target executed based on the authentication requests. In a case where the predetermined condition is satisfied, an authentication request for one target out of the first target and the second target is omitted, the linking demand includes an authentication request for the other target, and setting the correspondence relation between the first target and the second target includes setting the correspondence relation between the first target and the second target in accordance with success in authentication of the other target executed based on the authentication request.

A management server according to a fourth aspect of the present disclosure includes a processor configured to execute setting of a correspondence relation between a first target and a second target based on a linking demand transmitted from at least one of a first terminal of the first target or a second terminal of the second target upon occurrence of a use relation between the first target and the second target. Setting the correspondence relation includes, in a case where a predetermined condition is not satisfied, setting the correspondence relation between the first target and the second target in accordance with acquisition of an authentication result of at least one of the first target or the second target and success in authentication in the acquired authentication result, and in a case where the predetermined condition is satisfied, setting the correspondence relation between the first target and the second target in accordance with receipt of the linking demand while omitting authentication of both the first target and the second target.

A program according to a fifth aspect of the present disclosure is a program for causing a management server to set a correspondence relation between a first target and a second target by causing a first terminal of the first target to transmit a linking demand to the management server or transmit the linking demand in cooperation with a second terminal of the second target or causing the second terminal to transmit the linking demand upon occurrence of a use relation between the first target and the second target. In a case where a predetermined condition is not satisfied, the linking demand includes an authentication request for at least one of the first target or the second target, and setting the correspondence relation between the first target and the second target includes setting the correspondence relation between the first target and the second target in accordance with success in authentication of at least one of the first target or the second target executed based on the authentication request. In a case where the predetermined condition is satisfied, authentication requests for both the first target and the second target are omitted from the linking demand, and setting the correspondence relation between the first target and the second target includes setting the correspondence relation between the first target and the second target in accordance with receipt of the linking demand.

According to the present disclosure, it is possible to provide a technique for tracking a use relation between a first target and a second target while maintaining security and reducing trouble of the tracking.

### BRIEF DESCRIPTION OF THE DRAWINGS

FIG. 1 schematically illustrates one example of a scene to which the present disclosure is applied;

FIG. 2 schematically illustrates an example of the scene to which the present disclosure is applied;

FIG. 3A schematically indicates one example of linking information according to the present embodiment;

FIG. 3B schematically indicates one example of user information according to the present embodiment;

FIG. 3C schematically indicates one example of mobile body information according to the present embodiment;

FIG. 4 schematically illustrates one example of data exchange according to the present embodiment;

FIG. 5 schematically illustrates one example of a process of linking release according to the present embodiment;

FIG. 6 schematically illustrates one example of a predetermined condition according to the present embodiment;

FIG. 7 schematically illustrates one example of the predetermined condition according to the present embodiment;

FIG. 8 schematically indicates one example of confirmation processing of use continuation according to the present embodiment;

FIG. 9 schematically illustrates one example of a scene in which the linking information is used according to the present embodiment;

FIG. 10A schematically illustrates one example of a hardware configuration of a management server according to the present embodiment;

FIG. 10B schematically illustrates one example of a hardware configuration of a first server according to the present embodiment;

FIG. 10C schematically illustrates one example of a hardware configuration of a second server according to the present embodiment;

FIG. 10D schematically illustrates one example of a hardware configuration of a first terminal according to the present embodiment;

FIG. 10E schematically illustrates one example of a hardware configuration of a second terminal according to the present embodiment;

FIG. 11 schematically illustrates one example of software configurations of respective devices according to the present embodiment;

FIG. 12A indicates one example of processing procedure of linking setting according to the present embodiment;

FIG. 12B indicates one example of processing procedure of linking release according to the present embodiment;

FIG. 13 schematically illustrates another example of the scene to which the present disclosure is applied;

FIG. 14 schematically indicates one example of a processing process of authentication in a case where a first authentication method is employed;

FIG. 15 schematically indicates one example of a processing process of authentication in a case where a second authentication method is employed;

FIG. 16 schematically indicates one example of a processing process of authentication in a case where a 3-1-th authentication method is employed;

FIG. 17A schematically indicates one example of a processing process of authentication for a first target in a case where the 3-2-th authentication method is employed;

FIG. 17B schematically indicates one example of a processing process of authentication for a second target in a case where the 3-2-th authentication method is employed;

FIG. 18A schematically indicates one example of a processing process of authentication for the first target in a case where a fourth authentication method is employed; and

FIG. 18B schematically indicates one example of a processing process of authentication for the second target in a case where the fourth authentication method is employed.

### DESCRIPTION OF THE EMBODIMENTS

According to the system proposed in Japanese Patent Laid-Open No. 2022-140747, a user can pay a toll of an expressway by an ETC without having his/her own ETC card. However, the present inventors have found the following problem in the system in related art.

In other words, in accordance with diversification of mobility as a service (MaaS), in terms of user-friendliness as to efficiency of payment, and the like, it is considered that there will be a need for tracking of use of a mobile body by a user while maintaining security. Concerning this, while the system in related art can hold a correspondence relation between date and time of use and a user as use information in accordance with contract or reservation of a hired car, this date and time of use depends on the contract or the reservation, and thus, the use information is not necessarily consistent with actual use of the hired car by the user. In addition, in a vehicle (for example, an owner-driven car) to be used without accompanying contract or reservation, generation of use information is not originally assumed. Thus, according to the system in related art, it is difficult to track use of the mobile body by the user while maintaining security. Note that a scene in which the problem occurs is not limited to a scene in which a vehicle is used. A similar problem can occur also in a scene in which a mobile body other than a vehicle (such as, for example, a flight vehicle and a ship) is used and a scene in which a plurality of types of mobile bodies are used. Further, a similar problem can occur also in various use scenes other than the scene in which a mobile body is used.

In contrast, a system according to a first aspect of the present disclosure includes a management server, a first terminal of a first target, and a second terminal of a second target. At least one of the first terminal and the second terminal is configured to transmit a linking demand to the management server in accordance with occurrence of a use relation between the first target and the second target. The management server is configured to set a correspondence relation between the first target and the second target based on the linking demand. Setting the correspondence relation includes, in a case where a predetermined condition is not satisfied, setting the correspondence relation between the first target and the second target in accordance with acquisition of authentication results of both the first target and the second target and success in authentication of both the first target and the second target in the acquired authentication results of the first target and the second target, and in a case where the predetermined condition is satisfied, setting the correspondence relation between the first target and the second target in accordance with, while omitting authentication of one target out of the first target and the second target, acquisition of an authentication result of the other target and success in authentication of the other target in the acquired authentication result.

In the first aspect of the present disclosure, it is possible to track the use relation between the first target and the second target by setting the correspondence relation (linking) between the first target and the second target. In addition, in a case where the predetermined condition is not satisfied, by performing authentication of both the first target and the second target upon setting of the correspondence relation, it is possible to maintain security. On the other hand, in a case where the predetermined condition is satisfied, by omitting authentication of one of the first target and the second target, it is possible to achieve reduction in trouble. Thus, according to the first aspect of the present disclosure, it is possible to track the use relation between the first target and the second target while maintaining security and reduce trouble of the tracking.

Note that a form of the present disclosure does not have to be limited to the above-described example. As another form of the system according to the above-described aspect, one aspect of the present disclosure may be an information processing device that implements all or some of the components described above, an information processing method, a program, or a storage medium readable by a machine such as a computer, storing such a program therein. Here, the machine-readable storage medium is a medium that accumulates information such as the program by electric, magnetic, optical, mechanical, or chemical action. The information processing device may be at least one of the management server, the first terminal, and the second terminal according to the above-described aspect. Further, the system according to the above-described aspect may further include at least one of a first server involved in authentication of the first target and a second server involved in authentication of the second target.

For example, a management server according to a second aspect of the present disclosure may include a controller configured to execute setting of a correspondence relation between a first target and a second target based on a linking demand transmitted from at least one of a first terminal of the first target and a second terminal of the second target upon occurrence of a use relation between the first target and the second target. Setting the correspondence relation may include, in a case where a predetermined condition is not satisfied, setting the correspondence relation between the first target and the second target in accordance with acquisition of authentication results of both the first target and the second target and success in authentication of both the first target and the second target in the acquired authentication results of the first target and the second target, and in a case where the predetermined condition is satisfied, setting the correspondence relation between the first target and the second target in accordance with, while omitting authentication of one target out of the first target and the second target, acquisition of an authentication result of the other target and success in authentication of the other target in the acquired authentication result.

Further, for example, a program according to a third aspect of the present disclosure may be a program for causing a management server to execute setting of a correspondence relation between a first target and a second target by causing a first terminal of the first target to transmit a linking demand to the management server or transmit the linking demand in cooperation with a second terminal of the second target or causing the second terminal to transmit the linking demand upon occurrence of a use relation between the first target and the second target. In a case where a predetermined condition is not satisfied, the linking demand may include authentication requests for the first target and the second target, and setting the correspondence relation between the first target and the second target may include setting the correspondence relation between the first target and the second target in accordance with success in authentication of both the first target and the second target executed based on the authentication requests. In a case where the predetermined condition is satisfied, an authentication request for one target out of the first target and the second target is omitted, the linking demand may include an authentication request for the other target, and setting the correspondence relation between the first target and the second target may include setting the correspondence relation between the first target and the second target in accordance with success in authentication of the other target executed based on the authentication request.

Further, in terms of balance between maintenance of security and reduction in trouble, a form in which authentication is omitted does not have to be limited to the example in the above-described aspects. In another example, authentication of at least one of the first target and the second target may be performed in a case where the predetermined condition is not satisfied, and authentication of both the first target and the second target may be omitted in a case where the predetermined condition is satisfied.

For example, a management server according to a fourth aspect of the present disclosure may include a controller configured to execute setting of a correspondence relation between a first target and a second target based on a linking demand transmitted from at least one of a first terminal of the first target and a second terminal of the second target upon occurrence of a use relation between the first target and the second target. Setting the correspondence relation may include, in a case where a predetermined condition is not satisfied, setting the correspondence relation between the first target and the second target in accordance with acquisition of an authentication result of at least one of the first target and the second target and success in authentication in the acquired authentication result, and in a case where the predetermined condition is satisfied, setting the correspondence relation between the first target and the second target in accordance with receipt of the linking demand while omitting authentication of both the first target and the second target.

Further, for example, a program according to a fifth aspect of the present disclosure may be a program for causing a management server to execute setting of a correspondence relation between a first target and a second target by causing a first terminal of the first target to transmit a linking demand to the management server or transmit the linking demand in cooperation with a second terminal of the second target or causing the second terminal to transmit the linking demand upon occurrence of a use relation between the first target and the second target. In a case where a predetermined condition is not satisfied, the linking demand may include an authentication request for at least one of the first target and the second target, and setting the correspondence relation between the first target and the second target may include setting the correspondence relation between the first target and the second target in accordance with success in authentication of at least one of the first target and the second target executed based on the authentication request. In a case where the predetermined condition is satisfied, the authentication requests for both the first target and the second target are omitted from the linking demand, and setting the correspondence relation between the first target and the second target may include setting the correspondence relation between the first target and the second target in accordance with receipt of the linking demand.

An embodiment according to one aspect of the present disclosure (hereinafter, also expressed as the “present embodiment”) will be described below based on the drawings. However, the present embodiment described below is merely an example of the present disclosure in all respects. Various improvements and modifications may be made without deviating from the scope of the present disclosure. A specific configuration in accordance with the embodiment may be employed as appropriate to implement the present disclosure. Note that while data appearing in the present embodiment is described with natural language, more specifically, computer-recognizable quasi-language, commands, parameters, machine language, and the like, are designated.

### 1 APPLICATION EXAMPLE

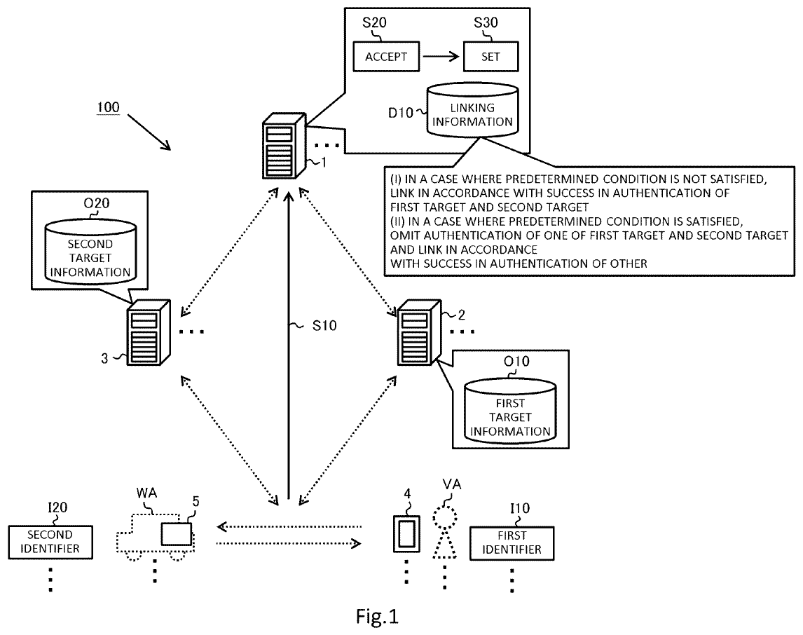

FIG. 1 schematically illustrates one example of a scene to which the present disclosure is applied. A system 100 according to the present embodiment includes a management server 1, a first terminal 4, and a second terminal 5. The management server 1 is one or more computers configured to record a correspondence relation (linking) between a first target VA and a second target WA. The first terminal 4 corresponds to the first target VA, and the second terminal 5 corresponds to the second target WA. The first terminal 4 is provided for each first target VA, and the second terminal 5 is provided for each second target WA.

In the present embodiment, at least one of the first terminal 4 and the second terminal 5 is configured to transmit a linking demand to the management server 1 in accordance with occurrence of a use relation between the first target VA and the second target WA. As an example, a use relation occurs between the first target VA and the second target WA on a one-to-one basis. In other words, a use relation occurs between one first target VA and one second target WA. The one first target VA is one individual of the first target VA, and the one second target WA is one individual of the second target WA. One individual with which a use relation occurs may be referred to as the “corresponding individual” or a “target individual”. In accordance with occurrence of this use relation, at least one of the first terminal 4 corresponding to the corresponding individual of the first target VA and the second terminal 5 corresponding to the corresponding individual of the second target WA transmits a linking demand to the management server 1 (step S10).

In accordance with this, the management server 1 receives the linking demand from at least one of the first terminal 4 of the first target VA and the second terminal 5 of the second target WA. The management server 1 accepts setting of a correspondence relation between the first target VA and the second target WA in accordance with receipt of the linking demand (step S20). The management server 1 sets the correspondence relation (linking) between the first target VA and the second target WA based on the accepted linking demand (step S30). In one example, the management server 1 may generate linking information D10 indicating setting of the correspondence relation between the first target VA and the second target WA and store the generated linking information D10.

In the present embodiment, authentication processing of the first target VA and the second target WA is provided in connection with the setting of the correspondence relation. The authentication processing of each target (VA, WA) may be executed at an arbitrary timing before the correspondence relation is set. Further, a predetermined condition is provided as a condition for activating simplification of the authentication processing. In accordance with this, in a case where the predetermined condition is not satisfied, setting the correspondence relation includes setting the correspondence relation between the first target VA and the second target WA in accordance with acquisition of authentication results of both the first target VA and the second target WA and success in authentication of both the first target VA and the second target WA in the acquired authentication results of the first target VA and the second target WA. On the other hand, in a case where the predetermined condition is satisfied, setting the correspondence relation includes setting the correspondence relation between the first target VA and the second target WA in accordance with, while omitting authentication of one target out of the first target VA and the second target WA, acquisition of an authentication result of the other target and success in authentication of the other target in the acquired authentication result.

Note that data exchange may be executed between the first terminal 4 corresponding to the corresponding individual of the first target VA and the second terminal 5 corresponding to the corresponding individual of the second terminal WA upon occurrence of the use relation between the first target VA and the second target WA. In association with this data exchange, the linking demand may be executed. A series of processing from linking demand to linking setting may be executed in real time in accordance with occurrence of the use relation. After setting, the correspondence relation (linking) may be released at an arbitrary timing. In one example, the correspondence relation may be released in accordance with extinction of the use relation.

Further, if each individual for which the correspondence relation is set can be specified, an expression format of information indicating setting of the correspondence relation does not have to be particularly limited and may be determined as appropriate in accordance with an embodiment. In one example, a first identifier I10 may be provided to each first target VA, and each individual of the first target VA may be identified by the first identifier I10. In a similar manner, a second identifier I20 may be provided to each second target WA, and each individual of the second target WA may be identified by the second identifier I20. In accordance with this, setting the correspondence relation between the first target VA and the second target WA may include setting the correspondence relation between the first identifier I10 provided to the corresponding individual of the first target VA and the second identifier I20 provided to the corresponding individual of the second target WA. In other words, setting the correspondence relation may be expressed using the first identifier I10 and the second identifier I20.

As described above, in the present embodiment, by setting the correspondence relation (linking) between the first target VA and the second target WA, a use relation between the corresponding individual of the first target VA and the corresponding individual of the second target WA can be tracked. In addition, in the present embodiment, in a case where the predetermined condition is not satisfied, by performing authentication of both the first target VA and the second target WA upon setting of the correspondence relation, security can be maintained. On the other hand, in a case where the predetermined condition is satisfied, by omitting authentication of one of the first target VA and the second target WA, it is possible to reduce trouble. Thus, according to the present embodiment, it is possible to track the use relation between the first target VA and the second target WA while maintaining security and reduce trouble of the tracking.

### (Target)

Each of the first target VA and the second target WA does not have to be particularly limited if the use relation can be established and may be selected as appropriate in accordance with an embodiment. Each of the first target VA and the second target WA may be an arbitrary object such as an object, a person, and other living things. The arbitrary object may include a virtual object. Establishment of the use relation may be occurrence of a real or virtual relation between at least two objects such as, for example, using one by the other, possessing one by the other, coupling one with the other, and connecting one to the other. The system 100 of the present disclosure may be used in an arbitrary scene in which a correspondence relation between two or more objects is tracked.

### (Terminal)

Each terminal (4, 5) relates to each target (VA, WA). A relation between each terminal (4, 5) and each target (VA, WA) does not have to be particularly limited and may be determined as appropriate in accordance with an embodiment. In one example, the first terminal 4 may accompany the corresponding first target VA, and the second terminal 5 may accompany the corresponding second target WA. Accompaniment may include temporal or constant deployment inside or outside the target, possession by the target (person), and possession by a person who is involved with the target (object). Deployment may include loading. Loading may include at least temporal placement at the target upon use of the target in addition to constant placement at the target. Loading may include possession by a user of the target. Further, at least one of the first terminal 4 and the second terminal 5 may be the target itself. Note that concerning each terminal (4, 5), a plurality of terminals may be used as terminals of the same individual, for example, as in a case where an account of one user is shared among the plurality of terminals. In this case, the plurality of terminals to be used by the same individual may be interpreted as one terminal of one individual.

### (First Server/Second Server)

In one example, to indicate details of each individual of the first target VA, first target information O10 regarding the first target VA may be used. The first target information O10 may include the first identifier I10. The first target information O10 may also include information (such as registered unique information) to be used for authentication of the first target VA. In a similar manner, to indicate details of each individual of the second target WA, second target information O20 regarding the second target WA may be used. The second target information O20 may include the second identifier I20. The second target information O20 may include information to be used for authentication of the second target WA. The first target information O10 and the second target information O20 may be held in an arbitrary memory area. At least part of the first target information O10 and the second target information O20 may be held so as to be accessible by at least one of the management server 1, an external server, and each terminal (4, 5).

The first target information O10 and the second target information O20 may be managed as appropriate. In the example of FIG. 1, a first server 2 may be configured to manage the first target information O10, and a second server 3 may be configured to manage the second target information O20. Each of the first server 2 and the second server 3 may be constituted with one or more server devices. The first target information O10 may be stored in a memory resource deployed at least one of inside and outside of the first server 2 so as to be accessible by the first server 2. The second target information O20 may be stored in a memory resource deployed at least one of inside and outside of the second server 3 so as to be accessible by the second server 3. The internal memory resource may include, for example, a random access memory (RAM), an auxiliary memory, a storage medium, and the like. The external memory resource may include, for example, an external main memory, an external computer (such as a network attached storage (NAS)), and the like. In another example, each piece of the target information (O10, O20) may be stored in a memory resource of the management server 1.

A unit of managing each piece of the target information (O10, O20) does not have to be particularly limited and may be determined as appropriate in accordance with an embodiment. At least one of the first target information O10 and the second target information O20 may be managed in a concentrative manner (in bulk) or may be managed in a dispersed manner (separately) for each arbitrary group. The server device that constitutes each server (2, 3) may be deployed by one or more operating institutions (entities). At least one of the first server 2 and the second server 3 may be deployed by a plurality of operating institutions. In a case where the server is deployed by a plurality of operating institutions, the target information may be shared (that is, managed in a concentrative manner) or may be managed in a dispersed manner for each operating institution.

Note that the first server 2 may be involved with authentication of the first target VA. Involvement with authentication may include determination as to whether or not authentication is successful (direct involvement) and indirect involvement (for example, provision of information for determining whether or not authentication is successful). In a case where whether or not authentication of the first target VA is successful is determined, the first server 2 is one example of an external server (external authentication server) that determines whether or not authentication of the first target VA is successful. The second server 3 may be involved with authentication of the second target WA. In a case where whether or not authentication of the second target WA is successful is determined, the second server 3 is one example of an external server (external authentication server) that determines whether or not authentication of the second target WA is successful.

### (Identifier)

In one example, each identifier (I10, I20) may be used to identify each individual of each target (VA, WA). A data format and a configuration of each identifier (I10, I20) do not have to be particularly limited if each individual of each target (VA, WA) can be identified and may be selected as appropriate in accordance with an embodiment. In one example, each identifier (I10, I20) may be constituted with a symbol string including numbers, characters, and the like. In another example, as each identifier (I10, I20), unique information such as identification information uniquely provided to each target (VA, WA) and information derived from each terminal (4, 5) may be used. The uniquely provided identification information may be, for example, a vehicle registration number, a vehicle identification number (VIN), a personal identification number, or the like. In a case where an IC tag is provided to the target, the uniquely provided identification information may include information held by the IC tag. The information derived from each terminal (4, 5) may be, for example, a media access control address (MAC address), terminal identification information (such as an international mobile equipment identifier (IMEI), an international mobile subscriber identity (IMSI), a mobile equipment identifier (MEID), an integrated circuit card ID (ICCID), and other serial numbers).

### (Management Server)

The management server 1 is configured to set the correspondence relation between the first target VA and the second target WA in response to the linking demand from at least one of the first terminal 4 and the second terminal 5. In one example, the management server 1 may directly receive the linking demand from at least one of the first terminal 4 and the second terminal 5 or may indirectly receive the linking demand via an external server. In other words, transmission of the linking demand to the management server 1 may include direct transmission of the linking demand to the management server 1 or indirect transmission of the linking demand to the management server 1 via an external server. The external server may include, for example, the first server 2, the second server 3, and the like. Further, in one example, indirect transmission may include simply relaying the linking demand by an external computer. In another example, indirect transmission may include transmitting a request for processing involved with linking to an external computer and causing the external computer to transmit some kind of information to the management server 1 in accordance with a result of the execution, for example, requesting authentication of each target (VA, WA) to each server (2, 3) and causing the management server 1 to transmit the authentication result. In other words, the linking demand may be transmitted from the external computer to the management server 1 as a result of data communication for other purposes with respect to the external computer.

The management server 1 may receive the linking demand (request for linking setting) in accordance with occurrence of the use relation and may set the correspondence relation between the corresponding individual of the first target VA and the corresponding individual of the second target WA in accordance with the received linking demand. The management server 1 may receive a release demand (request for linking release) in accordance with extinction of the use relation and may release the correspondence relation as appropriate in response to the received release demand. The linking demand and the release demand may be configured to designate the corresponding individuals to be processed using an arbitrary method. In a typical example, each of the linking demand and the release demand may be configured to designate the corresponding individuals to be processed by including the first identifier I10 and the second identifier I20. However, a method for designating the corresponding individuals to be processed does not have to be limited to such an example and may be changed as appropriate in accordance with an embodiment. In another example, by using substitute information in at least one of the linking demand and the release demand, at least one of the first identifier I10 and the second identifier I20 may be omitted. For example, an identifier may be provided to a combination (linking setting) of the corresponding individual of the first target VA and the corresponding individual of the second target WA as the substitute information. The identifier may be provided at, for example, an arbitrary timing such as upon initial linking setting. At least one of the linking demand and the release demand may be configured to designate the corresponding individuals of the respective targets (VA, WA) to be processed by including this identifier, without including at least one of the first identifier I10 and the second identifier I20.

The management server 1 may include one or more server devices. In the present embodiment, the management server 1 may be configured to record information regarding occurrence and extinction of the correspondence relation between the first target VA and the second target WA as the linking information D10. The linking information D10 may be stored in a memory resource deployed at least one of inside and outside of the management server 1. The internal memory resource may include, for example, a RAM, an auxiliary memory, a storage medium, and the like. The external memory resource may include, for example, an external main memory, an external computer (such as a NAS), and the like.

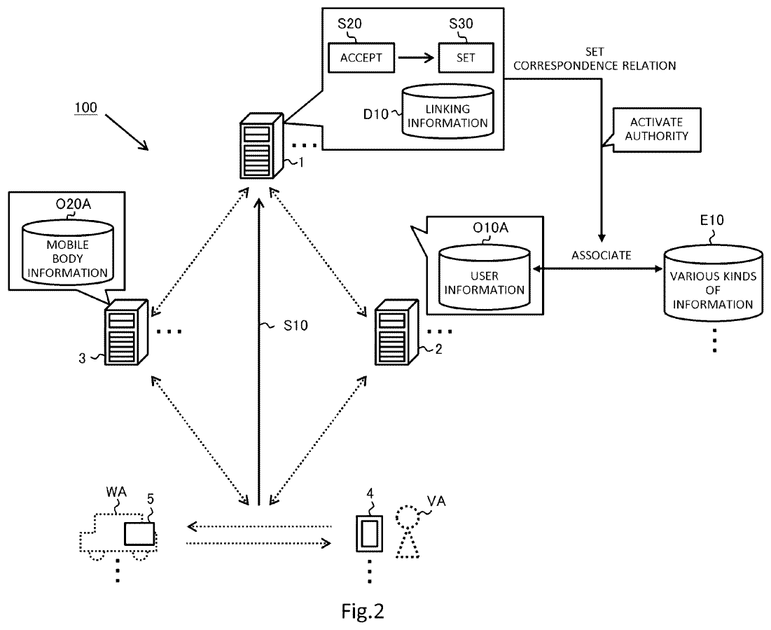

The linking information D10 that can be obtained may be used in various scenes. In one example, the linking information D10 may be used for tracking a relation between the first target VA and the second target WA. As a specific example, the linking information D10 may be used for allowing authority linked to one of the first target VA and the second target WA (the first target information O10 and the second target information O20) to be exercised by the other while the correspondence relation between the first target VA and the second target WA is set. In other words, the linking information D10 may be used for activating exercise of authority of one of the first target VA and the second target WA to be exercised by the other in accordance with linking between the first target VA and the second target WA (FIG. 2, which will be described later).

In one example of the present embodiment, the linking information D10 may include information on the first identifier I10 and the second identifier I20 of the corresponding individuals to indicate a combination of the first target VA and the second target WA for which the correspondence relation is set. The management server 1 may acquire each identifier (I10, I20) of each target as appropriate. In one example, the management server 1 may acquire information on the first identifier I10 and the second identifier I20 for which the correspondence relation is to be set from at least one of each server (2, 3) and each terminal (4, 5) each time without holding the information in advance. In another example, the management server 1 may hold information on at least one of the first identifier I10 and the second identifier I20 for which the correspondence relation is to be set in advance.

Note that an operating institution of the management server 1 and an operating institution of each server (2, 3) may have an arbitrary relation. In one example, the operating institution of the management server 1 may overlap with at least one of the operating institution of the first server 2 and the operating institution of the second server 3. In another example, the operating institution of the management server 1 may be different from the operating institutions of the first server 2 and the second server 3. The system 100 of the present disclosure may be produced by the management server 1 being connected to each terminal (4, 5) via a network and each terminal being deployed in a state where the above-described information processing can be executed in accordance with intention of the operating institution of the management server 1. In a case where each server (2, 3) is involved with information processing (for example, authentication processing) related to linking, each server (2, 3) may be interpreted as being included in the system 100. In this case, the system 100 of the present disclosure may be produced by the management server 1 being further connected to each server (2, 3) via a network and each server (2, 3) being further deployed in a state where the information processing related to linking can be executed.

### Operation Example

In one example, one of the first target VA and the second target WA may be a user. One terminal corresponding to the user out of the first terminal 4 and the second terminal 5 may be a user terminal related to the user. The other of the first target VA and the second target WA may be an object to be used by the user. One terminal corresponding to the object to be used out of the first terminal 4 and the second terminal 5 may be a loading terminal to be loaded on the object to be used. According to one example of the present embodiment, it is possible to track the use relation between the user and the object to be used.

The object to be used only requires to be an object that can be used by the user, and a type of the object to be used does not have to be particularly limited and may be selected as appropriate in accordance with an embodiment. In one example, the object to be used may be a mobile body (mobility). According to one example of the present embodiment, it is possible to track a use relation between the user and the mobile body. Note that a type of the mobile body may be selected as appropriate. The mobile body may be, for example, a vehicle, a railroad vehicle, a flight vehicle (such as an airplane and a drone), a ship, or the like. The mobile body may be at least one of a manned vehicle to be manually controlled and an unmanned vehicle to be automatically controlled. In a case where the mobile body is a vehicle, a type of the vehicle may be arbitrarily selected. The type of the vehicle may be selected from, for example, a two-wheeled vehicle, a three-wheeled vehicle, a four-wheeled vehicle, and the like. The vehicle may include an owner-driven car, a hired car, a shared car, a taxi, a bus, and the like. The vehicle may be at least one of an automated driving vehicle and a manual driving vehicle. The loading terminal may be referred to as a mobile body terminal.

FIG. 2 schematically illustrates an example of a scene to which the system 100 of the present disclosure is applied. In one example of FIG. 2, the first target VA is the user, and the second target WA is the mobile body. In the following description regarding a case of FIG. 2, description will be provided assuming that the “first” relates to the user, and the “second” relates to the mobile body. However, a correspondence relation between the “first” and the “second” does not have to be limited to the example of FIG. 2. The “first” and the “second” may be switched to each other. In other words, the second target WA may be the user, and the first target VA may be the mobile body.

In a case where the first target VA is the user, one example of the first terminal 4 is a user terminal. The user terminal may be an arbitrary computer such as, for example, a mobile terminal (such as a smartphone), a dedicated device (such as an electronic key device), and other computer devices. Typically, the user terminal may be carried by the user who is a linking target (each individual of the first target VA). An account of the user may be shared among a plurality of computers, and the computers that share the account may be used as the user terminal (first terminal 4) of the same user accordingly.

One example of the first identifier I10 is a user identifier (user ID, my ID). The user identifier may be, for example, an ID of the user account, a personal identification number, identification information of the user terminal (such as, for example, a MAC address and terminal identification information), or the like. One example of the first target information O10 is user information O10A. The user information O10A may include arbitrary information regarding the user. In one example, the user information O10A may be associated with various kinds of information E10 for exercising authority by including information regarding the authority of the corresponding user (corresponding individual of the user). The various kinds of information E10 may include, for example, information on public personal authentication, payment information, information on other service systems, and the like. The information on the public personal authentication may include, for example, a personal identification number and the like. The payment information may include, for example, information on a credit card, information on Internet banking, information on electronic payment, and the like. The information on other service systems may include, for example, information regarding an electronic prescription (such as an insurance number and prescription information). The various kinds of information E10 may be managed by an external system or may be managed inside the system 100. Note that the first server 2 may be deployed by a public institution, a neutral institution, each business operator (such as a vehicle manufacturer and a service operating company), or the like. The first server 2 may be referred to as a user ID server, a my ID server, or the like.

On the other hand, in a case where the second target WA is a mobile body, one example of the second terminal 5 is a mobile body terminal (loading terminal). The mobile body terminal may be, for example, a terminal attached to inside or outside of the mobile body, a terminal carried by a person (such as, for example, a driver and a conductor) who is involved with operation of the mobile body, equipment (such as, for example, a ticket gate) deployed at a facility of the mobile body, or the like. In a case where the mobile body is a vehicle, the mobile body terminal may be referred to as an in-vehicle terminal.

One example of the second identifier I20 is a mobile body identifier (a mobile body ID, a car ID). The mobile body identifier may be, for example, an ID of a mobile body account, identification information uniquely provided to a target mobile body (such as, for example, a vehicle registration number and vehicle identification information), identification information of the mobile body terminal, or the like. One example of the second target information O20 is mobile body information O20A. The mobile body information O20A may include arbitrary information regarding the mobile body. In one example of FIG. 2, exercise of at least part of authority of the various kinds of information E10 associated with the user information O10A by the mobile body may be activated in accordance with linking setting between the user and the mobile body. Note that the second server 3 may be deployed by a public institution, a neutral institution, each business operator (such as a vehicle manufacturer and a service operating company), or the like. The second server 3 may be referred to as a mobile body ID server, a car ID server, or the like.

The mobile body is one example of the object to be used. The form of FIG. 2 may be applied to an arbitrary case in which the user (occupant) of the object to be used dynamically changes. The object to be used may be, for example, a rented object, an accommodation facility, or the like, in addition to the mobile body. The rented object may include a rented office, a rented space, and the like.

The system 100 may be configured to set a correspondence relation (linking) between the corresponding user (the first identifier I10) and the corresponding individual of the object to be used (second identifier I20) in accordance with start of use of the object to be used. Further, the system 100 may be configured to release the correspondence relation (linking) between the corresponding individuals in accordance with end of use. The start and the end of use may be, for example, detected using an arbitrary method at a timing upon getting-on/getting-off of a vehicle, lending and returning of the object to be used, or the like. In one example, at least one of the start and the end of use may be detected in accordance with execution of data exchange between the first terminal 4 and the second terminal 5.

Note the object to be used can be divided into at least two types of an object that can be repeatedly used in a long term and an object that can be temporarily used. For explanatory convenience, the former will be referred to as an “object to be constantly used”, and the latter will be referred to as an “object to be temporarily used”. On example of the object to be constantly used is a possession of the user, such as an owner-driven car. It is desirable that the object that is repeatedly used in a long term is selected as the object to be constantly used. One example of the object to be temporarily used is an object possessed by a person other than the user, such as a hired car, a shared car, a mobile body of a public transportation system, a rented object, and an accommodation facility. The mobile body of the public transportation system is, for example, a taxi, a bus, a railroad vehicle, an airplane, a ship, or the like.

In the system 100, a type (whether the object is the object to be constantly used or the object to be temporarily used) of the object to be used may be distinguished or does not have to be distinguished. In a case where the type of the object to be used is distinguished, the system 100 may determine the type of the object to be used using an arbitrary method. In one example, target information (such as the mobile body information) may include information indicating the type of the object to be used, and the system 100 may determine the type of the object to be used using this information. In another example, the type of the object to be used may be determined using information such as an identifier and attribute information. In another example, information indicating the type of the object to be used may be included in information to be transmitted from at least one of the first terminal 4 and the second terminal 5 to the management server 1, and the system 100 may determine the type of the object to be used using this information. In another example, in a case where an operating institution of the server (in the example of FIG. 2, the second server 3) that handles information on the object to be used is determined in accordance with the type of the object to be used, the type of the object to be used may be determined in accordance with the operating institution to which the server belongs.

Further, the system 100 may, for example, switch forms of processing of linking setting, a condition of linking release, a method for managing the linking information D10, the authentication processing, and the like, in accordance with the determined type of the object to be used.

Note that a scene to which the system 100 of the present disclosure is applied does not have to be limited to a scene in which a relation between the user and the object to be used is tracked. In another example, both the first target VA and the second target WA may be robot devices configured to be autonomously operated by automated control. The robot devices may include a mobile body such as an automated driving vehicle and a drone. In a scene in which two or more robot devices autonomously perform interaction, the system 100 of the present disclosure may be used to track occurrence and extinction of a relation between the robot devices.

As a specific example, one of the first target VA and the second target WA may be a large-size automated driving vehicle, and the other may be a small-size automated driving vehicle. The large-size automated driving vehicle may be configured to store a plurality of small-size automated driving vehicles. The small-size automated driving vehicle may be unable to get on a plurality of large-size automated driving vehicles at the same time (that is, at one time point, the small-size automated driving vehicle is stored in only one large-size automated driving vehicle). In accordance with this, the first target VA may be the small-size automated driving vehicle, and the second target WA may be the large-size automated driving vehicle. The large-size automated driving vehicle may collect, convey, and release each small-size automated driving vehicle as appropriate. Each small-size automated driving vehicle may be operated as appropriate at a release destination. In this case, the system 100 of the present disclosure may be configured to track an operating situation (for example, whether or not the vehicle is being conveyed) by setting a correspondence relation between the large-size automated vehicle and the small-size automated vehicle, switching a state, and releasing the correspondence relation.

### (Linking Information)

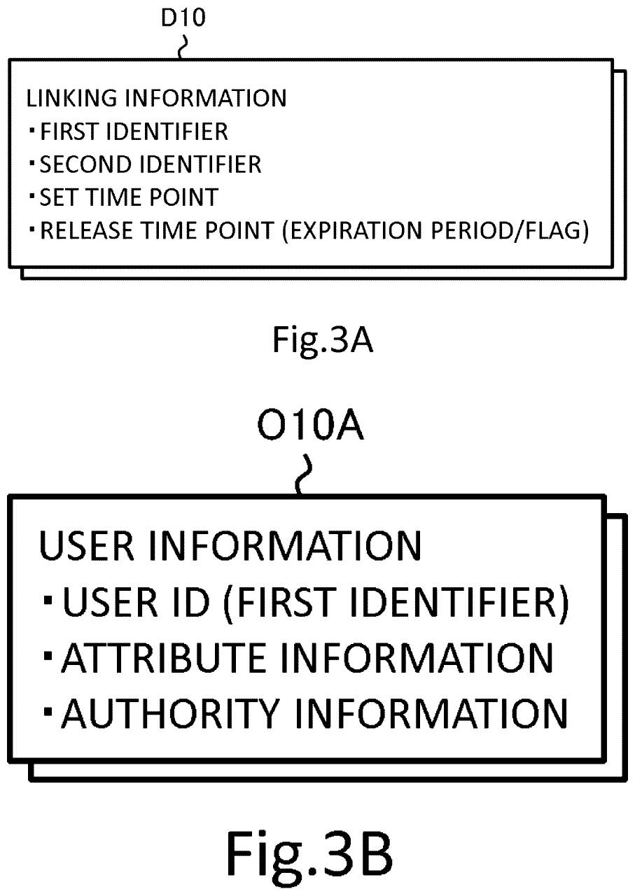

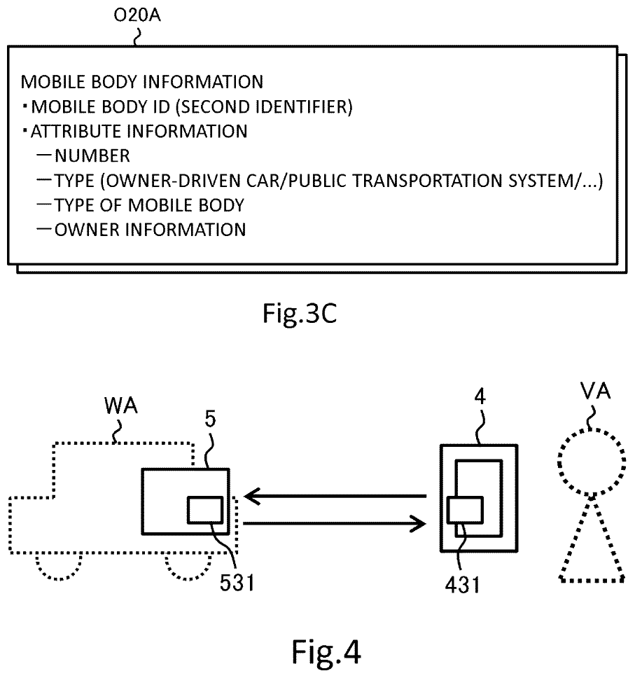

FIG. 3A schematically indicates one example of the linking information D10 according to the present embodiment. In one example of FIG. 3A, it is assumed to employ a form in which setting of the correspondence relation is expressed using the first identifier I10 and the second identifier I20. The linking information D10 includes the first identifier I10, the second identifier I20, a set time point, and a release time point. The first identifier I10 and the second identifier I20 indicate the corresponding individual of the first target VA and the corresponding individual of the second target WA for which the correspondence relation (linking) is set. The set time point indicates a time point at which the correspondence relation is set. The set time point may include a timestamp. The release time point indicates a time point at which the correspondence relation is released. A value of the release time point may be added when processing of releasing the correspondence relation is executed. A method for expressing release does not have to be limited to such an example. In another example, the release time point may be replaced with at least one of an expiration period and a flag. The expiration period indicates a period during which setting of the correspondence relation is valid. In this case, whether or not setting of the correspondence relation is valid (that is, whether the correspondence relation is set or released) is indicted in accordance with whether or not a current time point is within the expiration period. The flag indicates whether or not the correspondence relation is released. The flag may be set up when processing of releasing the correspondence relation is executed. In still another example, the linking information D10 may include at least one of the expiration period and the flag along with a field of the release time point. Note that the configuration of the linking information D10 does not have to be limited to the example of FIG. 3A if setting of the correspondence relation can be indicated and may be changed as appropriate in accordance with an embodiment. In another example, the linking information D10 may further include information indicating the type of the object to be used (whether the object is the object to be constantly used or the object to be temporarily used). The type of the object to be used does not necessarily have to be identified by separate information. For example, the type of the object to be used may be identified by information such as an identifier.

A data format of the linking information D10 does not have to be particularly limited and may be selected as appropriate in accordance with an embodiment. The linking information D10 may be held in an arbitrary database base. In one example, the linking information D10 may be held in a relational database having a table format or the like. In another example, the linking information D10 may be held in a block chain base. In this case, transactions of linking setting and release are accumulated with block chain as the linking information D10. For example, the transaction of linking setting may include the first identifier I10, the second identifier I20, and the set time point. The transaction of linking release may include the first identifier I10, the second identifier I20, and the release time point (or information indicating release).

### (First Target Information)

The first target information O10 may include arbitrary information regarding the first target VA. The first target information O10 may include, for example, the first identifier I10, attribute information of the first target VA, information regarding authority, and the like. In the example of FIG. 2, the user information O10A is one example of the first target information O10.

FIG. 3B schematically indicates one example of the user information O10A according to the present embodiment. In one example of FIG. 3B, the user information O10A includes a user ID (first identifier I10), attribute information, and authority information. The attribute information may include arbitrary information regarding an attribute of the corresponding user. The attribute information may include, for example, personal information such as a name, an address, an age, a gender, and contact information. The authority information is related to authority of the corresponding user. The authority information may include, for example, information for coordinating with a server that executes information processing regarding authority of the target, information indicating association with the various kinds of information E10, and the like. Note that a configuration of the user information O10A does not have to be limited to the example of FIG. 3B and may be changed as appropriate in accordance with an embodiment. For example, the user information O10A (first target information O10) may further include information (such as, for example, registered unique information) to be used for authentication of the user (first target VA).

A data format of the first target information O10 (user information O10A) does not have to be particularly limited and may be selected as appropriate in accordance with an embodiment. The first target information O10 (user information O10A) may be held in an arbitrary database base. In one example, the first target information O10 (user information O10A) may be held in a relational database having a table format or the like. In another example, the first target information O10 (user information O10A) may be held in a block chain base.

### (Second Target Information)

The second target information O20 may include arbitrary information regarding the second target WA. The second target information O20 may include, for example, the second identifier I20, attribute information of the second target WA, information regarding authority, and the like. In the example of FIG. 2, the mobile body information O20A is one example of the second target information O20.

FIG. 3C schematically indicates one example of the mobile body information O20A according to the present embodiment. In one example of FIG. 3C, the mobile body information O20A includes a mobile body ID (second identifier I20) and attribute information. The attribute information includes a number, a type (type of the target), a type of the mobile body, and owner information. In a case where the mobile body is a vehicle, the number may be a vehicle registration number. The type may be arbitrarily specified. In one example, the type may be specified to indicate a category so as to be able to distinguish between an object to be constantly used and an object to be temporarily used, such as, for example, an owner-driven car, a hired car, a shared car, and a mobile body of a public transportation system. In accordance with this, whether the second target WA (mobile body) is an object to be constantly user or an object to be temporarily used may be identified by attribute information of the type. However, a method for identifying whether or not the second target WA is an object to be constantly used does not have to be limited to such an example and may be selected as appropriate in accordance with an embodiment. In another example, whether the second target WA is an object to be constantly used or an object to be temporarily used may be identified with other information such as an identifier. The type of the mobile body indicates, for example, a type such as a type of a vehicle. In a case where the type of the mobile body is the same as the type (type of the target), a field of the type of the mobile body may be omitted. The owner information may include arbitrary information regarding an owner of the mobile body. The owner information may include, for example, personal information of the owner such as a name, an address, an age, a gender, and contact information. The owner may be a corporation. Note that a configuration of the mobile body information O20A does not have to be limited to the example of FIG. 3C and may be changed as appropriate in accordance with an embodiment. For example, the mobile body information O20A (second target information O20) may further include information (such as, for example, registered unique information) to be used for authentication of the mobile body (second target WA). Further, a configuration of the attribute information may be changed as appropriate. For example, the mobile body information O20A (attribute information) may further include information regarding a mobile body terminal such as contact information of the mobile body terminal.

A data format of the second target information O20 (mobile body information O20A) does not have to be particularly limited and may be selected as appropriate in accordance with an embodiment. The second target information O20 (mobile body information O20A) may be held in an arbitrary database base. In one example, the second target information O20 (mobile body information O20A) may be held in a relational database having a table format or the like. In another example, the second target information O20 (mobile body information O20A) may be held in a block chain base.

### (Data Exchange)

In the present embodiment, a series of processing regarding linking setting may be started by being triggered by data exchange between the first terminal 4 and the second terminal 5. In other words, the first terminal 4 and the second terminal 5 may be configured to execute data exchange upon occurrence of a use relation between the first target VA and the second target WA. Occurrence of the use relation (start of use) may be detected by this data exchange. According to one example of the present embodiment, it can be expected that occurrence of the use relation can be easily detected by data exchange.

A method for data exchange does not have to be particularly limited and may be selected as appropriate in accordance with an embodiment. In one example, data exchange between the first terminal 4 and the second terminal 5 may be performed through wireless or wired data communication. The wireless communication may be performed through, for example, near field communication (NFC), Bluetooth (registered trademark), Wi-Fi (registered trademark), or the like. The wired communication may be performed through, for example, a wired local area network (LAN), a universal serial bus (USB), or the like. The data communication may be directly performed between the first terminal 4 and the second terminal 5 or may be indirectly performed via other computers. In another example, the data exchange may be performed using a method other than data communication, such as reading of a two-dimensional code. For example, the data exchange may be performed by one of the first terminal 4 and the second terminal 5 displaying data on a display and the other reading the displayed data using a sensor such as an image sensor.

FIG. 4 schematically illustrates one example of the data exchange according to the present embodiment. In one example of the present embodiment, the first terminal 4 may include a short-range wireless communication module 431. The second terminal 5 may include a short-range wireless communication module 531. In accordance with this, data exchange between terminals may be performed by short-range wireless communication. Note that a type of each short-range wireless communication module (431, 531) does not have to be particularly limited and may be selected as appropriate in accordance with an embodiment. The short-range wireless communication may include, for example, NFC, Bluetooth (registered trademark), Wi-Fi (registered trademark), radio-frequency identification (RFID), ZigBee (registered trademark), infrared communication (infrared transmission), and the like. In one example of the present embodiment, occurrence of the use relation can be detected by being triggered by data exchange through short-range wireless communication. Further, it can be assured that the first terminal 4 and the second terminal 5 exist in a range in which short-range wireless communication can be performed, so that it can be expected that occurrence of the use relation between the first target VA and the second target WA can be appropriately detected.

Note that the linking demand may include at least one of the first identifier I10 and the second identifier I20. In a case where the linking demand includes the first identifier I10, the first identifier I10 may be transmitted from at least one of the first terminal 4 and the second terminal 5. In a case where the first identifier I10 is transmitted from the first terminal 4, the first terminal 4 may acquire the first identifier I10 at an arbitrary timing. In one example, the first identifier I10 may be stored in advance in the memory resource of the first terminal 4. The first terminal 4 may acquire the first identifier I10 from the memory resource. In another example, the first terminal 4 may acquire the first identifier I10 using an input device, a sensor, or the like. In a case where the first identifier I10 is transmitted from the second terminal 5, the second terminal 5 may be provided with the first identifier I10 from the first terminal 4 upon data exchange or may acquire the first identifier I10 through spontaneous operation. In one example, the second terminal 5 may acquire the first identifier I10 from the first terminal 4 through data communication. In another example, the second terminal 5 may acquire the first identifier I10 from the first terminal 4 using a method other than data communication, such as reading of the first identifier I10 displayed via a two-dimensional code in the first terminal 4. In still another example, the second terminal 5 may acquire the first identifier I10 from one of the first target VA and the first terminal 4 using a device such as an input device and a sensor. In a case where a person related to the second target WA exists (for example, in a case where the second target WA is a person, in a case where the second target WA is operated by a person, or the like), and the first target VA is an object, acquisition from the first target VA may include acquisition by the person related to the second target WA operating the device as a proxy.

In a similar manner, in a case where the linking demand includes the second identifier I20, the second identifier I20 may be transmitted from at least one of the first terminal 4 and the second terminal 5. In a case where the second identifier I20 is transmitted from the second terminal 5, the second terminal 5 may acquire the second identifier I20 at an arbitrary timing. In one example, the second identifier I20 may be stored in advance in the memory resource of the second terminal 5. The second terminal 5 may acquire the second identifier I20 from the memory resource. In another example, the second terminal 5 may acquire the second identifier I20 using an input device, a sensor, or the like. In a case where the second identifier I20 is transmitted from the first terminal 4, the first terminal 4 may be provided with the second identifier I20 from the second terminal 5 upon data exchange or may acquire the second identifier I20 through spontaneous operation. In one example, the first terminal 4 may acquire the second identifier I20 from the second terminal 5 through data communication. In another example, the first terminal 4 may acquire the second identifier I20 from the second terminal 5 using a method other than data communication, such as reading of the second identifier I20 displayed via a two-dimensional code in the second terminal 5. In still another example, the first terminal 4 may acquire the second identifier I20 from one of the second target WA and the second terminal 5 using a device such as an input device and a sensor. In a case where a person related to the first target VA exists (for example, in a case where the first target VA is a person, in a case where the first target VA is operated by a person, or the like), and the second target WA is an object, acquisition from the second target WA may include acquisition by the person related to the first target VA operating the device as a proxy.

For example, in the above-described example of FIG. 2, the first terminal 4 may acquire the second identifier I20 (mobile body identifier) from the second terminal 5 through data communication or by reading a code. In a case where the second identifier I20 is a vehicle registration number, the first terminal 4 may acquire the second identifier I20 by capturing an image of a car registration plate by an image sensor and analyzing the obtained image. The first terminal 4 may acquire the second identifier I20 via an input device. The second terminal 5 may acquire the second identifier I20 as appropriate. Further, the second terminal 5 may acquire the first identifier I10 (user identifier) through data communication or by reading a code. In a case where the first identifier I10 is a personal identification number described on a card, or the like, the second terminal 5 may acquire the first identifier I10 by capturing an image of the card by an image sensor and analyzing the obtained image. The second terminal 5 may acquire the first identifier I10 via an input device. The first terminal 4 may acquire the first identifier I10 as appropriate.

In a case where an input device is used to acquire data such as each identifier (I10, I20), acquisition of data by one terminal from the other target may include acquisition of data of the other target by one target operating the input device in addition to acquisition of data of the other target by the other target operating the input device. For example, in the above-described example of FIG. 2, in a case where the second identifier I20 is a vehicle registration number, and an input device is used to acquire the vehicle registration number, the first terminal 4 may acquire the second identifier I20 from the mobile body (second target WA) by the user (first target VA) inputting the vehicle registration number via the input device.

Note that acquisition of data of the other target by the one terminal does not necessarily have to be executed upon data exchange. The one terminal may acquire data of the other target at an arbitrary timing different from the timing of data exchange. Any of the above-described methods may be employed as a data acquisition method. In this case, data exchange between the first terminal 4 and the second terminal 5 may function as a mere trigger for starting a series of processing regarding linking setting.

### (Notification Processing)

When processing of at least one of linking setting and release is executed, the management server 1 may transmit a notification indicating an execution result to at least one of the first terminal 4 and the second terminal 5. A transmission path of the notification does not have to be particularly limited and may be determined as appropriate in accordance with an embodiment. In one example, the management server 1 may directly notify at least one of the first terminal 4 and the second terminal 5. In another example, the management server 1 may indirectly notify at least one of the first terminal 4 and the second terminal 5 via an external computer such as each server (2, 3).

Note that in a case where the notification is directly made, the management server 1 may acquire contact information of each terminal (4, 5) as appropriate. The contact information may be a phone number, an e-mail address, account information of a communication application (such as, for example, an application of a social networking service), an identification number, or the like. The management server 1 may acquire the information indicating the contact information of each terminal (4, 5) at an arbitrary timing. In one example, the management server 1 may acquire the information indicating the contact information at a timing at which a demand such as a linking demand and a release demand is accepted. The information indicating the contact information may be sent from at least one of each terminal (4, 5) and each server (2, 3).

### (Authentication Processing)

Authentication of the first target VA and the second target WA may be performed using an arbitrary method (a specific example will be described later). The authentication processing of the first target VA may be executed prior to or subsequent to the authentication processing of the second target WA. The authentication processing of the first target VA and the authentication processing of the second target WA may be executed at least partially in parallel.

Each of the authentication processing of the first target VA and the authentication processing of the second target WA may be executed in at least one of the management server 1, an external server (for example, the first server 2, the second server 3), the first terminal 4, and the second terminal 5. Further, the authentication processing of the first target VA and the authentication processing of the second target WA may be executed at an arbitrary timing before a correspondence relation is set. In one example, authentication of at least one of the first target VA and the second target WA may be executed before the linking demand is issued. In another example, authentication of at least one of the first target VA and the second target WA may be requested along with the linking demand and may be executed along with processing regarding linking setting. Requesting along with the linking demand may include that an authentication request is included in the linking demand. The authentication request may also be referred to as an authentication demand. In still another example, authentication of at least one of the first target VA and the second target WA may be started in response to a demand from the management server 1 or the external server after the linking demand is transmitted. In accordance with these, the management server 1 may acquire the authentication result before the linking demand is received, may acquire the authentication result along with receipt of the linking demand or may acquire the authentication result after the linking demand is received. The authentication result may be acquired along with the linking demand by being included in the linking demand or may be acquired separately from the linking demand. Further, acquisition of the authentication result at the management server 1 in a case where authentication is not successful may include acquisition of an authentication result indicating that authentication is not successful, and the authentication result not reaching the management server 1 (the authentication result being not acquired).

In one example, whether or not authentication of the first target VA and the second target WA is successful may be determined by the management server 1 or the external server. Determination as to whether or not authentication is successful corresponds to execution of authentication processing. In one example, authentication processing of both the first target VA and the second target WA may be executed by one of the management server 1 and the external server. In another example, authentication processing of one of the first target VA and the second target WA may be executed by the management server 1, and authentication processing of the other may be executed by the external server. The external server may be, for example, the first server 2, the second server 3, or the like. Acquisition of the authentication result at the management server 1 may include acquisition of the authentication result by executing authentication processing at the management server 1 or acquisition of the authentication result from the external server. For example, at least one of the first target VA and the second target WA may transmit the linking demand including the authentication request to the management server 1. The authentication request for each target (VA, WA) may include data (such as, for example, an identifier, unique information, a certificate) to be used for authentication of each target (VA, WA). The management server 1 may execute authentication processing in accordance with the received authentication request or may request execution of the authentication processing to the external server by transmitting the authentication request to the external server. Further, for example, at least one of the terminals may transmit the authentication request to the external server. The external server may execute authentication processing in response to the received authentication request or may request execution of the authentication processing to the management server 1 by transmitting the authentication request to the management server 1. In a case where the authentication processing is executed, the external server may directly transmit the authentication result to the management server 1 or may transmit the authentication result to the management server 1 by way of an external computer (such as, for example, at least one of the terminals). Note that as described above, a timing at which the authentication request is transmitted does not have to be limited to such an example. The authentication request may be transmitted in data communication with the management server 1 or the external server before or after the linking demand is issued. In one example of the present embodiment, it can be expected that security is maintained by executing the authentication processing on the server side.

In another example, authentication processing of at least one of the first target VA and the second target WA may be executed by at least one of the first terminal 4 and the second terminal 5. Acquisition of the authentication result at the management server 1 may include acquisition of the authentication result from at least one of the terminals. For example, at least one of the terminals may execute authentication processing of at least one of the targets as spontaneous operation. Further, for example, at least one of the terminals may execute authentication processing in response to a demand from the management server 1 or the external server. At least one of the terminals may transmit the authentication result to the management server 1 as appropriate along with the linking demand or separately from the linking demand. Between the first terminal 4 and the second terminal 5, a terminal that executes the authentication processing may be the same as or different from a terminal that transmits the authentication result. In a case where a terminal that executes the authentication processing is different from a terminal that transmits the authentication result, data of the authentication results may be exchanged between the respective terminals (4, 5) as appropriate.

### (Linking Release)

In the present embodiment, the management server 1 may be configured to release the correspondence relation in accordance with receipt of a release demand from at least one of the first terminal 4 and the second terminal 5 or satisfaction of a predetermined release condition.

### (I) Release Demand

In one example, the release demand may be configured to indicate a correspondence relation between release targets by including at least one of the first identifier I10 and the second identifier I20. In another example, the release demand may be configured to indicate a correspondence relation between release targets by including substitute information.

In a case where the first terminal 4 transmits the release demand including the second identifier I20, the first terminal 4 may acquire the second identifier I20 at an arbitrary timing. In one example, upon the linking demand, the first terminal 4 may acquire the second identifier I20 and store the acquired second identifier I20 in the memory resource. Upon the release demand, the first terminal 4 may acquire the second identifier I20 from the memory resource. Further, in a case where the first terminal 4 transmits the release demand including the first identifier I10, the first terminal 4 may acquire the first identifier I10 at an arbitrary timing. In one example, the first identifier I10 may be stored in advance in the memory resource. The first terminal 4 may acquire the first identifier I10 from the memory resource.

In a similar manner, in a case where the second terminal 5 transmits the release demand including the first identifier I10, the second terminal 5 may acquire the first identifier I10 at an arbitrary timing. In one example, upon the linking demand, the second terminal 5 may acquire the first identifier I10 and store the acquired first identifier I10 in the memory resource. Upon the release demand, the second terminal 5 may acquire the first identifier I10 from the memory resource. Further, in a case where the second terminal 5 transmits the release demand including the second identifier I20, the second terminal 5 may acquire the second identifier I20 at an arbitrary timing. In one example, the second identifier I20 may be stored in advance in the memory resource. The second terminal 5 may acquire the second identifier I20 from the memory resource.

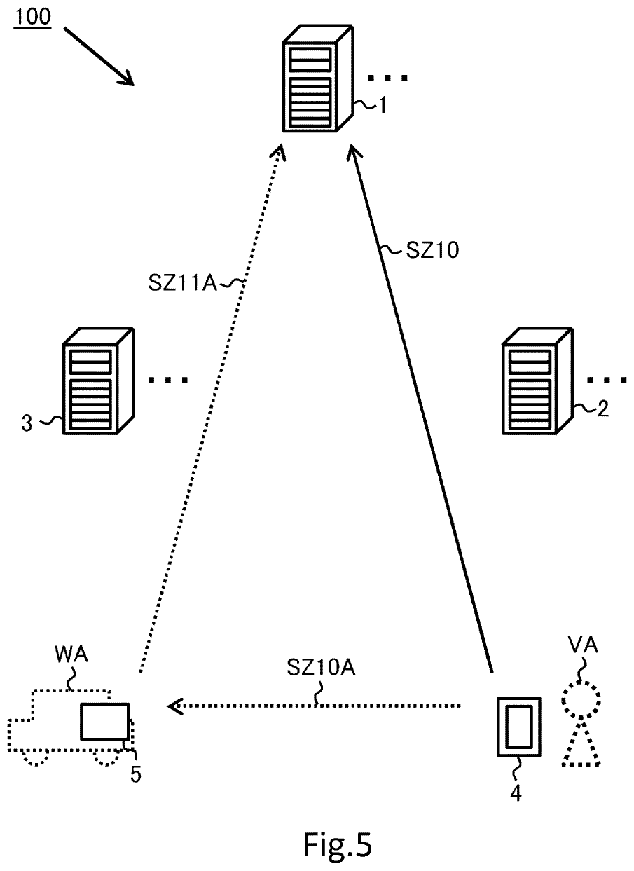

FIG. 5 schematically illustrates one example of a process of linking release according to the present embodiment. In the example of FIG. 5, as a first route, the first terminal 4 directly transmits the release demand to the management server 1 (step SZ10). Further, as a second route, the first terminal 4 provides an instruction to the second terminal 5 (step SZ10A) and causes the second terminal 5 to directly transmit the release demand to the management server 1 (step SZ11A). However, a transmission route of the release demand does not have to be limited to such an example. The first terminal 4 may indirectly transmit the release demand to the management server 1 via an external computer such as the first server 2. In the second route, the second terminal 5 may indirectly transmit the release demand to the management server 1 via an external computer such as the second server 3. Note that a point of origin of the release demand does not have to be limited to the first terminal 4. In another example, the second terminal 5 may directly or indirectly transmit the release demand to the management server 1. Further, the second terminal 5 may provide an instruction to the first terminal 4 and cause the first terminal 4 to directly or indirectly transmit the release demand to the management server 1. The management server 1 releases the correspondence relation designated by the identifiers included in the release demand with reference to the linking information D10 after receiving the release demand. After the release processing, the management server 1 may transmit a notification indicating a result of the release processing to at least one of the first terminal 4 and the second terminal 5 in a similar manner to upon the linking setting.

In one example, the processing of the release demand may include authentication processing of at least one of the first target VA and the second target WA. The authentication processing upon release may be similar to the authentication processing upon the linking setting described above. However, upon the release demand, the authentication processing does not necessarily have to be executed. In another example, the processing of the release demand may be simplified by omitting the authentication processing.

A trigger of the release demand may be set as appropriate in accordance with an embodiment. In one example, in a case where at least one of the first target VA and the second target WA is the user, the release demand may be transmitted from at least one of the first terminal 4 and the second terminal 5 through operation of at least one of the first terminal 4 and the second terminal 5 by the user. In other words, the trigger of the release demand may be operation by the user. In another example, arbitrary information processing may be executed in at least one of the first terminal 4 and the second terminal 5 in association with extinction of the use relation. As a trigger of execution of this information processing, a release demand may be transmitted from at least one of the first terminal 4 and the second terminal 5. For example, arbitrary information processing may be data exchange between the first terminal 4 and the second terminal 5. A method for data exchange upon linking release may be similar to the data exchange upon the linking setting. Whether the data exchange is data exchange upon the linking setting or the data exchange upon the linking release may be distinguished as appropriate. For example, in the example of FIG. 2, the second terminal 5 may include different sensor devices at an entrance and an exist, as at a bus platform, a railroad ticket gate, or the like. In this case, whether the data exchange is the data exchange upon the linking setting or the data exchange upon the linking release may be distinguished in accordance with the sensor device to be used for the data exchange. Further, for example, in a case where the data exchange is executed by an application of the terminal, the application may be configured to be able to switch the mode between a linking setting mode and a linking release mode. In this case, whether the data exchange is the data exchange upon the linking setting or the data exchange upon the linking release may be distinguished in accordance with the mode of the application.

### (ii) Release Condition

The release condition indicates a condition for releasing the correspondence relation between the targets. The release condition may be defined as appropriate in accordance with an embodiment.

In one example, the release condition may be defined so as to release the correspondence relation at an arbitrary set release time point. The release time point may be provided through, for example, designation by the user, designation from other applications (such as a scheduler), or the like. In this case, the management server 1 may release the correspondence relation between the targets in accordance with arrival of the release time point. The release time point may be set as an expiration period of the linking information D10 described above. In a case where the release time point is set as the expiration period, the management server 1 may perform operation assuming that the correspondence relation between the targets is released in accordance with arrival of the release time point.

Further, in another example, the number of correspondence relations that can be set to the same individual of each target (VA, WA) may be unlimited or limited. In a case where the number of correspondence relations that can be set is limited, an upper limit value (threshold) may be provided for the number of correspondence relations that can be set to the same individual. The threshold may be provided as appropriate. In a case where the number of correspondence relations set to the corresponding individual of at least one of the first target VA and the second target WA exceeds this upper limit value, the management server 1 may release at least one of the correspondence relations set to the corresponding individual. Which correspondence relation is to be released may be determined as appropriate in accordance with priority, order, a type of the target, or the like. The management server 1 may transmit an inquiry regarding release of at least one of the first terminal 4 and the second terminal 5 and determine the correspondence relation to be released in accordance with the obtained response.

For example, as in the example of FIG. 2, a scene will be assumed where the first target VA is the user, and the second target WA is the object to be used. In this case, the number of users that can be linked to the same object to be used may be unlimited or limited. In a case where the number of users that can be linked is limited, an upper limit value of the number of users that can be linked may be provided as appropriate as a threshold. The threshold may be set in accordance with an attribute (for example, the number of available passengers) of the object to be used. When the management server 1 newly accepts setting of a correspondence relation for the corresponding individual of the object to be used, the management server 1 may extract previous correspondence relations set and maintained for the corresponding individual of the object to be used with reference to the linking information D10. In a case where overlapping of the setting of the correspondence relations for the corresponding individual of the object to be used exceeds the threshold by the newly accepted setting of the correspondence relation, the management server 1 may discard the request for the newly accepted setting of the correspondence relation or may release at least one of the extracted previous correspondence relations. In a case where at least one of the previous correspondence relations is released, the management server 1 may determine the correspondence relation to be released in accordance with priority of the user, order (for example, releasing correspondence relations set earlier), or the like.

As a specific example, it is assumed in the example of FIG. 2 that the mobile body is an owner-driven car, and the first user and the second user are, for example, family members and share the target owner-driven car. The owner-driven car may read as the object to be constantly used. For explanatory convenience, it is assumed that the number of users that can be linked to the target owner-driven car is one. In this case, while a correspondence relation between one of the first user and the second user and the owner-driven car is set, the management server 1 may release the previous correspondence relation (correspondence relation between one target and the owner-driven car) in accordance with acceptance of setting of a correspondence relation between the other target and the owner-driven car.

This may similarly apply to the user. In other words, the number of objects to be used that can be linked to the same user may be unlimited or limited. In a case where the number of objects to be used that can be linked is limited, and the number of correspondence relations set for the corresponding user exceeds an upper limit value, the management server 1 may discard a request for newly accepted setting of a correspondence relation or release at least one of the extracted previous correspondence relations. In a case where at least one of the previous correspondence relations is released, the management server 1 may determine the correspondence relation to be released in accordance with priority, a type (for example, whether the object is an object to be constantly used or an object to be temporarily used), or the like, of the object to be used.

As described above, the management server 1 may release the correspondence relation in accordance with receipt of the release demand from at least one of the first terminal 4 and the second terminal 5 or satisfaction of the predetermined release condition. According to one example of the present embodiment, it is possible to track extinction of the use relation between the first target VA and the second target WA. Note that the linking information D10 after the correspondence relation is released may be stored as history.

### (Normal Processing/Simplified Processing)

In the present embodiment, in a case where the predetermined condition is not satisfied, authentication processing of both the first target VA and the second target WA is executed. On the other hand, in a case where the predetermined condition is satisfied, authentication processing of one of the first target VA and the second target WA is omitted. In the following description, for explanatory convenience, the processing of the former route in which the authentication processing of both the first target VA and the second target WA is executed (that is, the authentication processing is not omitted) will also be referred to as “normal processing of linking setting”. The processing of the latter route in which the correspondence relation is set while omitting authentication processing of one of the first target VA and the second target WA will also be referred to as “simplified processing of linking setting”.

Omission of authentication may include omission of acquisition of the authentication result. Omission of authentication in the management server 1 may include omission of execution of the authentication processing by the management server 1 and omission of acquisition by the management server 1, of the authentication result executed by another device other than the management server 1. In the latter case, execution of the authentication processing may be omitted in other devices.

The processing may be switched between the normal processing and the simplified processing using an arbitrary method. In one example, when the authentication processing is executed, whether or not the predetermined condition is satisfied may be determined by at least one of the management server 1, the external server (such as the first server 2 and the second server 3), the first terminal 4, and the second terminal 5. As a result of the determination processing, whether or not to execute the simplified processing may be switched. One of the devices may determine whether or not the predetermined condition is satisfied using at least one of information held by the own device and information provided from another device. The information to be used for determination may be selected as appropriate in accordance with the predetermined condition. Further, in another example, for example, a program including a mode for executing the simplified processing may be installed only in a terminal that is likely to satisfy the predetermined condition, such as a terminal of the object be used for which the simplified processing is allowed, and whether or not to execute the simplified processing may be switched by operation of this terminal. The processing of the mode for executing the simplified processing may include, for example, storage of information on a linking partner, transmission of a linking demand through the simplified processing, and the like. As described above, switching between the normal processing and the simplified processing may be implemented as a result of execution of arbitrary information processing such as determination processing or may be implemented as a result of satisfaction of the predetermined condition without information processing.

The linking demand by the simplified processing may be transmitted from at least one of the first terminal 4 and the second terminal 5. At least one of the first terminal 4 and the second terminal 5 may directly transmit the linking demand by the simplified processing to the management server 1 or may indirectly transmit the linking demand to the management server 1 via an external computer (for example, an external server such as the first server 2 and the second server 3). In a case where the authentication processing is executed by the external server, omission of authentication may include omission of data communication with the external server, omission of execution of authentication processing and execution of the subsequent information processing while data communication with the external server is executed.

In one example, in a case where a form in which the management server 1 or the external server executes authentication processing is employed, the first terminal 4 of the first target VA may be configured to cause the management server 1 to execute setting a correspondence relation between the first target VA and the second target WA by transmitting the linking demand to the management server 1, transmitting the linking demand in cooperation with the second terminal 5 of the second target WA or causing the second terminal 5 to transmit the linking demand upon occurrence of the use relation between the first target VA and the second target WA. In a case where the predetermined condition is not satisfied, the linking demand may include authentication requests for the first target VA and the second target WA. The authentication processing of each target (VA, WA) in response to the authentication requests may be executed in at least one of the management server 1 and the external server (such as the first server 2 and the second server 3). Setting the correspondence relation between the first target VA and the second target WA may include setting the correspondence relation between the first target VA and the second target WA in accordance with success in authentication of both the first target VA and the second target WA executed based on the authentication requests. On the other hand, in a case where the predetermined condition is satisfied, the authentication request for one target out of the first target VA and the second target WA may be omitted, and the linking demand may include an authentication request for the other target. Setting the correspondence relation between the first target VA and the second target WA may include setting the correspondence relation between the first target VA and the second target WA in accordance with success in authentication of the other target executed based on the authentication request.

In a similar manner, in a case where a form in which the management server 1 or the external server executes authentication processing is employed, the second terminal 5 of the second target WA may be configured to cause the management server 1 to execute setting of a correspondence relation between the first target VA and the second target WA by transmitting the linking demand to the management server 1, transmitting the linking demand in cooperation with the first terminal 4 of the first target VA and causing the first terminal 4 to transmit the linking demand upon occurrence of the use relation between the first target VA and the second target WA. In a case where the predetermined condition is not satisfied, the linking demand may include authentication requests for the first target VA and the second target WA. The authentication processing of each target (VA, WA) in response to the authentication requests may be executed in at least one of the management server 1 and the external server (such as the first server 2 and the second server 3). Setting the correspondence relation between the first target VA and the second target WA may include setting the correspondence relation between the first target VA and the second target WA in accordance with success in authentication of both the first target VA and the second target WA executed based on the authentication requests. On the other hand, in a case where the predetermined condition is satisfied, the authentication request for one target out of the first target VA and the second target WA may be omitted, and the linking demand may include the authentication request for the other target. Setting the correspondence relation between the first target VA and the second target WA may include setting the correspondence relation between the first target VA and the second target WA in accordance with success in authentication of the other target executed based on the authentication request.

Whether the processing to be executed is the simplified processing or the normal processing may be determined as appropriate. In one example, in a case where a form in which at least one of the management server 1 and the external server executes authentication processing is employed, at least one of the management server 1 and the external server may determine which of the simplified processing and the normal processing is to be executed in accordance with information included in the linking demand from at least one of the first terminal 4 and the second terminal 5. For example, the linking demand may include information indicating whether or not the processing to be executed is the simplified processing, and which of the simplified processing and the normal processing is to be executed may be determined in accordance with this information. Further, for example, which of the simplified processing and the normal processing is to be executed may be determined by information regarding at least one of the first target VA and the second target WA such as the first identifier I10, the second identifier I20, and a combination of these.

In one example, the linking demand by the simplified processing may include the first identifier I10 and the second identifier I20. The first identifier I10 and the second identifier I20 included in the linking demand may be obtained from at least one of each terminal (4, 5) and the external server in a process of being transmitted from at least one of the first terminal 4 and the second terminal 5 to the management server 1. However, as described above, a configuration of the linking demand by the simplified processing does not have to be limited to such an example. In another example, at least one of the first identifier I10 and the second identifier I20 may be omitted from the linking demand by the simplified processing by using substitute information.

Further, in one example, a transmission form in authentication processing of the other target out of the first target VA and the second target WA in the simplified processing may be the same as or different from a transmission form in the normal processing. For example, the normal processing assumes a form in which the first terminal 4 requests authentication of the second target WA to the second server 3, and the second terminal 5 requests authentication of the first target VA to the first server 2. In this case, in one example, in the simplified processing, the first terminal 4 may request authentication of the second target WA to the second server 3. Alternatively, the second terminal 5 may request authentication of the first target VA to the first server 2. In another example, in the simplified processing, the first terminal 4 may request authentication of the first target VA to the first server 2, or the second terminal 5 may request authentication of the second target WA to the second server 3.

Note that as one of optional configurations, at least one of the management server 1 and the external server (such as the first server 2 and the second server 3) may acquire identification information (such as a MAC address and terminal identification information) of at least one of the first terminal 4 and the second terminal 5 for which the simplified processing is allowed and store the acquired identification information as registration processing of the target for which the simplified processing is allowed. This registration processing may be executed at an arbitrary timing such as upon past linking setting. At least one of the management server 1 and the external server may be configured to accept a request for linking setting by the simplified processing from only the terminal identified by the identification information.

In one example, a trigger of the request for linking setting by the simplified processing may be similar to the trigger in the normal processing. In other words, at least one of the first terminal 4 and the second terminal 5 may transmit a request for linking setting by the simplified processing by being triggered by data exchange between the first terminal 4 and the second terminal 5. However, the trigger of the simplified processing does not have to be limited to such an example. In another example, in a case where at least one of the first target VA and the second target WA is the user, a request for linking setting by the simplified processing may be transmitted from at least one of the first terminal 4 and the second terminal 5 by operation of the at least one of the first terminal 4 and the second terminal 5 by the user. In other words, the trigger of the request for linking setting by the simplified processing may be operation by the user. In another example, the trigger of the request for linking setting by the simplified processing may be an instruction by other applications (such as a scheduler). In another example, arbitrary information processing may be executed in at least one of the first terminal 4 and the second terminal 5 in association with occurrence of the use relation. The request for linking setting by the simplified processing may be transmitted from at least one of the first terminal 4 and the second terminal 5 by being triggered by this arbitrary information processing.

Further, in one example, processing of releasing the correspondence relation set by the simplified processing (release processing for the simplified processing) may be similar to the processing of linking release in the normal processing described above (release processing for the normal processing). However, the release processing for the simplified processing does not necessarily have to be the same as the release processing for the normal processing. The correspondence relation set by the simplified processing may be released as appropriate. In another example, in a case where a transmission route of a request for setting the correspondence relation by the simplified processing is different from a transmission route of a release request for the normal processing, a transmission route of a release request for the simplified processing may be adapted to the transmission route of a request for setting the correspondence relation by the simplified processing.

Note that in the simplified processing, a target for which the authentication processing is to be omitted may be either the first target VA or the second target WA and may be selected as appropriate in accordance with an embodiment. The target for which the authentication processing is to be omitted may be selected in accordance with, for example, a type of each target (VA, WA), a relationship, or the like. In one example, the first target VA may be the user, and the second target WA may be an object to be used by the user. Authentication (authentication to be omitted) of one target out of the first target VA and the second target WA in a case where the predetermined condition is satisfied may be authentication of the object to be used. Authentication of the other target (authentication not to be omitted) may be authentication of the user. According to one example of the present embodiment, it is possible to reduce trouble by omitting authentication of the object to be used while maintaining security by user authentication.

### (Predetermined Condition)

The predetermined condition specifies which of the normal processing and the simplified processing is to be executed. The predetermined condition may be determined as appropriate in accordance with an embodiment. In one example, in a case where occurrence and extinction of the use relation are repeated in the same combination between the first target VA and the second target WA, the system 100 may execute authentication processing of the first target VA and the second target WA each time and repeat setting and release of the correspondence relation. However, in a case where occurrence and extinction of the use relation are frequently repeated, the same authentication processing will be executed each time, which may become trouble. Thus, the predetermined condition is preferably specified so that the simplified processing is selected for such a combination of the first target VA and the second target WA for which occurrence and extinction of the use relation are likely to be frequently repeated. The predetermined condition may include at least one of the following two conditions.

### (1) First Condition

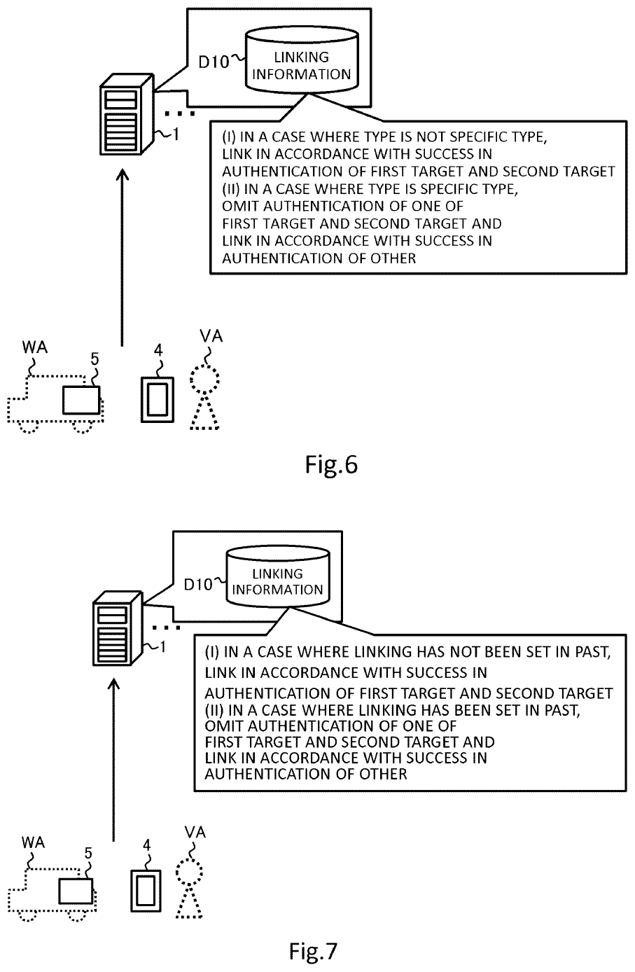

FIG. 6 schematically illustrates one example of the predetermined condition (first condition) according to the present embodiment. For example, occurrence and extinction of the use relation are likely to be frequently repeated if a type of at least one of the first target VA and the second target WA is a specific type such as an object to be constantly used. Thus, the first condition may be a condition that a type of at least one of the first target VA and the second target WA is the specific type. The predetermined condition may include the first condition.

In other words, in a case where the types of the first target VA and the second target WA are not the specific type, the system 100 may set the correspondence relation by the normal processing. On the other hand, in a case where a type of at least one of the first target VA and the second target WA is the specific type, the system 100 may set the correspondence relation by the simplified processing. In one example, the specific type may be set to each of the first target VA and the second target WA. In another example, the specific type may be set to only one target out of the first target VA and the second target WA, and the other target may be omitted. According to one example of the present embodiment, whether or not to execute the simplified processing can be controlled in accordance with a type of at least one of the first target VA and the second target WA.

The specific type may be set as appropriate in accordance with an embodiment. In one example, the first target VA may be the user, and the second target WA may be the object to be used by the user. Further, a type of at least one of the first target VA and the second target WA being the specific type may include that the object to be used is an object to be repeatedly and constantly used by the user. In other words, the first condition may include that the object to be used is an object to be repeatedly and constantly used by the user. Occurrence and extinction of the use relation are more likely to be frequently repeated for the object to be constantly used than for the object to be temporarily used. Thus, according to one example of the present embodiment, by allowing the simplified processing for the object to be constantly used, it is possible to track the use relation between the user and the object to be used while maintaining security and reduce trouble of the tracking. Note that the simplified processing may be allowed or does not have to be allowed for the object to be temporarily used. In one example, the system 100 may be configured to establish setting of the correspondence relation by the normal processing every time the use relation occurs by not allowing the simplified processing for the object to be temporarily used.

The authentication mode may be switched in accordance with the type using an arbitrary method. In one example, before execution of the authentication processing is started, at least one device out of the management server 1, the external server, the first terminal 4, and the second terminal 5 may identify a type of at least one of the first target VA and the second target WA and may determine which of the normal processing and the simplified processing is to be executed in accordance with the identification result. Starting execution of the authentication processing may be, for example, acquisition of data to be used for the authentication by at least one of the first terminal 4 and the second terminal 5. The external server may be, for example, the first server 2, the second server 3, or the like. A type of at least one of the targets may be identified as appropriate. In one example, the type of at least one of the targets may be identified using the information included in each piece of the target information (O10, O20) such as an identifier and attribute information. In a case of the object to be used described above, whether or not the object to be used is an object to be constantly used may be identified in accordance with attribute information (for example, a type, a type of the mobile body) included in the mobile body information O20A. At least one of the devices may hold information for identifying the type in advance and may identify the type of at least one of the targets using this information. Alternatively, at least one of the devices may identify the type of at least one of the targets by referring to information held by an external device. At least one of the first terminal 4 and the second terminal 5 may determine which of the normal processing and the simplified processing is to be executed and may start execution of the authentication processing in a mode in accordance with the determination result. Alternatively, at least one of the terminals may receive a determination result from at least one of the management server 1 and the external server and may start execution of the authentication processing in a mode in accordance with the received determination result. In another example, a program including a mode for executing the simplified processing may be installed only in a terminal of a target that satisfies the condition of the specific type, such as a terminal (the second terminal 5 in FIG. 2) of the object to be constantly used, and whether or not to execute the simplified processing may be switched by operation of this terminal.

### (2) Second Condition

FIG. 7 schematically illustrates one example of the predetermined condition (second condition) according to the present embodiment. Whether or not occurrence and extinction of the use relation are repeated can be specified from history of the linking setting. Thus, the second condition may be a condition that the correspondence relation has been set in the past for the same combination (combination of the same individuals) between the first target VA and the second target WA. The predetermined condition may include the second condition.

In other words, in a case where the correspondence relation has not been set in the past for the combination of the same individuals of the first target VA and the second target WA, the system 100 may set the correspondence relation by the normal processing. On the other hand, in a case where the correspondence relation has been set in the past for the combination of the same individuals, the system 100 may set the correspondence relation by the simplified processing. According to one example of the present embodiment, it is possible to maintain security by executing authentication processing in a mode of normal processing at least once and reduce trouble by executing authentication processing in a mode of simplified processing thereafter.

The authentication mode may be switched under this second condition using an arbitrary method. Information on the combination of the first target VA and the second target WA for which the correspondence relation has been set in the past may be managed by at least one of the management server 1, the external server, the first terminal 4, and the second terminal 5. Management may include updating (generation) and deletion of data held by at least one of a memory within the own device and a memory of an external device.

In one example, the linking information D10 may be maintained as history after the correspondence relation is released. The management server 1 may determine whether or not the combination of the corresponding individuals of the first target VA and the second target WA for which the linking demand is accepted is the combination for which the correspondence relation has been set in the past by the history of the linking information D10. In a case where it is determined that the combination is the combination for which the correspondence relation has been set in the past, the management server 1 may accept linking setting by the simplified processing. Further, the management server 1 may transmit a command (for example, a command for starting processing regarding authentication in the simplified processing mode) for activating the simplified processing on the combination, to at least one of the first terminal 4 and the second terminal 5.

In another example, the first terminal 4 may acquire the second identifier I20 of the second target WA at an arbitrary timing such as upon linking setting by the normal processing mode and store the acquired second identifier I20 as a partner (that is, a partner for which the simplified processing is allowed) for which the correspondence relation has been set in the past. In a similar manner, the second terminal 5 may also acquire the first identifier I10 of the first target VA and may store the acquired first identifier I10 as a partner of the simplifier processing. By this means, at least one of the first terminal 4 and the second terminal 5 may hold information on the partner for which the correspondence relation has been set in the past and determine which of the normal processing and the simplified processing is to be executed using the held information on the partner. For example, linking setting by the simplified processing mode may be activated for the same partner by the linking setting by the normal processing mode being executed in at least one of the terminals. In accordance with this, the at least one of the terminals may be configured to be able to execute the linking demand by the simplified processing mode for the corresponding partner.

In another example, the external server may store a combination of the first target VA and the second target WA in an accessible memory area when the external server is involved with the authentication processing. For example, the first server 2 may accept authentication of the first target VA by receiving data to be used for authentication of the first target VA along with the first identifier I10. In this event, the first server 2 may also receive the second identifier I20 of the second target WA that becomes a partner for which the correspondence relation is to be set. The first server 2 may store information on the partner for which the correspondence relation has been set in the past by storing the second identifier I20 in association with the first identifier I10 (first target information O10). The same will also apply to the second server 3. In accordance with this, when the external server is newly involved with authentication processing, the external server may determine whether or not the combination of the first target VA and the second target WA for which setting of the correspondence relation by the authentication processing to be involved is requested is the combination for which the correspondence relation has been set in the past by referring to the held information. In a case where it is determined that the combination is the combination for which the correspondence relation has been set in the past, the external server may accept linking setting by the simplified processing. Further, the external server may transmit a command for activating the simplified processing for the combination (for example, a command for starting processing related to authentication in the simplified processing mode) to at least one of the first terminal 4 and the second terminal 5.

Note that in one example, the system 100 may be configured, after the simplified processing mode is activated by the authentication processing by the normal processing mode being executed once, to permanently execute linking setting by the simplified processing mode. In other words, a range of the past may be unlimited. In another example, activation of the simplified processing mode may be temporary, and after activation of the simplified processing mode is resolved, the authentication processing by the normal processing mode may be executed again. In other words, the range of the past may be limited. Activation of the simplified processing mode may be resolved for an arbitrary reason such as elapse of the expiration period.

Further, when processing related to authentication by the normal processing mode is executed, at least one of the first terminal 4 and the second terminal 5 may store at least part of data to be used for authentication (such as, for example, an identifier, unique information, and a certificate) in the memory resource. Then, when execution of the processing by the simplified processing mode is started, at least one of the first terminal 4 and the second terminal 5 may read out data to be used for the authentication from the memory resource and execute the processing related to authentication using the readout data.

The above-described first condition and second condition may be used in combination. In other words, the predetermined condition may include a condition that the correspondence relation has been set in the past for the same combination of the first target VA and the second target WA, and that a type of at least one of the first target VA and the second target WA is the specific type. According to one example of the present embodiment, it can be expected that security is maintained while reducing trouble by requesting authentication processing by the normal processing at least once also for the specific type.

Further, in a case where the first condition and the second condition are used in combination, the first target VA may be the user, and the second target WA may be the object to be used by the user. Further, the type of at least one of the first target VA and the second target WA being the specific type may include that the object to be used is the object to be repeatedly and constantly used by the user. According to one example of the present embodiment, by requesting the authentication processing by the normal processing at least once for the object to be constantly used, it can be expected that security is maintained while achieving reduction in trouble.

The type of the object to be used may be selected as appropriate in accordance with an embodiment. In one example, the object to be used may be a mobile body (example of FIG. 2). By this means, in a scene in which a mobile body appears, it is possible to track the use relation while maintaining security and achieve reduction in trouble of the tracking. Further, in one example, the object to be constantly used may be an owner-driven car. Regarding the owner-driven car, it is possible to achieve reduction in trouble of tracking the use relation.

### (Confirmation Processing of Use Continuation)

As one of optional configurations, after the correspondence relation between the corresponding individual of the first target VA and the corresponding individual of the second target WA is set, the management server 1 may further execute processing (confirmation processing) for confirming whether or not the correspondence relation is continued. A confirmation method of use continuation may be selected as appropriate in accordance with an embodiment.

(i-1) Confirmation Processing by Authentication

In one example, the management server 1 may confirm whether the correspondence relation is continued by authenticating at least one of the first target VA and the second target WA via at least one of the first terminal 4 and the second terminal 5. The authentication method may be performed using an arbitrary method in a similar manner to the linking setting or the like. In the example of FIG. 2, for example, the user may be authenticated using a method of performing face authentication of the user using an image sensor provided in a mobile body, a method of performing fingerprint authentication of the user using a fingerprint reading device attached to a steering wheel, a method of performing voice spectrum authentication using a microphone provided in a mobile body by causing the user to make an utterance, or the like. The authentication processing may be executed in at least one of the terminal (4, 5), the server (2, 3), and the management server 1. In a case where the server (2, 3) executes the authentication processing, data to be used for the authentication may be directly transmitted from the terminal (4, 5) to the server (2, 3) or may be indirectly transmitted via an external computer such as the management server 1. In a case where the management server 1 executes the authentication processing, data to be used for the authentication may be directly transmitted from the terminal (4, 5) to the management server 1 or may be indirectly transmitted via an external computer such as each server (2, 3). The management server 1 may acquire the authentication result as appropriate, may determine that the correspondence relation is continued in a case where authentication of the target is successful and may determine that the correspondence relation is not continued in a case where authentication is not successful in the acquired authentication result.

(i-2) Confirmation Processing by Notification

In another example, in a case where at least one of the first target VA and the second target WA is the user (for example, a case of FIG. 2), the management server 1 may directly or indirectly transmit a confirmation notification including an operation piece to at least one of the first terminal 4 and the second terminal 5. The operation piece may include, for example, a confirmation button, a return button, a link, or the like. A transmission destination of the confirmation notification does not necessarily have to correspond to the user. In the case of FIG. 2, the management server 1 may transmit the confirmation notification to at least one of the first terminal 4 and the second terminal 5. The transmission destination of the confirmation notification may overlap with or may be different from a transmission destination of a notification indicating a result of the processing regarding linking. The confirmation notification may be configured to directly or indirectly return a response to the management server 1 in accordance with operation of the operation piece by the user. The management server 1 may determine that the correspondence relation is continued in a case where a response by the operation of the operation piece is received within a predetermined period and may determine that the correspondence relation is not continued in a case where a response is not received.

(i-3) Confirmation Processing by Position Information

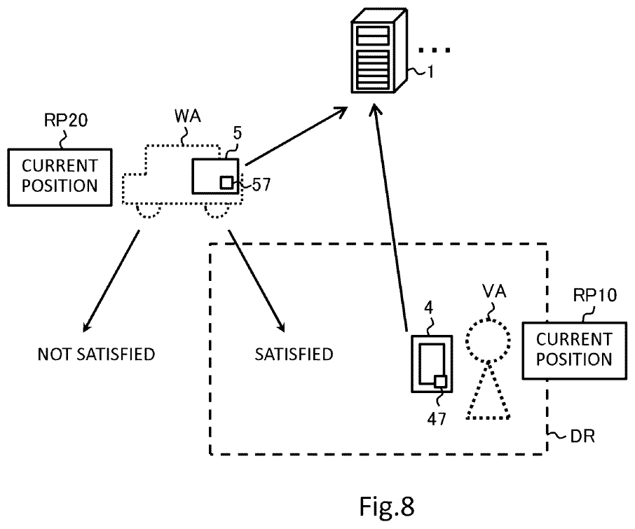

FIG. 8 schematically indicates one example of confirmation processing of use continuation according to the present embodiment. In a case where a use relation is tracked in the real world, the first terminal 4 may include a positioning module 47. The first terminal 4 may be further configured to measure a current position of the first terminal 4 using the positioning module 47 of the first terminal 4 and transmit a measurement result of the current position of the first terminal 4 to the management server 1. Further, the second terminal 5 may include a positioning module 57. The second terminal 5 may be further configured to measure a current position of the second terminal 5 using the positioning module 57 of the second terminal 5 and transmit a measurement result of the current position of the second terminal 5 to the management server 1.

In accordance with this, the management server 1 may be further configured to set the correspondence relation between the first target VA and the second target WA and then receive the measurement result of the current position (RP10, RP20) of each terminal (4, 5) from each terminal (4, 5), determine whether or not the received measurement result of the current position (RP10, RP20) of each terminal (4, 5) satisfies a condition of the use relation in real time, determine that the correspondence relation between the first target VA and the second target WA is continued in a case where the measurement result of the current position (RP10, RP20) of each terminal (4, 5) satisfies the condition of the use relation and determine that the correspondence relation is not continued in a case where the measurement result does not satisfy the condition.

The condition of the use relation may be set as appropriate in accordance with an embodiment, for example, such that the user is close to the mobile body in such a degree that the user gets on the mobile body. In one example, the condition of the use relation may be specified by a range DR of a distance based on the current position RP10 of the first terminal 4 or the current position RP20 of the second terminal 5. In this case, whether or not the condition of the use relation is satisfied may be determined in accordance with whether or not the current position exists within the range DR. FIG. 8 assumes a scene based on the current position RP10 of the first terminal 4. In this scene, it may be determined that the condition of the use relation is satisfied by the current position RP20 of the second terminal 5 falling within the range DR. On the other hand, it may be determined that the condition of the use relation is not satisfied by the current position RP20 of the second terminal 5 falling outside the range DR.

Note that the range DR may be set as appropriate so as to be able to determine the second target WA for which the use relation occurs. A shape of the range DR may be arbitrarily specified. The range DR may be specified such that distances in respective directions are the same, or distances are different in at least some of the directions.

A type of each positioning module (47, 57) does not have to be particularly limited and may be selected as appropriate in accordance with an embodiment. Each positioning module (47, 57) may be, for example, a global positioning satellite (GPS) module, a global navigation satellite system (GNSS) module, or the like.

The current position (RP10, RP20) of each terminal (4, 5) may be transmitted to the management server 1 at an arbitrary timing before the confirmation processing is executed. In one example, each terminal (4, 5) may report information on each current position to the management server 1 as spontaneous information processing such as periodic transmission. In this case, the management server 1 may determine whether or not the condition of the use relation is satisfied using each current position recently reported from each terminal (4, 5) as each current position (RP10, RP20). Further, in another example, the management server 1 may directly or indirectly transmit a request to each terminal (4, 5) at an arbitrary timing before the confirmation processing is executed. Each terminal (4, 5) may report each recent current position (RP10, RP20) to the management server 1 in real time in response to this request. The management server 1 may determine whether or not the condition of the use relation is satisfied from information on each recent current position (RP10, RP20) reported in real time. Note that in either embodiment, in a case where information on a recent current position of at least one of the first terminal 4 and the second terminal 5 cannot be obtained due to power-off or the like, the management server 1 may determine that the condition of the use relation is not satisfied.

Further, a device to which the information on each current position is to be reported may be selected as appropriate in accordance with an embodiment. In one example, the information on each current position may be reported to the management server 1. In accordance with this, the information on each current position may be managed by the management server 1. In another example, the information on each current position may be reported to an external server (such as the first server 2 and the second server 3). In accordance with this, the information on each current position may be managed by the external server. The management server 1 may acquire the information on each current position (RP10, RP20) from the external server. Reporting the information on each current position to the management server 1 may include directly reporting the information on each current position to the management server 1 and indirectly reporting the information on each current position to the management server 1 via the external server. The reported information on each current position may be discarded after the information is no longer used in the confirmation processing or may be stored as history for at least a predetermined period. In a case where a form in which the information each current position is directly reported to the management server 1 is employed, the information may be stored in the management server 1 or may be stored in an external server (such as the first server 2, the second server 3, and a NAS). In a similar manner, also in a case where a form in which the information is indirectly reported to the management server 1 is employed, the information on each current position may be stored in the management server 1 or may be stored in the external server. According to one example of the present embodiment, it is possible to appropriately confirm continuation of the correspondence relation by using a relation of positions between the first target VA and the second target WA (the first terminal 4 and the second terminal 5).

(ii)

In a case where it is determined that the correspondence relation is continued, the management server 1 may maintain the setting of the correspondence relation. On the other hand, in a case where it is determined that the correspondence relation is not continued, the management server 1 may release the correspondence relation. The management server 1 may be configured to update a state of the correspondence relation by repeatedly executing the confirmation processing regularly or irregularly until the correspondence relation is released.

Note that in a case where it is determined that the correspondence relation is not continued, the management server 1 may immediately release the correspondence relation or may release the correspondence relation after holding the correspondence relation for a predetermined period. A timing of release may be determined as appropriate in accordance with an embodiment. In a case where the latter method is employed, in a case where continuation of the correspondence relation is confirmed using at least one of the methods described above, the management server 1 may restore the setting of the correspondence relation during holding. This makes it possible to restore the setting of the correspondence relation early without releasing the correspondence relation promptly in a case where the targets are temporarily separate from each other.

(Scene in which Linking Information is Used)

As described above, the linking information D10 may be used in various scenes. In one example, the linking information D10 may be used to simply track occurrence and extinction of the relation between the first target VA and the second target WA.

In another example, the linking information D10 may be used to enable at least part of authority linked to one of the first target VA and the second target WA to be exercised from the other while the correspondence relation is set between the first target VA and the second target WA. For example, the management server 1 may be configured to further execute activation of exercise of authority associated with the corresponding first target VA via the second target WA for which the correspondence relation is set in accordance with establishment of the correspondence relation between the first target VA and the second target WA. Further, the management server 1 may be configured to further execute deactivation of exercise of the authority in accordance with release of the correspondence relation. In the example of FIG. 2, the linking information D10 may be used to be able to exercise at least part of the authority linked to the user from the mobile body while the correspondence relation is set between the user and the mobile body. According to one example of the present embodiment, it is possible to control permission and prohibition of exercise of authority of the first target VA by the second target WA by setting and releasing the correspondence relation.

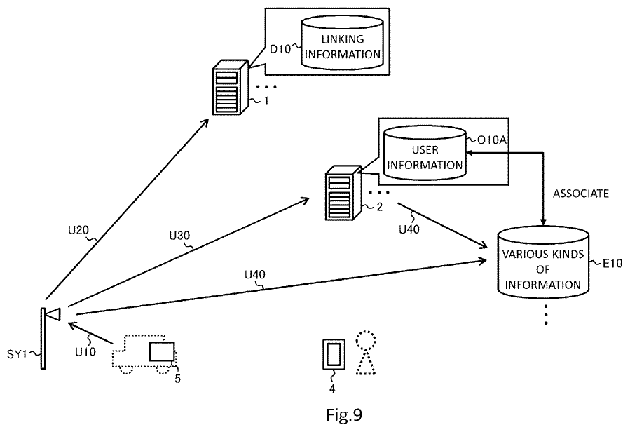

FIG. 9 schematically illustrates one example of a scene in which the linking information D10 is used according to the present embodiment. FIG. 9 assumes a scene in which the mobile body exercises authority linked to the user in the example of FIG. 2. Further, it is assumed that the linking information D10 is configured to indicate the first target VA (user) and the second target WA (mobile body) for which the correspondence relation is set by including the first identifier I10 and the second identifier I20. Still further, a scene is assumed where information on the user is managed by the first server 2, and information on the mobile body is managed by the second server 3. An external system SY1 is deployed at a place (such as, for example, a parking area) where various kinds of services are to be exercised and is configured to execute information processing for providing a target service to the user having target authority. The configuration and the service of the external system SY1 does not have to be particularly limited and may be selected as appropriate in accordance with an embodiment.

First, in step U10, the external system SY1 may acquire the second identifier I20 (mobile body identifier) from the target mobile body. An acquisition method of the second identifier I20 may be selected as appropriate in accordance with an embodiment. In one example, the external system SY1 may acquire the second identifier I20 from the second terminal 5 by performing data exchange with the second terminal 5. A method of the data exchange may be similar to the method of the data exchange between the first terminal 4 and the second terminal 5. In another example, in a case where the second identifier I20 is a vehicle registration number, the external system SY1 may acquire the second identifier I20 by capturing an image of a car registration plate by an image sensor and analyzing the obtained image.

In step U20, the external system SY1 may inquire at the management server 1 as to whether or not there is a valid correspondence relation with the target mobile body on the target date and time using the acquired second identifier I20 as a query. Valid means that setting of the correspondence relation is maintained on the target date and time. Further, basically, the target date and time is present (real time), but the target date and time does not have to be limited to this. For example, in a case where payment processing at the past date and time is executed, the target date and time may be past date and time. In a case where there is a valid correspondence relation, the first identifier I10 (user identifier) of the user linked to the target mobile body is extracted. On the other hand, in a case where there is no valid correspondence relation and the user linked to the target mobile body is not extracted, the present processing may end.

In step U30, the external system SY1 may inquire at the first server 2 as to exercisable authority for the user linked to the target mobile body using the extracted first identifier I10 as a query. The first server 2 may extract exercisable authority associated with the target user with reference to the first target information O10 (user information O10A). In a case where exercisable authority is not extracted, the present processing may end. Note that whether or not to allow exercise of authority by the mobile body may be set for each kind of authority in the first target information O10 (user information O10A). The exercisable authority may be extracted in accordance with this setting. Further, the present processing may end also in a case where the target authority to be exercised by the external system SY1 is not included in the exercisable authority. The authority to be exercised may be set as appropriate at an arbitrary timing. In one example, the authority to be exercised may be designated in advance in the external system SY1 or may be designated by the user.

In step U40, in a case where the exercisable authority includes the target authority, the external system SY1 may execute processing for exercising the target authority. By this means, the authority linked to the user is exercised from the mobile body, so that the user can receive a service via the mobile body. For example, in a case where the authority information includes information of public personal authentication, and the target authority relates to the public personal authentication, the user can receive a government-provided service via the mobile body. Further, for example, in a case where the authority information includes payment information, and the target authority relates to payment, the user can receive a payment service via the mobile body. The payment service may be, for example, payment of a fee for a parking area, a toll of an expressway, a charge at a drive-through, a fare of public transportation, a rental charge, or the like. Further, for example, in a case where the authority information includes information regarding an electronic prescription, and the target authority is receipt of drugs prescribed by the electronic prescription, the user can receive the drugs by exercising the electronic prescription via the mobile body.

Note that processing procedure when the above-described authority is exercised is merely one example, and each step may be changed as far as possible. Concerning the above-described processing procedure, the steps can be omitted, replaced, and added as appropriate in accordance with an embodiment. Further, in the above-described processing procedure, the user may be replaced with the first target VA, and the mobile body may be replaced with the second target WA. Still further, in the above-described processing procedure, the “first” and the “second” may be switched to each other.

### (Data Communication Between Devices)

Data communication between devices (the management server 1, the first server 2, the second server 3, the first terminal 4, and the second terminal 5) does not have to be particularly limited and may be selected as appropriate in accordance with an embodiment. A network among the devices may be selected as appropriate from, for example, the Internet, a wireless communication network, a mobile communication network, a phone network, a leased line, a local area network, and the like. The data communication between the devices may be encrypted using a method such as a secure socket layer (SSL) and a transport layer security (TLS). In one example, each terminal (4, 5) may include a subscriber identity module (SIM), and data communication between each terminal (4, 5) and the server (the management server 1, the first server 2, the second server 3) may be performed through encrypted communication using the SIM.

### 2 CONFIGURATION EXAMPLE

### Hardware Configuration Example

### (Management Server)

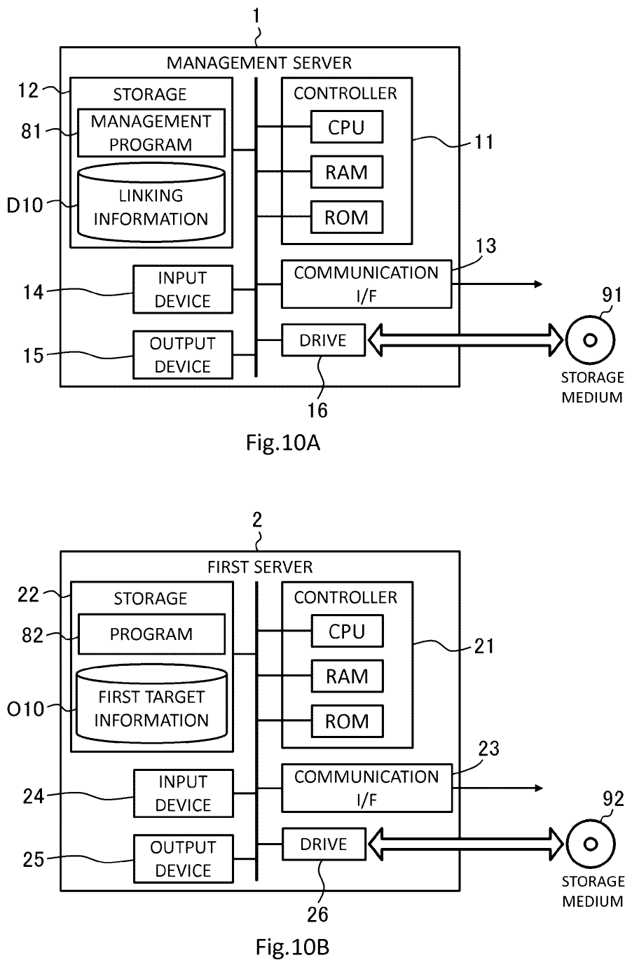

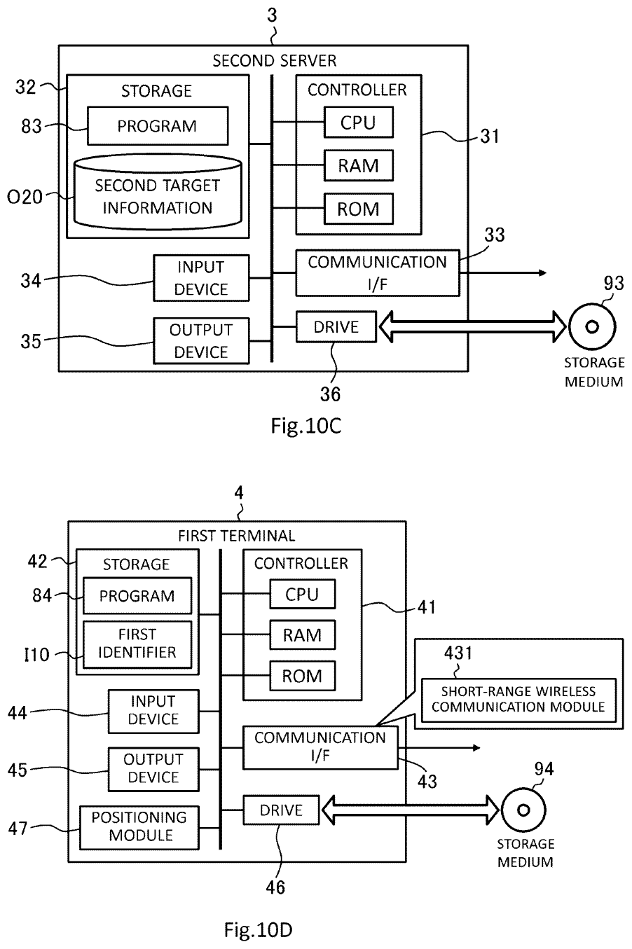

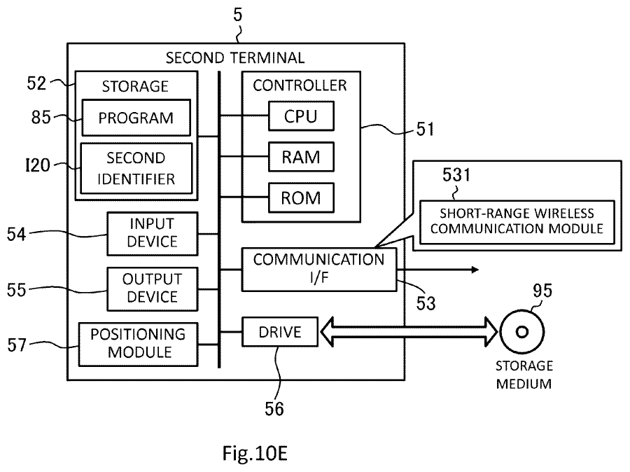

FIG. 10A schematically illustrates one example of a hardware configuration of the management server 1 according to the present embodiment. The management server 1 according to the present embodiment is a computer in which a controller 11, a storage 12, a communication interface 13, an input device 14, an output device 15, and a drive 16 are electrically connected.

The controller 11 includes a central processing unit (CPU) that is a hardware processor, a random access memory (RAM), a read only memory (ROM), and the like, and is configured to execute arbitrary information processing based on a program and various kinds of data. The controller 11 (CPU) is one example of a processor resource of the management server 1.

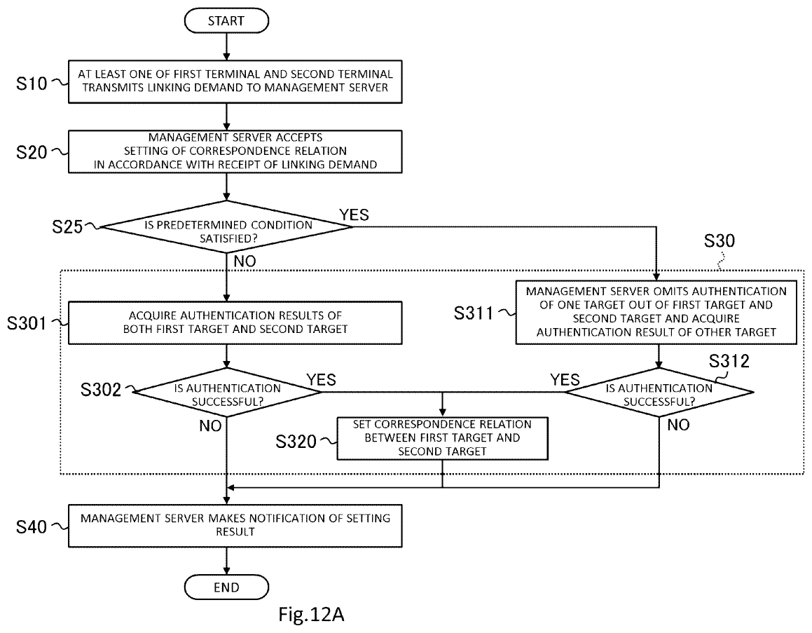

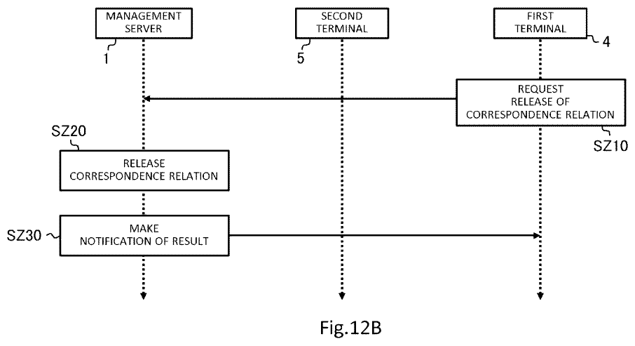

The storage 12 may include, for example, a hard disk drive, a solid state drive, a semiconductor memory, and the like. The storage 12 (and the RAM, the ROM) is one example of the memory resource. In the present embodiment, the storage 12 stores a management program 81 and various kinds of information such as the linking information D10. The management program 81 is a program for causing the management server 1 to execute information processing (FIG. 12A and FIG. 12B which will be described later) regarding setting and release of the correspondence relation between the first target VA and the second target WA. The management program 81 includes a series of commands of the information processing.

The communication interface 13 is configured to perform wired or wireless communication via a network. The communication interface 13 may include, for example, a wired local area network (LAN) module, a wireless LAN module, and the like. The management server 1 may execute data communication with other computers (the first server 2, the second server 3, the first terminal 4, the second terminal 5) via the communication interface 13.

The input device 14 is, for example, a device for performing input, such as a mouse, a keyboard, and an operation button. The output device 15 is, for example, a device for performing output, such as a display and a speaker. An operator can operate the management server 1 by using the input device 14 and the output device 15. The input device 14 and the output device 15 may be, for example, integrally constituted by a touch panel display or the like. The input device 14 and the output device 15 may be connected via an external interface. The external interface may be configured as appropriate to be connected to an external device in a wired or wireless manner using a universal serial bus (USB) port, a dedicated port, a wireless communication port, or the like.

The drive 16 is a device for loading various kinds of information such as a program stored in a storage medium 91. At least one of the management program 81 and the linking information D10 described above may be stored in the storage medium 91 in place of the storage 12 or in addition to the storage 12. The storage medium 91 is configured to accumulate various kinds of information (such as the stored program) through electric, magnetic, optical, mechanical, or chemical action so as to be able to read the information by a machine such as a computer. The management server 1 may acquire at least one of the management program 81 and the linking information D10 described above from the storage medium 91. Note that the storage medium 91 may be a disk-type storage medium such as a CD and a DVD or a storage medium other than a disk type, such as a semiconductor memory (for example, a flash memory). A type of the drive 16 may be selected as appropriate in accordance with the type of the storage medium 91. The drive 16 may be connected via the external interface.

Note that components can be omitted, replaced, and added as appropriate in accordance with an embodiment concerning a specific hardware configuration of the management server 1. For example, the controller 11 may include a plurality of hardware processors. The hardware processor may include a microprocessor, a field-programmable gate array (FPGA), a digital signal processor (DSP), a graphics processing unit (GPU), an application specific integrated circuit (ASIC), and the like. At least one of the input device 14, the output device 15, and the drive 16 may be omitted. The linking information D10 may be stored in an external computer (such as, for example, a NAS) that can be accessed by the management server 1, instead of being stored in the storage 12. The management server 1 may include a plurality of computers. In this case, hardware configurations of the respective computers may be the same or do not have to be the same. The management server 1 may be a general-purpose server device, a general-purpose computer, or the like, in addition to an information processing device designed only for a service to be provided.

### (First Server)

FIG. 10B schematically illustrates one example of a hardware configuration of the first server 2 according to the present embodiment. The first server 2 according to the present embodiment is a computer in which a controller 21, a storage 22, a communication interface 23, an input device 24, an output device 25, and a drive 26 are electrically connected. The controller 21 to the drive 26 of the first server 2 and a storage medium 92 may be constituted respectively in a similar manner to the controller 11 to the drive 16 of the above-described management server 1 and the storage medium 91.

The controller 21 (CPU) is one example of a processor resource of the first server 2, and the storage 22 (and the RAM, the ROM) is one example of the memory resource of the first server 2. In the present embodiment, the storage 22 stores a program 82 and various kinds of information such as the first target information O10. The program 82 is a program for causing the first server 2 to execute information processing regarding authentication of the first target VA. The program 82 includes a series of commands of the information processing. At least one of the program 82 and the first target information O10 may be stored in the storage medium 92 in place of the storage 22 or in addition to the storage 22. The first server 2 may acquire at least one of the program 82 and the first target information O10 from the storage medium 92. The first server 2 may perform data communication with other computers (such as the second terminal 5 and the management server 1) via the communication interface 23. The first server 2 may be operated via the input device 24 and the output device 25.

Note that concerning a specific hardware configuration of the first server 2, components can be omitted, replaced, and added as appropriate in accordance with an embodiment. For example, the controller 21 may include a plurality of hardware processors. The hardware processor may include a microprocessor, an FPGA, a DSP, a GPU, an ASIC, and the like. At least one of the input device 24, the output device 25, and the drive 26 may be omitted. The first target information O10 may be stored in an external computer (such as, for example, a NAS) that can be accessed by the first server 2, instead of being stored in the storage 22. The first server 2 may include a plurality of computers. In this case, hardware configurations of the respective computers may be the same or do not have to be the same. The first server 2 may be a general-purpose server device, a general-purpose computer, or the like, in addition to an information processing device dedicated only for a service to be provided.

### (Second Server)

FIG. 10C schematically illustrates one example of a hardware configuration of the second server 3 according to the present embodiment. The second server 3 according to the present embodiment is a computer in which a controller 31, a storage 32, a communication interface 33, an input device 34, an output device 35, and a drive 36 are electrically connected. The controller 31 to the drive 36 of the second server 3 and a storage medium 93 may be constituted respectively in a similar manner to the controller 11 to the drive 16 of the above-described management server 1 and the storage medium 91.

The controller 31 (CPU) is one example of a processor resource of the second server 3, and the storage 32 (and the RAM, the ROM) is one example of the memory resource of the second server 3. In the present embodiment, the storage 32 stores a program 83 and various kinds of information such as the second target information O20. The program 83 is a program for causing the second server 3 to execute information processing regarding authentication of the second target WA. The program 83 includes a series of commands of the information processing. At least one of the program 83 and the second target information O20 may be stored in the storage medium 93 in place of the storage 32 or in addition to the storage 32. The second server 3 may acquire at least one of the program 83 and the second target information O20 from the storage medium 93. The second server 3 may perform data communication with other computers (such as the first terminal 4 and the management server 1) via the communication interface 33. The second server 3 may be operated via the input device 34 and the output device 35.

Note that concerning a specific hardware configuration of the second server 3, components can be omitted, replaced, and added as appropriate in accordance with an embodiment. For example, the controller 31 may include a plurality of hardware processors. The hardware processor may include a microprocessor, an FPGA, a DSP, a GPU, an ASIC, and the like. At least one of the input device 34, the output device 35, and the drive 36 may be omitted. The second target information O20 may be stored in an external computer (such as, for example, a NAS) that can be accessed by the second server 3, instead of being stored in the storage 32. The second server 3 may include a plurality of computers. In this case, hardware configurations of the respective computers may be the same or do not have to be the same. The second server 3 may be a general-purpose server device, a general-purpose computer, or the like, in addition to an information processing device designed only for a service to be provided.

### (First Terminal)

FIG. 10D schematically illustrates one example of a hardware configuration of the first terminal 4 according to the present embodiment. The first terminal 4 according to the present embodiment is a computer in which a controller 41, a storage 42, a communication interface 43, an input device 44, an output device 45, a drive 46, and the positioning module 47 are electrically connected. The controller 41 to the drive 46 of the first terminal 4 and a storage medium 94 may be constituted respectively in a similar manner to the controller 11 to the drive 16 of the above-described management server 1 and the storage medium 91.

The controller 41 (CPU) is one example of a processor resource of the first terminal 4, and the storage 42 (and the RAM, the ROM) is one example of the memory resource of the first terminal 4. In the present embodiment, the storage 42 stores a program 84 and various kinds of information such as the first identifier I10. The program 84 is a program for causing the first terminal 4 to execute information processing (FIG. 12A and FIG. 12B which will be described later) regarding linking. The program 84 includes a series of commands of the information processing. At least one of the program 84 and the first identifier I10 may be stored in the storage medium 94 in place of the storage 42 or in addition to the storage 42. The first terminal 4 may acquire at least one of the program 84 and the first identifier I10 from the storage medium 94. The first terminal 4 may be operated via the input device 44 and the output device 45.

The first terminal 4 may perform data communication with other computers (such as the management server 1, the first server 2, the second server 3, and the second terminal 5) via the communication interface 43. In one example, the communication interface 43 may include a plurality of types of modules. For example, the communication interface 43 may include the short-range wireless communication module 431 and other wireless communication modules (such as, for example, a cellular communication module). The first terminal 4 may perform data communication with the second terminal 5 via the short-range wireless communication module 431 and may perform data communication with a server (the management server 1, the first server 2, the second server 3) via the other wireless communication modules.

Note that concerning a specific hardware configuration of the first terminal 4, components can be omitted, replaced, and added as appropriate in accordance with an embodiment. For example, the controller 41 may include a plurality of hardware processors. The hardware processor may include a microprocessor, an FPGA, a DSP, a GPU, an ASIC, an electronic control unit (ECU), and the like. At least one of the input device 44, the output device 45, the drive 46, and the positioning module 47 may be omitted. The first identifier I10 does not have to be stored in the storage 42. The first identifier I10 may be acquired each time. To acquire data such as an identifier and information to be used for authentication, the first terminal 4 may further include a data acquisition device such as a sensor and a reading device.

The first terminal 4 may include a plurality of computers. In this case, hardware configurations of the respective computers may be the same or do not have to be the same. The first terminal 4 may be a general-purpose computer, a terminal device (such as, for example, a smartphone and a tablet PC), or the like, in addition to an information processing device designed only for a service to be provided.

### (Second Terminal)

FIG. 10E schematically illustrates one example of a hardware configuration of the second terminal 5 according to the present embodiment. The second terminal 5 according to the present embodiment is a computer in which a controller 51, a storage 52, a communication interface 53, an input device 54, an output device 55, a drive 56, and the positioning module 57 are electrically connected. The controller 51 to the drive 56 of the second terminal 5 and a storage medium 95 may be constituted respectively in a similar manner to the controller 11 to the drive 16 of the above-described management server 1 and the storage medium 91.

The controller 51 (CPU) is one example of a processor resource of the second terminal 5, and the storage 52 (and the RAM, the ROM) is one example of the memory resource of the second terminal 5. In the present embodiment, the storage 52 stores a program 85 and various kinds of information such as the second identifier I20. The program 85 is a program for causing the second terminal 5 to execute information processing (FIG. 12A and FIG. 12B which will be described later) regarding linking. The program 85 includes a series of commands of the information processing. At least one of the program 85 and the second identifier I20 may be stored in the storage medium 95 in place of the storage 52 or in addition to the storage 52. The second terminal 5 may acquire at least one of the program 85 and the second identifier I20 from the storage medium 95. The second terminal 5 may be operated via the input device 54 and the output device 55.

The second terminal 5 may perform data communication with other computers (such as the management server 1, the first server 2, the second server 3 and the first terminal 4) via the communication interface 53. In one example, in a similar manner to the first terminal 4, the communication interface 53 may include a plurality of types of modules. For example, the communication interface 53 may include a short-range wireless communication module 531 and other wireless communication modules. The second terminal 5 may perform data communication with the first terminal 4 via the short-range wireless communication module 531 and perform data communication with a server via the other wireless communication modules.

Note that concerning a specific hardware configuration of the second terminal 5, components can be omitted, replaced, and added as appropriate in accordance with an embodiment. For example, the controller 51 may include a plurality of hardware processors. The hardware processor may include a microprocessor, an FPGA, a DSP, a GPU, an ASIC, an ECU, and the like. At least one of the input device 54, the output device 55, the drive 56, and the positioning module 57 may be omitted. The second identifier I20 does not have to be stored in the storage 52. The second identifier I20 may be acquired each time. To acquire data such as an identifier and information to be used for authentication, the second terminal 5 may further include a data acquisition device such as a sensor and a reading device. The second terminal 5 may include a plurality of computers. In this case, hardware configurations of the respective computers may be the same or do not have to be the same. The second terminal 5 may be a general-purpose computer, a terminal device, or the like, in addition to an information processing device designed only for a service to be provided.

### Software Configuration Example

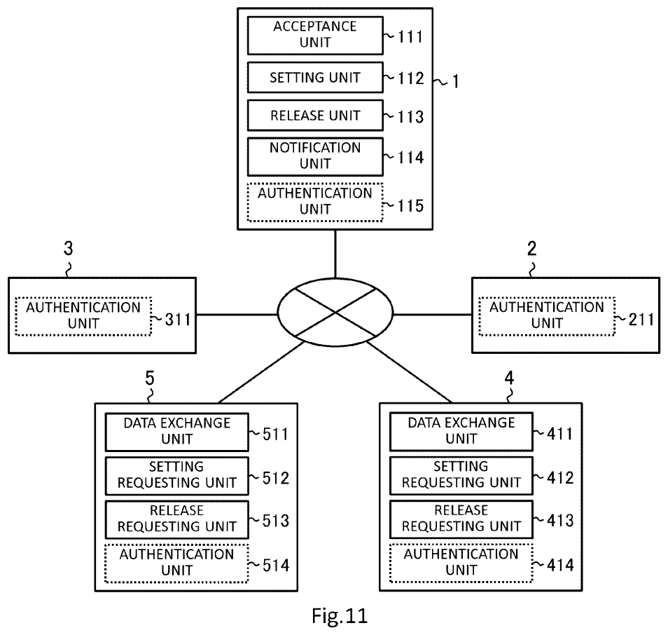

FIG. 11 schematically illustrates one example of software configurations of respective devices (the management server 1, the first server 2, the second server 3, the first terminal 4, and the second terminal 5) according to the present embodiment.

### (Management Server)

The controller 11 of the management server 1 loads the management program 81 stored in the storage 12 to the RAM and executes a command included in the management program 81 by the CPU. By this means, the management server 1 operates as a computer including an acceptance unit 111, a setting unit 112, a release unit 113, and a notification unit 114 as software modules.

The acceptance unit 111 is configured to directly or indirectly receive a linking demand from at least one of the first terminal 4 of the corresponding individual of the first target VA and the second terminal 5 of the corresponding individual of the second target WA in accordance with occurrence of the use relation between the corresponding individual of the first target VA and the corresponding individual of the second target WA. The acceptance unit 111 is configured to accept setting of the correspondence relation between the corresponding individual of the first target VA and the corresponding individual of the second target WA by receipt of the linking demand.

The setting unit 112 is configured to execute processing of setting the correspondence relation between the corresponding individual of the first target VA and the corresponding individual of the second target WA based on the linking demand. The setting unit 112 is configured to acquire authentication results of both the first target VA and the second target WA in a case where the predetermined condition is not satisfied and set the correspondence relation between the first target VA and the second target WA in accordance with success in authentication of both the first target VA and the second target WA in the acquired authentication results of the first target VA and the second target WA. Further, in a case where the predetermined condition is satisfied, the setting unit 112 is configured to omit authentication of at least one target out of the first target VA and the second target WA, acquire an authentication result of the other target and set the correspondence relation between the first target VA and the second target WA in accordance with success in authentication of the other target in the acquired authentication result. The release unit 113 is configured to execute processing of releasing the correspondence relation in accordance with receipt of a release demand from at least one of the first terminal 4 and the second terminal 5 or satisfaction of a predetermined release condition.

The notification unit 114 is configured to transmit a notification indicating a result of executing the processing of setting the correspondence relation to at least one of the first terminal 4 and the second terminal 5. The notification unit 114 is configured to transmit a notification indicating a result of executing the processing of releasing the correspondence relation to at least one of the first terminal 4 and the second terminal 5.

In a case where a form in which the management server 1 executes authentication processing of at least one of the first target VA and the second target WA is employed, the management server 1 may further include an authentication unit 115 as a software module. The authentication unit 115 may be configured to execute authentication processing of at least one of the first target VA and the second target WA.

### (First Server)

In a case where a form in which the first server 2 executes authentication processing of the first target VA is employed, the controller 21 of the first server 2 may execute a command included in the program 82 by the CPU. By this means, the first server 2 may operate as a computer including an authentication unit 211 as a software module. The authentication unit 211 is configured to execute authentication processing of the first target VA in response to an authentication request for the first target VA.

### (Second Server)

In a case where a form in which the second server 3 executes authentication processing of the second target WA is employed, the controller 31 of the second server 3 may execute a command included in the program 83 by the CPU. By this means, the second server 3 may operate as a computer including an authentication unit 311 as a software module. The authentication unit 311 is configured to execute authentication processing of the second target WA in response to an authentication request for the second target WA.

### (First Terminal)

The controller 41 of the first terminal 4 executes a command included in the program 84 by the CPU. By this means, the first terminal 4 operates as a computer including a data exchange unit 411, a setting requesting unit 412, and a release requesting unit 413 as software modules. The data exchange unit 411 is configured to execute data exchange with the second terminal 5. The setting requesting unit 412 is configured to transmit a linking demand (request for linking setting) to the management server 1. The release requesting unit 413 is configured to transmit a release demand (request for linking release) to the management server 1.

In a case where a form in which the first terminal 4 executes authentication processing of at least one of the first target VA and the second target WA is employed, the first terminal 4 may be configured to further include an authentication unit 414 as a software module. The authentication unit 414 may be configured to execute authentication processing of at least one of the first target VA and the second target WA.

### (Second Terminal)

The controller 51 of the second terminal 5 executes a command included in the program 85 by the CPU. By this means, the second terminal 5 operates as a computer including a data exchange unit 511, a setting requesting unit 512, and a release requesting unit 513 as software modules. The data exchange unit 511 is configured to execute data exchange with the first terminal 4. The setting requesting unit 512 is configured to transmit a linking demand (request for linking setting) to the management server 1. The release requesting unit 513 is configured to transmit a release demand (request for linking release) to the management server 1.

In a case where a form in which the second terminal 5 executes authentication processing of at least one of the first target VA and the second target WA is employed, the second terminal 5 may be configured to further include an authentication unit 514 as a software module. The authentication unit 514 may be configured to execute authentication processing of at least one of the first target VA and the second target WA.

### (Others)

In the present embodiment, an example where all of the respective software modules of the respective devices are implemented by general-purpose CPUs is described. However, some or all of the above-described software modules may be implemented by one or more dedicated processors. The above-described modules may be implemented as hardware modules. Concerning software configurations of the respective devices, modules may be omitted, replaced, and added as appropriate in accordance with an embodiment. For example, in a case where a form in which a linking demand is transmitted from only one of the first terminal 4 and the second terminal 5 is employed, the setting requesting unit may be omitted from the other terminal. In a similar manner, in a case where a form in which a release demand is transmitted from only one of the first terminal 4 and the second terminal 5 is employed, the release requesting unit may be omitted from the other terminal. The authentication unit may be omitted from a device in which execution of the authentication processing is omitted.

### 3 OPERATION EXAMPLE

### (Linking Setting)

FIG. 12A indicates one example of processing procedure of linking setting by the system 100 according to the present embodiment. The following processing procedure is one example of an information processing method to be executed by a computer. Processing procedure of the management server 1 among the following processing procedures is one example of a management method to be executed by the computer.

In step S10, at least one of the controller 41 of the corresponding first terminal 4 and the controller 51 of the corresponding second terminal 5 transmits a linking demand to the management server 1 in accordance with occurrence of the use relation between the corresponding individual of the first target VA and the corresponding individual of the second target WA.

In one example, the controller 41 of the corresponding first terminal 4 may operate as the data exchange unit 411 and execute data exchange with the corresponding second terminal 5 in accordance with occurrence of the use relation. The controller 51 of the second terminal 5 may operate as the data exchange unit 511 and execute data exchange with the first terminal 4. The data exchange may be performed through short-range wireless communication. The controller 41 of the first terminal 4 may operate as the setting requesting unit 412 by being triggered by the data exchange and transmit a linking demand to the management server 1. The controller 51 of the second terminal 5 may operate as the setting requesting unit 512 and transmit a linking demand to the management server 1. The first terminal 4 and the second terminal 5 may transmit the linking demand in cooperation with each other or one of the first terminal 4 and the second terminal 5 may transmit the linking demand. One of the first terminal 4 and the second terminal 5 may provide an instruction to the other terminal, and the other terminal may transmit the linking demand. Further, the linking demand may be directly transmitted to the management server 1 or may be indirectly transmitted via an external computer (such as the first server 2 and the second server 3.)

In step S20, the controller 11 of the management server 1 operates as the acceptance unit 111 and directly or indirectly receives the linking demand from at least one of the first terminal 4 of the corresponding individual of the first target VA and the second terminal 5 of the corresponding individual of the second target WA. The controller 11 accepts setting of the correspondence relation between the corresponding individual of the first target VA and the corresponding individual of the second target WA by receipt of this linking demand.

Note that in step S10, in a case where a form in which the first terminal 4 and the second terminal 5 transmit the linking demand in cooperation with each other is employed, one linking demand may be transmitted from the first terminal 4 and the second terminal 5 in a divided manner or the same linking demand may be transmitted. In a case where the linking demand is transmitted in a divided manner, data of part of the linking demand may be transmitted from the first terminal 4, and the remaining part of the data may be transmitted from the second terminal 5. The data of the part and the remaining part of the data may be allowed to partially overlap with each other. In step S20, to specify a combination of the corresponding individual of the first target VA and the corresponding individual of the second target WA for which setting of the correspondence relation is actually requested, the management server 1 may specify association of this data as appropriate (that is, determine a combination of the corresponding data).

Association of the data may be specified using an arbitrary method. In one example, data to be transmitted from each terminal (4, 5) may include shared information for specifying association of the data. The shared information may include, for example, information having a relation such as matching and success in the correspondence relation. The management server 1 may specify association of the data in accordance with establishment of the relation between shared information included in the data received from one of the first terminal 4 and the second terminal 5 and shared information included in the data received from the other.

The shared information may be arbitrarily constituted. In one example, the shared information may be constituted with a combination of the first identifier I10 and the second identifier I20. The management server 1 may specify association of the data in accordance with matching between a combination of identifiers (I10, I20) included in the data received from the first terminal 4 and a combination of identifiers (I10, I20) included in the data received from the second terminal 5. In another example, the shared information may be constituted with temporal information such as a random number, a timestamp, and a hash value. In this case, the management server 1 may specify association of the data in accordance with establishment of the relation between temporal information included in the data received from the first terminal 4 and temporal information included in the data received from the second terminal 5. Note that the shared information may be shared between the first terminal 4 and the second terminal 5 at an arbitrary timing. In typical one example, the first terminal 4 and the second terminal 5 may share the shared information upon data exchange.

In step S25, a branch destination of the processing is determined in accordance with whether or not the predetermined condition is satisfied. In a case where the predetermined condition is not satisfied, the processing proceeds to step S301. On the other hand, in a case where the predetermined condition is satisfied, the processing proceeds to step S311. In one example, whether or not the predetermined condition is satisfied may be determined by at least one of the management server 1, an external server (such as the first server 2 and the second server 3), the first terminal 4, and the second terminal 5. The branch destination of the processing may be determined in accordance with the determination result. In another example, the branch destination of the processing may be determined in accordance with an operation mode of at least one of the first terminal 4 and the second terminal 5. Further, in on example, the predetermined condition may include at least one of the above-described two conditions.

In step S301, the controller 11 of the management server 1 operates as the setting unit 112 and acquires authentication results of both the first target VA and the second target WA. In step S302, the controller 11 operates as the setting unit 112 and determines whether or not authentication of both the first target VA and the second target WA is successful in the acquired authentication results. In a case where authentication of at least one of the first target VA and the second target WA is not successful, the controller 11 discards the linking demand, and the processing proceeds to step S40. By this means, the controller 11 omits setting of the correspondence relation. On the other hand, in a case where authentication of both the first target VA and the second target WA is successful, the processing of the controller 11 proceeds to step S320.

In step S311, the controller 11 of the management server 1 operates as the setting unit 112, omits authentication of one target out of the first target VA and the second target WA and acquires an authentication result of the other target. In one example, the first target VA may be the user, and the second target WA may be the object to be used. The controller 11 may omit authentication of the object to be used and acquire an authentication result of the user.

In step S312, the controller 11 operates as the setting unit 112 and determines whether or not authentication of the other target is successful in the acquired authentication result. In a case where authentication of the other target is not successful, the controller 11 discards the linking demand, and the processing proceeds to step S40. By this means, the controller 11 omits setting of the correspondence relation. On the other hand, in a case where authentication of the other target is successful, the processing of the controller 11 proceeds to step S320. Success in authentication of the other target may include continuation of a login state of the other target.

Note that authentication processing of each of the first target VA and the second target WA may be executed at least one of the management server 1, the external server (for example, the first server 2, the second server 3), the first terminal 4, and the second terminal 5. The controller 11 of the management server 1 may operate as the authentication unit 115 and execute authentication processing of at least one of the first target VA and the second target WA. The controller 21 of the first server 2 may operate as the authentication unit 211 and execute authentication processing of the first target VA. The controller 31 of the second server 3 may operate as the authentication unit 311 and execute authentication processing of the second target WA. The controller 41 of the first terminal 4 may operate as the authentication unit 414 and execute authentication processing of at least one of the first target VA and the second target WA. The controller 41 of the second terminal 5 may operate as the authentication unit 514 and execute authentication processing of at least one of the first target VA and the second target WA. The authentication processing may be executed at an arbitrary timing before the processing in step S301 and step S311 is executed.

In step S320, the controller 11 operates as the setting unit 112 and updates the linking information D10 so as to establish setting of the correspondence relation between the first target VA and the second target WA designated by the linking demand. In one example, updating the linking information D10 in association with the setting of the correspondence relation may include generating new linking information D10 indicating the designated correspondence relation. If the linking information D10 is updated, the processing of the controller 11 proceeds to the next step S40. Note that the above-described processing in step S301, step S302, step S311, step S312, and step S320 is one example of the processing (above-described step S30) of setting the correspondence relation in response to the accepted linking demand.

In step S40, the controller 11 operates as the notification unit 114 and directly or indirectly transmits a notification indicating a result of executing the processing of setting the correspondence relation to at least one of the first terminal 4 and the second terminal 5. If the notification of the result is completed, the processing procedure regarding the linking setting according to the present operation example ends.

Note that the processing procedure described above is merely one example, and each step may be changed as far as possible. Further, concerning the processing procedure described above, steps can be omitted, replaced, and added as appropriate in accordance with an embodiment. For example, branch of step S25 may be provided before step S20 or step S10.

### (Linking Release)

FIG. 12B indicates one example of processing procedure of linking release by the system 100 according to the present embodiment. The following processing procedure is one example of an information processing method to be executed by a computer. Processing procedure of the management server 1 among the following processing procedures is one example of a management method to be executed by the computer. Note that the example of FIG. 12B assumes a scene in which a form in which the release demand is directly transmitted from the first terminal 4 to the management server 1 is employed.

In step SZ10, the controller 41 of the first terminal 4 operates as the release requesting unit 413 and transmits the release demand of the correspondence relation to the management server 1. In response to this, the controller 11 of the management server 1 receives the release demand. The correspondence relation for which release is to be requested may be designated as appropriate. A trigger of the release demand may be selected as appropriate in accordance with the embodiment.

In step SZ20, the controller 11 operates as the release unit 113 and updates the linking information D10 so as to release setting of the correspondence relation designated by the received release demand. In one example, updating the linking information D10 in association with release of the correspondence relation may include recording information indicating that the correspondence relation has been released. For example, in a case where the linking information D10 has the configuration in FIG. 3A, the controller 11 may release the target correspondence relation by adding a release time point to the corresponding linking information D10 or setting up a flag of release. In a case where the linking information D10 is constituted with a block chain base, the controller 11 may release the target correspondence relation by generating a transaction indicating linking release and adding the generated transaction to a block chain.

In step SZ30, the controller 11 operates as the notification unit 114 and transmits an execution result of the processing of linking release to the first terminal 4. If the notification of the result is completed, processing procedure regarding the linking release according to the present operation example ends.

Note that the processing procedure described above is merely one example, and each step may be changed as far as possible. Further, concerning the processing procedure described above, steps can be omitted, replaced, and added as appropriate in accordance with an embodiment. For example, as described above, a transmission route of the release demand does not have to be limited to the example of FIG. 12B and may be selected as appropriate in accordance with an embodiment. The release demand may be transmitted from the second terminal 5 (release requesting unit 513). The processing of the release demand may include authentication processing of at least one of the first target VA and the second target WA. Further, the controller 11 of the management server 1 may operate as the release unit 113 instead of step SZ20 described above and release the correspondence relation in association with satisfaction of the predetermined release condition. Still further, the controller 11 may operate as the release unit 113 and execute the confirmation processing of use continuation described above for the set correspondence relation at an arbitrary timing after the correspondence relation is set.

### [Characteristics]

In the present embodiment, information indicating setting of the correspondence relation between the corresponding individual of the first target VA and the corresponding individual of the second target WA is recorded by the processing in step S320. This recording enables tracking of the use relation between the corresponding individual of the first target VA and the corresponding individual of the second target WA. In addition, in the present embodiment, in a case where the predetermined condition is not satisfied, authentication of both the first target VA and the second target WA is executed (the route of step S301 is selected) upon setting of the correspondence relation. This can maintain security. On the other hand, in a case where the predetermined condition is satisfied, authentication of one of the first target VA and the second target WA is omitted (a route of step S311 is selected). This can achieve reduction in trouble. Thus, according to the present embodiment, it is possible to track the use relation between the first target VA and the second target WA while maintaining security and achieve reduction in trouble of the tracking.

### 4 MODIFICATIONS

While the embodiment of the present disclosure has been described in detail above, the above description is merely an example of the present disclosure in all aspects. It goes without saying that various improvements or modifications can be made without deviating from the scope of the present disclosure. For example, changes as described below can be made. Note that in the following description, similar reference numerals will be used for components similar to those in the above-described embodiment, and description concerning points similar to those in the above-described embodiment will be omitted as appropriate. The following modifications can be combined as appropriate.

<4.1>

In the above-described embodiment, while authentication processing of both the first target VA and the second target WA is executed in the normal processing mode, one of them is omitted in the simplified processing mode. However, in terms of balance between maintenance of security and reduction of trouble, omission of authentication processing can be applied also to a case other than such division. An omission form of the authentication processing does not have to be limited to the example of the above-described embodiment. In another example, authentication of at least one of the first target VA and the second target WA may be performed in the normal processing mode, and authentication of both the first target VA and the second target WA may be omitted in the simplified processing mode.

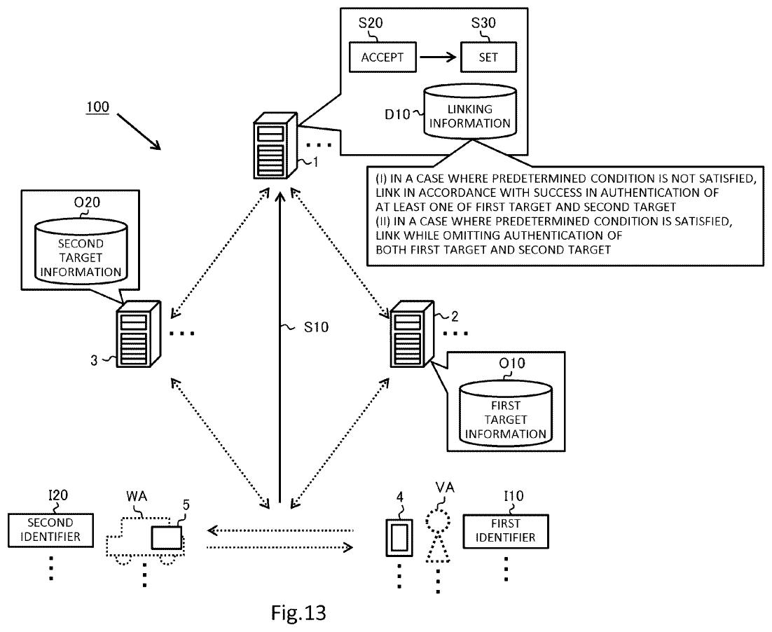

FIG. 13 schematically illustrates another example of a scene to which the present disclosure is applied. The controller 11 of the management server 1 may be configured to set the correspondence relation between the first target VA and the second target WA based on the linking demand transmitted from at least one of the first terminal 4 of the first target VA and the second terminal 5 of the second target WA upon occurrence of the use relation between the first target VA and the second target WA. In this setting processing, in a case where the predetermined condition is not satisfied, the controller 11 may acquire an authentication result of at least one of the first target VA and the second target WA and set the correspondence relation between the first target VA and the second target WA in accordance with success in authentication in the acquired authentication result. On the other hand, in a case where the predetermined condition is satisfied, the controller 11 may omit authentication of both the first target VA and the second target WA and set the correspondence relation between the first target VA and the second target WA in accordance with receipt of the linking demand.

Further, in on example, in a case where a form in which the management server 1 or the external server executes authentication processing is employed, the controller 41 of the first terminal 4 of the first target VA may be configured to cause the management server 1 to execute setting the correspondence relation between the first target VA and the second target WA by transmitting the linking demand to the management server 1, transmitting the linking demand in cooperation with the second terminal 5 of the second target WA, or causing the second terminal 5 to transmit the linking demand upon occurrence of the use relation between the first target VA and the second target WA. In a case where the predetermined condition is not satisfied, the linking demand may include an authentication request for at least one of the first target VA and the second target WA. Setting the correspondence relation between the first target VA and the second target WA may include setting the correspondence relation between the first target VA and the second target WA in accordance with success in authentication of at least one of the first target VA and the second target WA executed based on the authentication request. In a case where the predetermined condition is satisfied, the authentication request for both the first target VA and the second target WA may be omitted from the linking demand. Setting the correspondence relation between the first target VA and the second target WA may include setting the correspondence relation between the first target VA and the second target WA in accordance with receipt of the linking demand.

In a similar manner, the controller 51 of the second terminal 5 of the second target WA may be configured to cause the management server 1 to execute setting of the correspondence relation between the first target VA and the second target WA by transmitting the linking demand to the management server 1, transmitting the linking demand in cooperation with the first terminal 4 of the first target VA, or causing the first terminal 4 to transmit the linking demand upon occurrence of the use relation between the first target VA and the second target WA. In a case where the predetermined condition is not satisfied, the linking demand may include an authentication request for at least one of the first target VA and the second target WA. Setting the correspondence relation between the first target VA and the second target WA may include setting the correspondence relation between the first target VA and the second target WA in accordance with success in authentication of at least one of the first target VA and the second target WA executed based on the authentication request. In a case where the predetermined condition is satisfied, the authentication request for both the first target VA and the second target WA may be omitted from the linking demand. Setting the correspondence relation between the first target VA and the second target WA may include setting the correspondence relation between the first target VA and the second target WA in accordance with receipt of the linking demand.

<4.2>

In the above-described embodiment, the authentication processing may be executed in at least one of the management server 1, the external server (such as the first server 2 and the second server 3), and each terminal (4, 5). Data communication upon execution of the authentication processing may be designed as appropriate in accordance with an embodiment. As one example, at least one of the following four authentication methods may be employed.

### (A) First Authentication Method

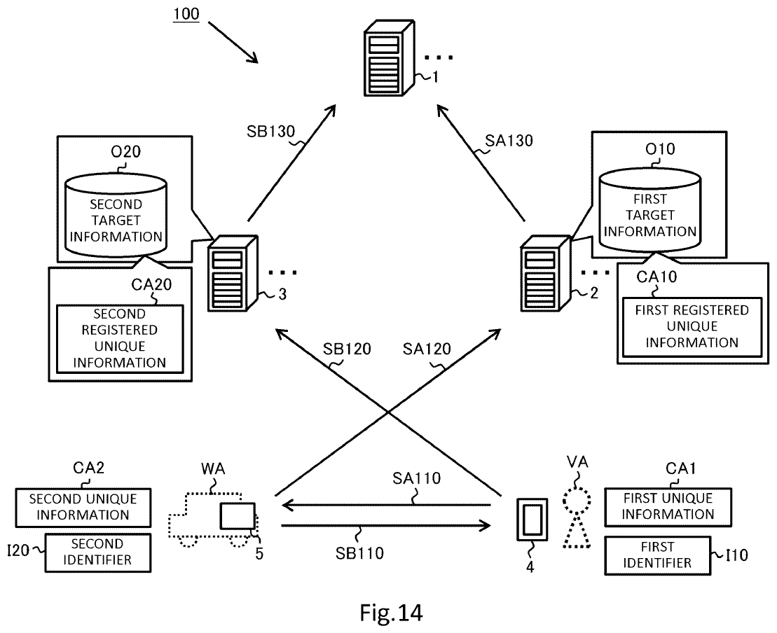

FIG. 14 schematically indicates one example of a processing process of linking setting in a case where a first authentication method is employed. In the first authentication method, the second server 3 executes authentication processing of the second target WA in response to a demand (authentication request) from the first terminal 4 of the first target VA. The first server 2 executes authentication processing of the first target VA in response to a demand (authentication request) from the second terminal 5 of the second target WA. Each terminal (4, 5) requests each authentication of the other to each server (2, 3) as the linking demand and causes the management server 1 to report authentication results. By this means, each terminal (4, 5) transmits the linking demand to the management server 1. The request to be transmitted from each terminal (4, 5) to each server (2, 3) is one example of the linking demand including the authentication request. Further, processing from when each terminal (4, 5) transmits a demand to each server (2, 3) until when each terminal (4, 5) causes the management server 1 to transmit the authentication result is one example of processing of the first terminal 4 and the second terminal 5 transmitting the linking demand in cooperation with each other.

The first server 2 is configured to be accessible by a first main memory that stores first registered unique information CA10 for authentication of the first target VA. The first main memory may include at least one of the memory resource of the first server 2 and an external main memory (such as a NAS). The first registered unique information CA10 may be included in the first target information O10. The second server 3 may be configured to be accessible by a second main memory that stores second registered unique information CA20 for authentication of the second target WA. The second main memory may include at least one of the memory resource of the second server 3 and an external main memory (such as a NAS). The second registered unique information CA20 may be included in the second target information O20.

Each piece of the registered unique information (CA10, CA20) is unique information registered in advance for authentication of each target (VA, WA). A data format and a configuration of the unique information do not have to be particularly limited if the unique information can be used for authentication and may be selected as appropriate in accordance with an embodiment. The unique information may include arbitrary information such as, for example, information derived from the target, information derived from the terminal, temporarily generated information, and information generated using other arbitrary methods.

The information derived from the target may be, for example, biological information, uniquely provided identification information, or the like. The biological information may be, for example, a face image, a fingerprint, a vocal print, or the like. The uniquely provided identification information may be, for example, a vehicle registration number, a vehicle identification number, a personal identification number, or the like. In a case where an IC tag is provided to the target, the uniquely provided identification information may include information held by the IC tag. The information derived from the terminal may be, for example, a MAC address, terminal identification information, or the like. The temporarily generated information may be, for example, a one-time password, a private address (dynamically generated address), or the like. The temporarily generated information may include a timestamp, a random number, a hash value, and the like. The information generated using other arbitrary methods may include, for example, a password, a passcode, as well as information other than symbol strings, and the like.

First, data exchange is executed between the corresponding first terminal 4 and the corresponding second terminal 5 upon occurrence of the use relation between the corresponding individual of the first target VA and the corresponding individual of the second target WA (step SA110, step SB110). Authentication processing in the normal processing mode will be described below.

In step SA110, the controller 51 of the second terminal 5 acquires the first identifier I10 and the first unique information CA1 from the corresponding individual of the first target VA. The first unique information CA1 corresponds to the first registered unique information CA10. The controller 51 may acquire the first identifier I10 and the first unique information CA1 from the first target VA as appropriate in the data exchange. Acquisition from the first target VA may include acquisition from the first terminal 4. For example, the controller 51 may acquire at least one of the first identifier I10 and the first unique information CA1 from the first target VA via an input device, a sensor, or the like. The controller 51 may acquire at least one of the first identifier I10 and the first unique information CA1 from the first terminal 4 in the data exchange.

Further, in step SB110, the controller 41 of the first terminal 4 acquires the second identifier I20 and the second unique information CA2 from the corresponding individual of the second target WA. The second unique information CA2 corresponds to the second registered unique information CA20. The controller 41 may acquire the second identifier I20 and the second unique information CA2 from the second target WA in the data exchange. Acquisition from the second target WA may include acquisition from the second terminal 5. For example, the controller 41 may acquire at least one of the second identifier I20 and the second unique information CA2 from the second target WA via an input device, a sensor, or the like. The controller 41 may acquire at least one of the second identifier I20 and the second unique information CA2 from the second terminal 5 in the data exchange. Each identifier (I10, I20) and each piece of unique information (CA1, CA2) are one example of data to be used for authentication.

In step SA120, the controller 51 of the second terminal 5 transmits a first authentication request including the first identifier I10 and the first unique information CA1 to the first server 2. In accordance with this, the controller 21 of the first server 2 receives the first authentication request for the corresponding individual of the first target VA. The controller 21 of the first server 2 operates as the authentication unit 211 and executes authentication processing of the first target VA as appropriate in accordance with receipt of the first authentication request. In one example, the controller 21 may extract the first registered unique information CA10 of the corresponding individual of the first target VA from the first target information O10 by searching the first target information O10 using the first identifier I10 included in the first authentication request as a query. The controller 21 may collate the extracted first registered unique information CA10 and the first unique information CA1 included in the first authentication request. The collation may be performed as appropriate in accordance with the unique information to be used. The controller 21 may determine whether or not authentication of the corresponding individual of the first target VA is successful in accordance with a result of the collation. In step SA130, the controller 21 reports an authentication result of the corresponding individual of the first target VA to the management server 1.

In one example, the controller 21 may transmit to the management server 1, the authentication result of the first target VA to which the first identifier I10 of the first target VA is added. The controller 21 may transmit the authentication result to the management server 1 regardless of whether or not the authentication is successful or may transmit the authentication result to the management server 1 only in a case where the authentication is successful.

On the other hand, in step SB120, the controller 41 of the first terminal 4 transmits a second authentication request including the second identifier I20 and the second unique information CA2 to the second server 3. In accordance with this, the controller 31 of the second server 3 receives the second authentication request for the corresponding individual of the second target WA. The controller 31 of the second server 3 operates as the authentication unit 311 and executes authentication processing of the second target WA as appropriate in accordance with receipt of the second authentication request. In one example, the controller 31 may extract the second registered unique information CA20 of the corresponding individual of the second target WA from the second target information O20 by searching the second target information O20 using the second identifier I20 included in the second authentication request as a query. The controller 31 may collate the extracted second registered unique information CA20 and the second unique information CA2 included in the second authentication request. The collation may be performed as appropriate in accordance with the unique information to be used. The controller 31 may determine whether or not authentication of the corresponding individual of the second target WA is successful in accordance with a result of the collation. In step SB130, the controller 31 reports an authentication result of the corresponding individual of the second target WA to the management serve 1. In one example, the controller 31 may transmit to the management server 1, the authentication result of the second target WA to which the second identifier I20 of the second target WA is added. The controller 31 may transmit the authentication result to the management server 1 regardless of whether or not the authentication is successful or may transmit the authentication result to the management server 1 only in a case where the authentication is successful.

The second terminal 5 providing the first authentication request to the first server 2 and causing the first server 2 to transmit the authentication result to the management server 1 is one example of the second terminal 5 transmitting the linking demand to the management server 1. Further, the first terminal 4 providing the second authentication request to the second server 3 and causing the second server 3 to transmit the authentication result to the management server 1 is one example of the first terminal 4 transmitting the linking demand to the management server 1. In other words, in a case where the first authentication method is employed upon linking setting, the processing in step SA120, step SA130, step SB120, and step SB130 is one example of the processing in step S10 described above. This form of the authentication request is one example of a form in which the authentication processing is executed along with the linking demand.

The controller 11 of the management server 1 receives the authentication result for the corresponding individual of each target (VA, WA) from each server (2, 3). The controller 11 may specify association of the data of the authentication results using a method such as a method using the shared information described above to specify a combination of the corresponding individual of the first target VA and the corresponding individual of the second target WA for which setting of the correspondence relation is actually requested. The controller 11 sets the correspondence relation between the corresponding individual of the first target VA and the corresponding individual of the second target WA in a case where authentication of both the first target VA and the second target WA is successful in the received authentication results of the first target VA and the second target WA. The processing of setting the correspondence relation may be similar to that in the above-described embodiment. Note that a series of processing from data exchange to linking setting between the terminals (4, 5) may be executed in real time in accordance with occurrence of the use relation.

In the first authentication method, the first server 2 and the second server 3 respectively perform authentication of the corresponding individuals of the first target VA and the second target WA in accordance with occurrence of the use relation between the corresponding individual of the first target VA and the corresponding individual of the second target WA in the normal processing mode. In this event, the second terminal 5 of the second target WA requests authentication of the first target VA. The first terminal 4 of the first target VA requests authentication of the second target WA. In other words, instead of proceeding authentication of own targets, crossover authentication of proceeding authentication of the other's target is performed. By this means, it can be expected that security is maintained.

Note that the processing procedure of FIG. 14 is merely one example, and each step may be changed as far as possible. Further, concerning the processing procedure described above, steps can be omitted, replaced, and added as appropriate in accordance with the embodiment. For example, processing order of the authentication of the first target VA (step SA110 to step SA130) and the authentication of the second target WA (step SB110 to step SB130) does not have to be particularly limited and may be determined as appropriate in accordance with an embodiment.

In a case where the simplified processing mode is selected, authentication processing of at least one of the first target VA and the second target WA may be omitted. The linking demand in the simplified processing mode may be configured so as to designate the corresponding individuals of the first target VA and the second target WA as appropriate. In one example, in a case where authentication of one target out of the first target VA and the second target WA is executed, data to be transmitted in an authentication route of the one target may include an identifier of the other target along with an identifier of the one target. For example, in a case where authentication of the first target VA is performed, data to be transmitted from the second terminal 5 to the management server 1 by way of the first server 2 may include the first identifier I10 and the second identifier I20.

Further, in a similar manner to <4.1> described above, authentication processing of at least one of the first target VA and the second target WA may be executed in the normal processing mode, and authentication of both the first target VA and the second target WA may be omitted in the simplified processing mode. In this case, at least one of the first terminal 4 and the second terminal 5 may transmit the linking demand to the management server 1 as appropriate while omitting the authentication request.

Further, transmission paths of the authentication results do not have to be limited to the example of FIG. 14. In another example, the first terminal 4 may receive the authentication result of the second target WA from the second server 3, and the second terminal 5 may receive the authentication result of the first target VA from the first server 2. In accordance with this, each terminal (4, 5) may transmit the linking demand including the received authentication result of each target (VA, WA) to the management server 1. Alternatively, one terminal out of the first terminal 4 and the second terminal 5 may exchange data of the authentication result with the other terminal, and the other terminal may transmit the linking demand including the authentication results of the first target VA and the second target WA to the management server 1. This form is one example of a form in which authentication processing is executed before the linking demand is issued.

### (B) Second Authentication Method

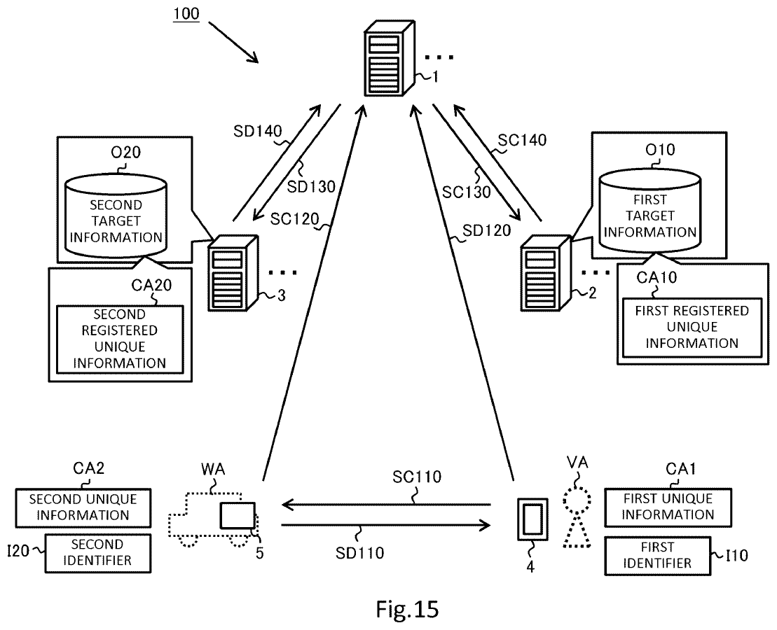

FIG. 15 schematically indicates one example of a processing process of linking setting in a case where a second authentication method is employed. In the second authentication method, the management server 1 requests authentication to each server (2, 3) in response to a request from at least one of the first terminal 4 and the second terminal 5. In other words, at least one of the first terminal 4 and the second terminal 5 transmits the linking demand including the authentication request for each target (VA, WA). Data (unique information) to be used for authentication is similar to that in the first authentication method. The demand to be transmitted from the first terminal 4 and the second terminal 5 to the management server 1 is one example of the linking demand including the authentication request. Further, this form of the authentication request is one example of a form in which the authentication processing is executed after the linking demand. The authentication processing in the normal processing mode will be described below.

First, data exchange is executed between the corresponding first terminal 4 and the corresponding second terminal 5 upon occurrence of the use relation between the corresponding individual of the first target VA and the corresponding individual of the second target WA (step SC110, step SD110). At least one of the first terminal 4 and the second terminal 5 transmits the authentication request including the first identifier I10, the first unique information CA1, the second identifier I20, and the second unique information CA2 to the management server 1 as the linking demand (step SC120, step SD120). In accordance with this, the controller 11 of the management server 1 receives the authentication request including the first identifier I10, the first unique information CA1, the second identifier I20, and the second unique information CA2. The processing in step SC120 and step SD120 is one example of the processing in step S10 described above.

Assignment of the data transmission may be determined as appropriate in accordance with an embodiment. In one example, the second terminal 5 may be in charge of transmission of the first identifier I10 and the first unique information CA1, and the first terminal 4 may be in charge of transmission of the second identifier I20 and the second unique information CA2. In other words, in step SC110, the controller 51 of the second terminal 5 may acquire the first identifier I10 and the first unique information CA1 from the first target VA. Acquisition from the first target VA may include acquisition from the first terminal 4. In step SC120, the controller 51 of the second terminal 5 may transmit the linking demand including the acquired first identifier I10 and first unique information CA1 to the management server 1. In step SD110, the controller 41 of the first terminal 4 may acquire the second identifier I20 and the second unique information CA2 from the second target WA. Acquisition from the second target WA may include acquisition from the second terminal 5. In step SD120, the controller 41 of the first terminal 4 may transmit the linking demand including the acquired second identifier I20 and second unique information CA2 to the management server 1.

Note that assignment of the data transmission does not have to be limited to such an example. In another example, at least one of the first identifier I10 and the first unique information CA1 may be transmitted from the first terminal 4. At least one of the second identifier I20 and the second unique information CA2 may be transmitted from the second terminal 5. In a case where a form in which transmission is performed in a divided manner is employed, the management server 1 may specify association of data of the authentication requests using a method such as a method using the shared information described above to specify a combination of the corresponding individual of the first target VA and the corresponding individual of the second target WA for which setting of the correspondence relation is actually requested. In still another example, the first identifier I10, the first unique information CA1, the second identifier I20, and the second unique information CA2 may be transmitted from only one of the first terminal 4 and the second terminal 5.

In step SC130, the controller 11 of the management server 1 requests authentication of the corresponding individual of the first target VA to the first server 2 by transmitting the first identifier I10 and the first unique information CA1 among the received pieces of data to the first server 2. In accordance with this, the controller 21 of the first server 2 may operate as the authentication unit 211, collate the first unique information CA1 and the first registered unique information CA10 and determine whether or not the authentication of the corresponding individual of the first target VA is successful in accordance with a result of the collation. In step SC140, the controller 21 of the first server 2 returns the authentication result of the corresponding individual of the first target VA to the management server 1.

In a similar manner, in step SD130, the controller 11 of the management server 1 requests authentication of the corresponding individual of the second target WA to the second server 3 by transmitting the second identifier I20 and the second unique information CA2 to the second server 3. In accordance with this, the controller 31 of the second server 3 may operate as the authentication unit 311, collate the second unique information CA2 and the second registered unique information CA20 and determine whether or not the authentication of the corresponding individual of the second target WA is successful in accordance with a result of the collation. In step SD140, the controller 31 of the second server 3 transmits the authentication result of the corresponding individual of the second target WA to the management server 1.

The controller 11 of the management server 1 receives the authentication result of the corresponding individual of each target (VA, WA) from each server (2, 3). The controller 11 of the management server 1 sets the correspondence relation between the corresponding individual of the first target VA and the corresponding individual of the second target WA in a case where the authentication of both the first target VA and the second target WA is successful in the received authentication results of the first target VA and the second target WA. The processing of setting the correspondence relation may be similar to that in the above-described embodiment. Note that a series of processing from data exchange to linking setting between the terminals (4, 5) may be executed in real time in accordance with occurrence of the use relation. Other configurations may be similar to those in the first authentication method.

In the second authentication method, the first server 2 and the second server 3 respectively perform authentication of the corresponding individuals of the first target VA and the second target WA in accordance with occurrence of the use relation between the corresponding individual of the first target VA and the corresponding individual of the second target WA in the normal processing mode. By the authentication of these two, it can be expected that security is maintained.

Note that the processing procedure of FIG. 15 is merely one example, and each step may be changed as far as possible. Further, concerning the processing procedure described above, steps can be omitted, replaced, and added as appropriate in accordance with an embodiment. For example, processing order of the authentication of the first target VA (step SC110 to step SC140) and the authentication of the second target WA (step SD110 to step SD140) does not have to be particularly limited and may be determined as appropriate in accordance with an embodiment.

In a case where the simplified processing mode is selected, authentication processing of at least one of the first target VA and the second target WA may be omitted. In a similar manner to the first authentication method described above, the linking demand in the simplified processing mode may be configured to designate the corresponding individuals of the first target VA and the second target WA as appropriate. Further, in a similar manner to <4.1> described above, authentication processing of at least one of the first target VA and the second target WA may be executed in the normal processing mode, and authentication of both the first target VA and the second target WA may be omitted in the simplified processing mode.

Further, transmission paths of the authentication results do not have to be limited to the example of FIG. 15. In another example, authentication processing of at least one of the first target VA and the second target WA may be executed by the management server 1 instead of the external server. For example, the management server 1 may hold at least one of the first registered unique information CA10 and the second registered unique information CA20. Alternatively, the management server 1 may acquire at least one of the first registered unique information CA10 and the second registered unique information CA20 by making an inquiry to at least one of the first server 2 and the second server 3. In accordance with this, the controller 11 of the management server 1 may operate as the authentication unit 115 and execute authentication processing of at least one of the first target VA and the second target WA.

### (C-1) 3-1-Th Authentication Method

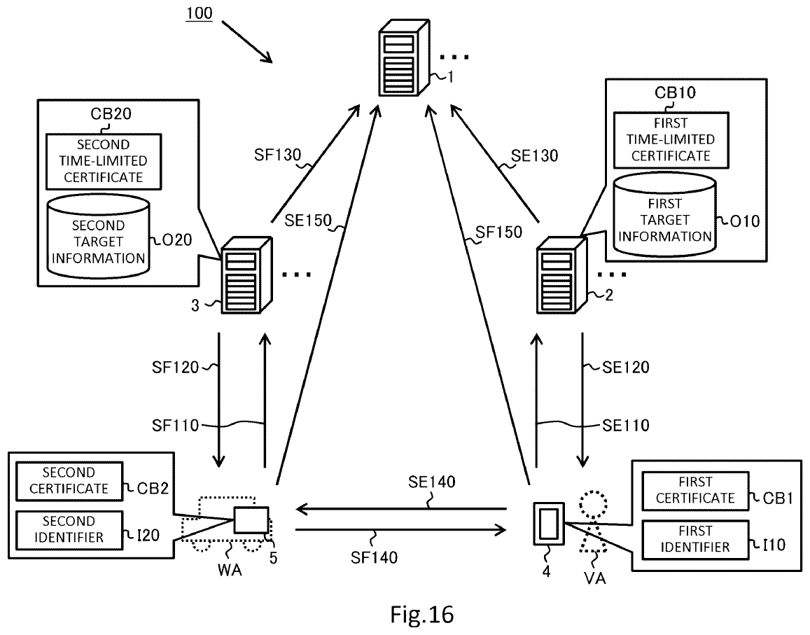

FIG. 16 schematically indicates one example of a processing process of linking setting in a case where a 3-1-th authentication method is employed. The 3-1-th authentication method uses a time-limited certificate in authentication in place of the unique information. The authentication processing is executed by the management server 1.

The first server 2 is configured to issue a first time-limited certificate CB10 to each individual of the first target VA. The second server 3 is configured to issue a second time-limited certificate CB20 to each individual of the second target WA.

Each time-limited certificate (CB10, CB20) is configured to expire if an expiration period has elapsed. If expiration by elapse of the expiration period can be controlled, a configuration of each time-limited certificate (CB10, CB20) does not have to be particularly limited and may be selected as appropriate in accordance with an embodiment. Each time-limited certificate (CB10, CB20) may include arbitrary information. In one example, each time-limited certificate (CB10, CB20) may include a random number, a timestamp, a hash value, and the like. Each time-limited certificate (CB10, CB20) may include temporary information such as a one-time password.

The expiration period of each time-limited certificate (CB10, CB20) may be managed as appropriate. Expiration by elapse of the expiration period may be specified as appropriate. For example, whether or not the target time-limited certificate has expired may be specified by a fact that a period set in the time-limited certificate has elapsed, a fact that the time-limited certificate is added to a revocation list, a fact that the time-limited certificate is deleted from a valid list, a fact that the time-limited certificate is updated to a new time-limited certificate, a fact that information indicating expiration (for example, a timestamp) is provided, or the like. In a case where reference information such as the revocation list and the valid list is used to manage the expiration period, the reference information may be stored in an arbitrary main memory that can be accessed from the system 100. Typically, the reference information of each time-limited certificate (CB10, CB20) may be stored in each server (2, 3). The authentication processing in the normal processing mode will be described below.

First, in step SE110, the controller 41 of the first terminal 4 of the first target VA transmits a request for issuing the first time-limited certificate CB10 to the first server 2 in relation to the first identifier I10 of the first target VA. In accordance with receipt of the request, the controller 21 of the first server 2 issues the first time-limited certificate CB10 in relation to the first identifier I10. In step SE120, the controller 21 of the first server 2 returns the issued first time-limited certificate CB10 to the first terminal 4. In accordance with this, the first terminal 4 receives the issued first time-limited certificate CB10 from the first server 2. The controller 41 of the first terminal 4 stores the received first time-limited certificate CB10 as a first certificate CB1 in a usable manner. Further, in step SE130, the controller 21 of the first server 2 also notifies the management server 1 of the issued first time-limited certificate CB10. The controller 21 may make a notification of the first time-limited certificate CB10 to which the first identifier I10 is added.

In step SF110, the controller 51 of the second terminal 5 of the second target WA transmits a request for issuing the second time-limited certificate CB20 to the second server 3 in relation to the second identifier I20 of the second target WA. In accordance with receipt of the request, the controller 31 of the second server 3 issues the second time-limited certificate CB20 in relation to the second identifier I20. In step SF120, the controller 31 of the second server 3 returns the issued second time-limited certificate CB20 to the second terminal 5. In accordance with this, the second terminal 5 receives the issued second time-limited certificate CB20 from the second server 3. The controller 51 of the second terminal 5 stores the received second time-limited certificate CB20 as the second certificate CB2 in a usable manner. Further, in step SF130, the controller 31 of the second server 3 also notifies the management server 1 of the issued second time-limited certificate CB20. The controller 31 may make a notification of the second time-limited certificate CB20 to which the second identifier I20 is added.

Data exchange is executed between the corresponding first terminal 4 and the corresponding second terminal 5 upon occurrence of the use relation between the corresponding individual of the first target VA and the corresponding individual of the second target WA (step SE140, step SF140). At least one of the first terminal 4 and the second terminal 5 transmits the authentication request including the first certificate CB1 and the second certificate CB2 to the management server 1 as the linking demand (step SE150, step SF150). In accordance with this, the management server 1 receives the first certificate CB1 corresponding to the first time-limited certificate CB10 and the second certificate CB2 corresponding to the second time-limited certificate CB20. The processing in step SE150 and step SF150 is one example of the processing in step S10 described above. A request to be transmitted from at least one of the first terminal 4 and the second terminal 5 is one example of the linking demand including the authentication request. This form of the authentication request is one example of a form in which the authentication processing is executed along with the linking demand or after the linking demand.

Assignment of the data transmission may be determined as appropriate in accordance with an embodiment. In one example, the second terminal 5 may be in charge of transmission of the first certificate CB1, and the first terminal 4 may be in charge of transmission of the second certificate CB2. In other words, in step SE140, the controller 51 of the second terminal 5 may acquire the first certificate CB1 from the first terminal 4. In step SE150, the controller 51 of the second terminal 5 may transmit the linking demand including the first certificate CB1 to the management server 1. In step SF140, the controller 41 of the first terminal 4 may acquire the second certificate CB2 from the second terminal 5. In step SF150, the controller 41 of the first terminal 4 may transmit the linking demand including the second certificate CB2 to the management server 1.

Note that assignment of the data transmission does not have to be limited to such an example. In another example, the first certificate CB1 may be transmitted from the first terminal 4. The second certificate CB2 may be transmitted from the second terminal 5. Further, each identifier (I10, I20) may be transmitted to the management server 1 along with each certificate (CB1, CB2). In this case, each identifier (I10, I20) and each certificate (CB1, CB2) are one example of data to be used for authentication. Each identifier (I10, I20) may be transmitted from at least one of the first terminal 4 and the second terminal 5. In a case where a form in which transmission is performed in a divided manner is employed, the management server 1 may specify association of the data of the authentication requests using a method such as a method using the shared information described above to specify a combination of the corresponding individuals of the first target VA and the second target WA for which setting of the correspondence relation is actually requested. In still another example, the first certificate CB1 and the second certificate CB2 may be transmitted from only one of the first terminal 4 and the second terminal 5.

The controller 11 of the management server 1 operates as the authentication unit 115 and collates the received first certificate CB1 and the first time-limited certificate CB10 notified from the first server 2. The controller 11 of the management server 1 operates as the authentication unit 115 and collates the received second certificate CB2 and the second time-limited certificate CB20 notified from the second server 3. The controller 11 may specify association of the data to be collated as appropriate. Specifying the correspondence of the data to be collated is determining a combination of the first time-limited certificate CB10 and the first certificate CB1 to be collated and a combination of the second time-limited certificate CB20 and the second certificate CB2 to be collated. In a similar manner to the association of the data of the authentication requests, the controller 11 may specify the association of the data to be collated using a method such as a method using the shared information described above. The shared information may be each identifier (I10, I20).

Further, a collation method of the certificate and the time-limited certificate may be selected as appropriate in accordance with a relation between both. In one example, the time-limited certificate (CB10, CB20) may be used as is as the certificate (CB1, CB2). In this case, whether or not collation is successful in the authentication may be determined in accordance with whether or not the time-limited certificate (CB10, CB20) matches the certificate (CB1, CB2). In another example, the time-limited certificate (CB10, CB20) may be arbitrarily converted, and the converted time-limited certificate (CB10, CB20) may be used as the certificate (CB1, CB2). In this case, whether or not collation is successful in the authentication may be determined in accordance with whether or not a predetermined relation is established between the time-limited certificate (CB10, CB20) and the certificate (CB1, CB2). For example, the first time-limited certificate CB10 may be converted into a hash value, and the obtained hash value may be used as the first certificate CB1. In accordance with this, whether or not the relation is established may be determined in accordance with whether or not the hash value of the first time-limited certificate CB10 matches the first certificate CB1. The conversion may include data operation such as deletion and addition. At least one of the first time-limited certificate CB10 and the second time-limited certificate CB20 may be used as is as the certificate, and the other may be used as the certificate after being converted. Note that the conversion processing may be executed at each terminal (4, 5) or may be executed at each server (2, 3). In a case where the conversion processing is executed at each server (2, 3), each terminal (4, 5) may receive the converted time-limited certificate (CB10, CB20) from each server (2, 3).

The controller 11 of the management server 1 may determine whether or not authentication of the corresponding individual of each target (VA, WA) is successful in accordance with each result of the collation. In a case where the collation is not successful, the authentication becomes unsuccessful. In a case where the first time-limited certificate CB10/the second time-limited certificate CB20 has expired as a result of the expiration period having elapsed, collation of the first target VA/the second target WA becomes unsuccessful. On the other hand, if the first time-limited certificate CB10 and the second time-limited certificate CB20 are valid, and the collation is successful, authentication of both the first target VA and the second target WA is successful. In a case where authentication of both the first target VA and the second target WA is successful, the controller 11 of the management server 1 sets the correspondence relation between the corresponding individual of the first target VA and the corresponding individual of the second target WA. The processing of setting the correspondence relation may be similar to that in the above-described embodiment. Note that a series of processing from data exchange to linking setting between the terminals (4, 5) may be executed in real time in accordance with occurrence of the use relation. Other configurations may be similar to those in the first authentication method and the like.

In the 3-1-th method, authentication of each of the first target VA and the second target WA is performed using the time-limited certificate (CB10, CB20) in accordance with occurrence of the use relation between the corresponding individual of the first target VA and the corresponding individual of the second target WA in the normal processing mode. Each time-limited certificate (CB10, CB20) is configured to expire if the expiration period has elapsed. This can prevent the same certificate from being permanently used, so that it can be expected that security is maintained.

Note that the processing procedure of FIG. 16 is merely one example, and each step may be changed as far as possible. Further, concerning the processing procedure described above, steps can be omitted, replaced, and added as appropriate in accordance with an embodiment. For example, processing order of the authentication of the first target VA (step SE110 to step SE150) and the authentication of the second target WA (step SF110 to step SF150) does not have to be particularly limited and may be determined as appropriate in accordance with an embodiment.

Further, issuance of each time-limited certificate (CB10, CB20) does not necessarily have to be performed in response to a request (demand) from each terminal (4, 5). Each server (2, 3) may spontaneously generate each time-limited certificate (CB10, CB20). In this case, the processing in step SE110 and step SF110 may be omitted.

Further, issuance (step SE110 to step SE130, step SF110 to step SF130) of each time-limited certificate (CB10, CB20) may be executed at an arbitrary timing before the request for linking setting (step SE150, step SF150). In one example, issuance of each time-limited certificate (CB10, CB20) may be executed in advance before data exchange is executed between the first terminal 4 and the second terminal 5 (step SE140, step SF140). In another example, issuance may be executed at a timing after data exchange is started between the first terminal 4 and the second terminal 5 and before the linking demand is transmitted. In terms of reduction in the number of processes upon linking setting, issuance of each time-limited certificate (CB10, CB20) is preferably executed at the former timing.

In a case where the simplified processing mode is selected, authentication processing of at least one of the first target VA and the second target WA may be omitted. In a similar manner to the first authentication method described above, the linking demand in the simplified processing mode may be configured to designate the corresponding individuals of the first target VA and the second target WA as appropriate. Further, in a similar manner to <4.1> described above, authentication processing of at least one of the first target VA and the second target WA may be executed in the normal processing mode, and authentication of both the first target VA and the second target WA may be omitted in the simplified processing mode.

Further, in the above-described 3-1-th authentication method, collation processing of each certificate (CB1, CB2) and each time-limited certificate (CB10, CB20), that is, authentication processing of each target (VA, WA) is executed by the management server 1. However, an entity that executes the collation processing does not have to be limited to the management server 1. In another example, the management server 1 may request the collation processing to each server (2, 3) by transmitting each certificate (CB1, CB2) to each server (2, 3). By this means, the collation processing may be executed at each server (2, 3). In other words, authentication processing of at least one of the first target VA and the second target WA may be executed by an external server. In one example, the controller 21 of the first server 2 may operate as the authentication unit 211 and determine whether or not the authentication of the first target VA is successful by collating the first certificate CB1 received from the management server 1 and the first time-limited certificate CB10. The controller 21 may return the authentication result of the first target VA to the management server 1. Further, the controller 31 of the second server 3 may operate as the authentication unit 311 and determine whether or not the authentication of the second target WA is successful by collating the second certificate CB2 received from the management server 1 and the second time-limited certificate CB20. The controller 31 may return the authentication result of the second target WA to the management server 1. In this case, the notification (step SE130, step SF130) of each time-limited certificate (CB10, CB20) may be omitted. In another example, the management server 1 may execute authentication processing of at least one of the first target VA and the second target WA, and the external server may execute authentication processing of the other target.

### (C-2) 3-2-Th Authentication Method

In the above-described 3-1-th authentication method, authentication processing of each target (VA, WA) is executed in response to the linking demand from at least one of the first terminal 4 and the second terminal 5. However, a timing of executing the authentication processing does not have to be limited to such an example. In the 3-2-th authentication method, before the linking demand is transmitted to the management server 1, authentication processing of at least one of the first target VA and the second target WA may be executed in advance with at least one of the first server 2 and the second server 3 by at least one of the first terminal 4 and the second terminal 5. This form of the authentication request is one example of a form in which the authentication processing is executed before the linking demand.

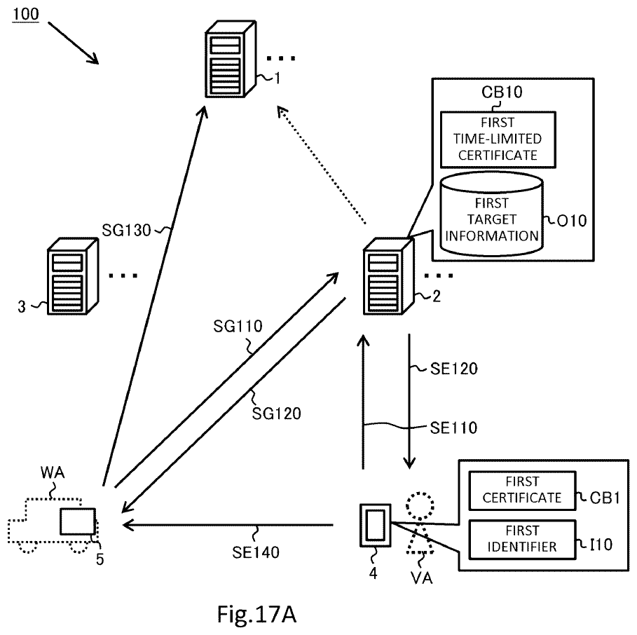

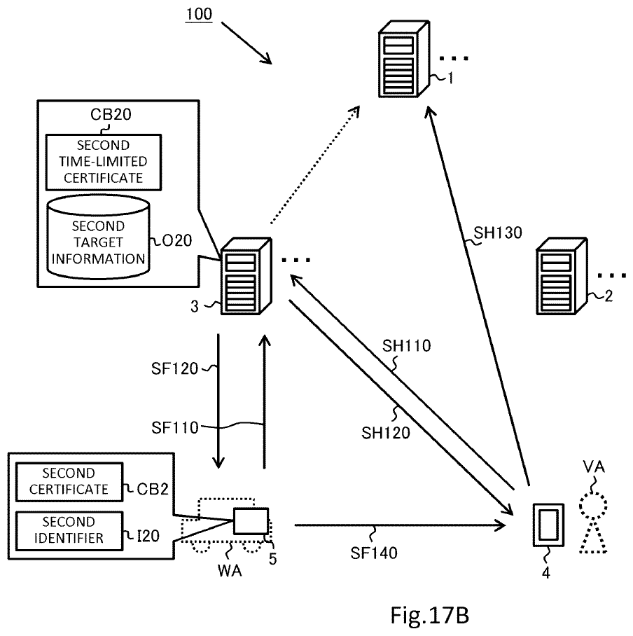

FIG. 17A schematically indicates one example of a processing process of linking setting in a case where the 3-2-th authentication method is employed. FIG. 17A assumes a scene in which the authentication processing of the first target VA is executed.

First, the processing in step SE110 and step SE120 may be executed between the first terminal 4 and the first server 2 in a similar manner to the processing in the 3-1-th authentication method described above. As a result of the execution, the first time-limited certificate CB10 is issued, and the first terminal 4 is notified of the issued first time-limited certificate CB10. In this event, the first server 2 may store the issued first time-limited certificate CB10 in association with the first identifier I10. The first time-limited certificate CB10 may be stored as the first target information O10. The notification (step SE130) to the management server 1 may be omitted. In step SE140, the controller 41 of the first terminal 4 provides the issued first time-limited certificate CB10 to the second terminal 5 as the first certificate CB1. Further, the first terminal 4 provides the first identifier I10 to the second terminal 5. In accordance with this, the second terminal 5 acquires the first identifier I10 and the first certificate CB1 from the first target VA.

In step SG110, the controller 51 of the second terminal 5 transmits the authentication request including the first identifier I10 and the first certificate CB1 to the first server 2. In accordance with receipt of the authentication request, the controller 21 of the first server 2 operates as the authentication unit 211 and collates the received first certificate CB1 and the corresponding first time-limited certificate CB10. The corresponding first time-limited certificate CB10 may be acquired as appropriate. In one example, the issued first time-limited certificate CB10 may be stored as the first target information O10, and the controller 21 of the first server 2 may extract the corresponding first time-limited certificate CB10 by searching the first target information O10 using the first identifier I10 as a query. In step SG120, the controller 21 of the first server 2 returns the collation result to the second terminal 5. In accordance with this, the controller 51 of the second terminal 5 receives the collation result.

In a case where collation of the first certificate CB1 and the first time-limited certificate CB10 is not successful in the received collation result, the controller 51 of the second terminal 5 may end the processing procedure of the linking setting as appropriate. The controller 51 may request retransmission of the first certificate CB1 to the first terminal 4. On the other hand, in a case where the collation is successful, the controller 51 transmits the linking demand including the first identifier I10 and the second identifier I20 to the management server 1 (step SG130). The processing in step SG130 is one example of the processing in step S10 described above.

In accordance with this, the management server 1 receives the linking demand from the second terminal 5. The controller 11 of the management server 1 sets the correspondence relation between the corresponding individual of the first target VA and the corresponding individual of the second target WA in response to the linking demand. The processing of setting the correspondence relation may be similar to that in the above-described embodiment. Note that a series of processing from data exchange (step SE140) to linking setting between the terminals (4, 5) may be executed in real time in accordance with occurrence of the use relation. Other configurations may be similar to those in the first authentication method and the like.

Note that an authentication target by the 3-2-th authentication method does not have to be limited to the first target VA. The second target WA may be authenticated using a similar method.

FIG. 17B schematically indicates another example of the processing process of the linking setting in a case where the 3-2-th authentication method is employed. FIG. 17B assumes a scene in which the authentication processing of the second target WA is executed. The processing procedure of FIG. 17B may be similar to the processing procedure of FIG. 17A except that the first target VA and the second target WA are replaced with each other. In other words, the second time-limited certificate CB20 is issued by the processing in step SF110 and step SF120 being executed between the second terminal 5 and the second server 3, and the second terminal 5 is notified of the issued second time-limited certificate CB20. In step SF140, the controller 51 of the second terminal 5 provides the issued second time-limited certificate CB20 to the first terminal 4 as the second certificate CB2. Further, the controller 51 of the second terminal 5 provides the second identifier I20 to the first terminal 4. In step SH110, the controller 41 of the first terminal 4 transmits the authentication request including the second identifier I20 and the second certificate CB2 to the second server 3. In accordance with this, the controller 31 of the second server 3 operates as the authentication unit 311 and executes collation processing of the second certificate CB2 and the second time-limited certificate CB20. In step SH120, the controller 31 of the second server 3 returns the collation result to the first terminal 4. In a case where collation of the second certificate CB2 and the second time-limited certificate CB20 is successful in the collation result, the controller 41 of the first terminal 4 transmits the linking demand including the first identifier I10 and the second identifier I20 to the management server 1 (step SH130). In accordance with this, the management server 1 receives the linking demand from the first terminal 4. The controller 11 of the management server 1 sets the correspondence relation between the corresponding individual of the first target VA and the corresponding individual of the second target WA in response to the linking demand.

In a case where a form similar to that in the above-described embodiment in which the authentication processing is omitted is employed, in the normal processing mode, authentication processing of the first target VA and the second target WA in FIG. 17A and FIG. 17B described above may be executed. On the other hand, in the simplified processing mode, authentication processing of at least one of the first target VA and the second target WA may be omitted.

In the 3-2-th authentication method, the authentication processing is executed before the linking demand in the normal processing mode. This can reduce processing load of the management server 1. Further, it is possible to shorten a processing period from the linking demand to the setting processing.

Note that the processing procedure in FIG. 17A and FIG. 17B is merely one example, and each step may be changed as far as possible. Further, in the above-described processing procedure, steps can be omitted, replaced, and added as appropriate in accordance with an embodiment. Processing order of the authentication of the first target VA and the authentication of the second target WA does not have to be particularly limited and may be determined as appropriate in accordance with an embodiment.

For example, the management server 1 may verify success in collation in the first server 2 as appropriate in the processing procedure of FIG. 17A. In one example, the first server 2 may transmit the collation result to the management server 1. For example, the above-described authentication request may further include the second identifier I20. In a case where the collation is successful, the first server 2 may transmit the collation result including the first identifier I10 and the second identifier I20 to the management server 1. By this means, the first server 2 may cause the management server 1 to activate the linking demand for a combination of the first identifier I10 and the second identifier I20 designated in the collation result. In other words, in one example, verification of success in collation may include reception of the collation result. The management server 1 may be configured to hold the collation result from the first server 2, accept a request for the linking setting for the combination of the first identifier I10 and the second identifier I20 designated in the collation result, and discard requests for linking setting for other combinations. In a similar manner, also in the processing procedure of FIG. 17B, the management server 1 may verify success in collation in the second server 3 as appropriate.

Further, in a similar manner to <4.1> described above, in the normal processing mode, the authentication processing of at least one of the first target VA and the second target WA by FIG. 17A and FIG. 17B described above may be executed. On the other hand, in the simplified processing mode, authentication of both the first target VA and the second target WA may be omitted.

Further, in the processing procedure of FIG. 17A and FIG. 17B, each server (2, 3) may transmit the authentication result to the management server 1 instead of returning the authentication result to each terminal (4, 5). This transmission form is one example of a form in which the linking demand is transmitted to the management server 1 by way of the external server and a form in which the authentication processing is executed along with the linking demand.

### (D) Fourth Authentication Method

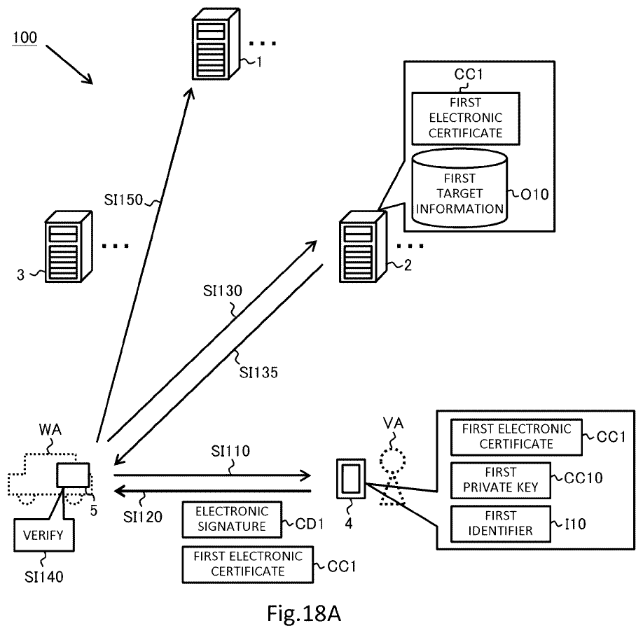

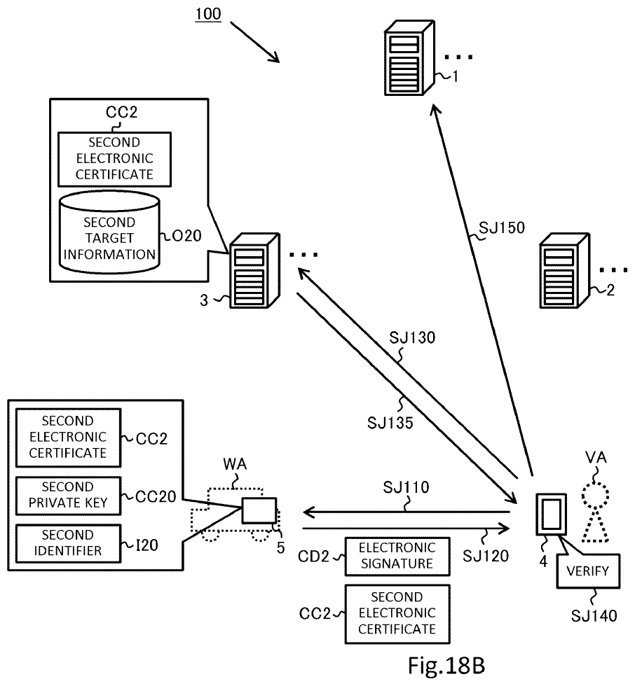

FIG. 18A schematically indicates one example of a processing process of linking setting in a case where a fourth authentication method is employed. The fourth authentication method uses an electronic signature and an electronic certificate using a private key. The authentication processing is executed by a terminal of a partner of the authentication target. The terminal of the partner of the authentication target is the second terminal 5 in a case where the first target VA is to be authenticated and is the first terminal 4 in a case where the second target WA is to be authenticated. FIG. 18A assumes a scene in which the authentication processing of the first target VA is executed.

As a preparation stage (pre-processing), a combination of a first private key CC10 and a first public key to be used for authentication of the first target VA is generated. A method for generating the first private key CC10 and the first public key does not have to be particularly limited and may be selected as appropriate in accordance with an embodiment. The first private key CC10 and the first public key may be generated by at least one of the first terminal 4 and an external computer (such as the first server 2 and certificate authority).

Next, a first electronic certificate CC1 for the first public key is generated by the certificate authority. In one example, the certificate authority may generate the first electronic certificate CC1 in response to a request from the first terminal 4. The certificate authority may be the first server 2 or an external server other than the first server 2. If authenticity of the first public key can be verified, a configuration of the first electronic certificate CC1 does not have to be particularly limited and may be selected as appropriate in accordance with an embodiment. In one example, the first electronic certificate CC1 may include an electronic signature by the certificate authority, possession information, and the first public key. The certificate authority holds a combination of the public key and the private key. The electronic signature by the certificate authority may be generated by encrypting the possession information and the first public key with a private key of the certificate authority. In a specific example, the electronic signature by the certificate authority may be generated by converting the possession information and the first public key into a hash value by a hash function and encrypting the obtained hash value with the private key of the certificate authority.

The first electronic certificate CC1 is provided to the first terminal 4 from the certificate authority. Further, the first electronic certificate CC1 may be stored in an arbitrary memory area. An expiration period of the first electronic certificate CC1 may be managed by a revocation list. The revocation list may be stored in an arbitrary memory area. The first electronic certificate CC1 and the revocation list may be stored in the first server 2 or may be stored in an external server that can be accessed from the first server 2. Preparation for the authentication processing of the first target VA is completed by the state becoming a state in which the first terminal 4 holds the first private key CC10 and the first electronic certificate CC1.

In a use stage, first, data exchange is executed (step SI110, SI120) between the corresponding first terminal 4 and the corresponding second terminal 5 upon occurrence of the use relation between the corresponding individual of the first target VA and the corresponding individual of the second target WA. In this data exchange, electronic information is shared between the first terminal 4 and the second terminal 5. The electronic information may include arbitrary information such as, for example, a random number and a timestamp. The electronic information may include, for example, information derived from the first target VA such as owner information of the first terminal 4.

The electronic information may be generated by at least one of the first terminal 4 and the second terminal 5. In a case where the second terminal 5 is involved with generation of at least part of the electronic information, data regarding the electronic information may be provided from the second terminal 5 to the first terminal 4 as the processing in step SI110. The controller 41 of the first terminal 4 generates an electronic signature CD1 by encrypting the first identifier I10 and the electronic information using the first private key CC10. In a specific example, the controller 41 of the first terminal 4 may generate the electronic signature CD1 by converting the first identifier I10 and the electronic information into a hash value using a hash function and encrypting the obtained hash value with the first private key CC10.

In step SI120, the controller 41 of the first terminal 4 provides the first identifier I10, the generated electronic signature CD1, and the first electronic certificate CC1 to the second terminal 5. By this means, the second terminal 5 acquires the first identifier I10, the electronic signature CD1, and the first electronic certificate CC1 from the first terminal 4. In a case where the first terminal 4 is involved with generation of at least part of the electronic information such as information derived from the first target VA, data regarding the electronic information may be provided from the first terminal 4 to the second terminal 5 as the processing in step SI120.

Then, the controller 51 of the second terminal 5 operates as the authentication unit 514 and verifies validity of the first electronic certificate CC1 (step SI130, step SI135). The example of FIG. 18A assumes a scene in which the first server 2 holds the revocation list. In step SI130, the controller 51 of the second terminal 5 inquires at the first server 2 as to whether or not the first electronic certificate CC1 is valid. In a case where the first electronic certificate CC1 is not registered in the revocation list, it is determined that the first electronic certificate CC1 is valid (that is, the expiration period has not elapsed). In a case where the first electronic certificate CC1 is registered in the revocation list, it is determined that the first electronic certificate CC1 is not valid. The first server 2 determines whether or not the first electronic certificate CC1 is valid with reference to the revocation list. In step SI135, the first server 2 returns the determination result to the second terminal 5. The controller 51 of the second terminal 5 may inquire at the first server 2 as to whether or not the first identifier I10 is valid. Note that in a case where an external server holds the revocation list, the controller 51 of the second terminal 5 may directly or indirectly (for example, by way of the first server 2) inquire at the external server as to whether or not the first electronic certificate CC1 is valid. Further, in another example, the controller 51 of the second terminal 5 may acquire the revocation list and determine whether or not the first electronic certificate CC1 is valid with reference to the acquired revocation list. In a case where the first electronic certificate CC1 is not valid (that is, the expiration period has elapsed), the controller 51 of the second terminal 5 may determine that verification of validity of the first electronic certificate CC1 is not successful and end the processing procedure of the linking setting as appropriate. The controller 51 of the second terminal 5 may request retransmission of a series of information to the first terminal 4. On the other hand, in a case where the first electronic certificate CC1 is valid, the controller 51 of the second terminal 5 acquires the public key of the certificate authority as appropriate. The controller 51 of the second terminal 5 decrypts the electronic signature of the certificate authority included in the first electronic certificate CC1 using the acquired public key. Then, the controller 51 of the second terminal 5 collates the obtained decrypted data and the remaining information (the possession information and the first public key) included in the first electronic certificate CC1. In a case where encryption is performed after conversion into a hash value, the controller 51 of the second terminal 5 converts the possession information and the first public key into a hash value by a hash function and collates the obtained hash value and the decrypted data. The controller 51 of the second terminal 5 determines that verification of validity of the first electronic certificate CC1 is successful in a case where both match in the collation and determines that verification of validity of the first electronic certificate CC1 is not successful in a case where both do not match.

Further, the controller 51 of the second terminal 5 operates as the authentication unit 514 and verifies validity of the electronic signature CD1 (step SI140). The controller 51 of the second terminal 5 decrypts the electronic signature CD1 using the first public key included in the first electronic certificate CC1. The controller 51 of the second terminal 5 collates the obtained decrypted data and the shared information (the first identifier I10 and the electronic information). In a case where encryption is performed after conversion into a hash value, the controller 51 of the second terminal 5 converts the shared information (the first identifier I10 and the electronic information) into a hash value by a hash function and collates the obtained hash value and the decrypted data. The controller 51 of the second terminal 5 determines that verification of validity of the electronic signature CD1 is successful in a case where both match in the collation and determines that verification of validity of the electronic signature CD1 is not successful in a case where both do not match.

In a case where verification of validity of both the first electronic certificate CC1 and the electronic signature CD1 is successful, authentication of the first target VA is successful. In this case, the controller 51 of the second terminal 5 transmits the linking demand including the first identifier I10 and the second identifier I20 to the management server 1 (step SI150). In accordance with this, the management server 1 receives the linking demand from the second terminal 5. The controller 11 of the management server 1 sets the correspondence relation between the corresponding individual of the first target VA and the corresponding individual of the second target WA in response to the linking demand. The processing of setting the correspondence relation may be similar to that in the above-described embodiment. Note that a series of processing from data exchange to linking setting between the terminals (4, 5) may be executed in real time in accordance with occurrence of the use relation. The processing in step SI150 is one example of the processing in step S10 described above. On the other hand, in a case where verification of validity of at least one of the first electronic certificate CC1 and the electronic signature CD1 is not successful, the second terminal 5 may end the processing procedure of the linking setting as appropriate. The second terminal 5 may request retransmission of a series of information to the first terminal 4.

Note that the authentication target by the fourth authentication method does not have to be limited to the first target VA, and the second target WA may be authenticated using a similar method.

FIG. 18B schematically indicates another example of the processing process of the linking setting in a case where the fourth authentication method is employed. FIG. 18B assumes a scene in which the authentication processing of the second target WA is executed. The processing procedure and respective pieces of data in FIG. 18B may be similar to the processing procedure and respective pieces of data in FIG. 18A except that the first target VA and the second target WA are replaced with each other. In other words, in a preparation stage, a combination of a second private key CC20 and a second public key is generated. Then, a second electronic certificate CC2 for a second public key is generated by the certificate authority. In one example, the second electronic certificate CC2 may include an electronic signature of the certificate authority, possession information, and the second public key. The second electronic certificate CC2 is provided from the certificate authority to the second terminal 5. In a use stage, data exchange is executed (step SJ110, step SJ120) between the corresponding first terminal 4 and the corresponding second terminal 5 upon occurrence of the use relation between the corresponding individual of the first target VA and the corresponding individual of the second target WA. In this data exchange, electronic information is shared between the first terminal 4 and the second terminal 5. The controller 51 of the second terminal 5 generates an electronic signature CD2 by encrypting the second identifier I20 and the electronic information using the second private key CC20. The controller 51 of the second terminal 5 provides the second identifier I20, the generated electronic signature CD2, and the second electronic certificate CC2 to the first terminal 4. By this means, the controller 41 of the first terminal 4 acquires the second identifier I20, the electronic signature CD2, and the second electronic certificate CC2. The controller 41 of the first terminal 4 operates as the authentication unit 414 and verifies validity of the second electronic certificate CC2 (step SJ130, step SJ135). Further, the controller 41 of the first terminal 4 operates as the authentication unit 414 and verifies validity of the electronic signature CD2 (step SJ140). In a case where verification of both the second electronic certificate CC2 and the electronic signature CD2 is successful, authentication of the second target WA is successful. In this case, the controller 41 of the first terminal 4 transmits the linking demand including the first identifier I10 and the second identifier I20 to the management server 1 (step SJ150). In accordance with this, the management server 1 receives the linking demand from the first terminal 4. The controller 11 of the management server 1 sets the correspondence relation between the corresponding individual of the first target VA and the corresponding individual of the second target WA in response to the linking demand. The processing of setting the correspondence relation may be similar to that in the above-described embodiment. On the other hand, in a case where verification of validity of at least one of the second electronic certificate CC2 and the electronic signature CD2 is not successful, the first terminal 4 may end the processing procedure of the linking setting as appropriate. The first terminal 4 may request retransmission of a series of information to the second terminal 5. In another example, the authentication processing of the first target VA and the second target WA may be executed by a series of processing in FIG. 18A and FIG. 18B being executed.

In a case where a form similar to the above-described embodiment in which the authentication processing is omitted is employed, in the normal processing mode, authentication processing of the first target VA and the second target WA by FIG. 18A and FIG. 18B described above may be executed. On the other hand, in the simplified processing mode, authentication processing of at least one of the first target VA and the second target WA may be omitted.

In the fourth authentication method, at least one of the first target VA and the second target WA is authenticated using the private key and the electronic certificate. By this means, it can be expected that security is maintained. Further, it can be expected that processing load of the management server 1 can be reduced by the authentication processing being performed on the terminal side before the linking demand. Further, it is possible to shorten a processing period from the linking demand to the setting processing.

Note that the processing procedure of FIG. 18A and FIG. 18B is merely one example, and each step may be changed as far as possible. Further, concerning the processing procedure described above, steps can be omitted, replaced, and added as appropriate in accordance with an embodiment. For example, in the processing procedure of FIG. 18A, processing order of the verification of the validity of the first electronic certificate CC1 (step SI130, step SI135) and the verification of the validity of the electronic certificate CD1 (step SI140) may be changed as appropriate. In another example, the verification of the validity of the electronic signature CD1 may be executed prior to the verification of the validity of the first electronic certificate CC1. Processing of verifying the validity of the first electronic certificate CC1 and processing of verifying the validity of the electronic signature CD1 may be executed at least partially in parallel. This similarly applies to a relation between the verification of the validity of the second electronic certificate CC2 and the verification of the validity of the electronic signature CD2.

Further, in a similar manner to <4.1> described above, in the normal processing mode, authentication processing of at least one of the first target VA and the second target WA in FIG. 18A and FIG. 18B described above may be executed. On the other hand, in the simplified processing mode, authentication processing of both the first target VA and the second target WA may be omitted.

### 5 SUPPLEMENTARY NOTE

The processing and means described in the present disclosure can be implemented freely in combination unless technical inconsistency occurs.

Further, the processing described as being performed by one device may be shared and executed by a plurality of devices. Alternatively, the processing described as being performed by different devices may be executed by one device.

In a computer system, what king of hardware configurations are used to implement respective functions may be flexibly changed.

The present disclosure can also be implemented by supplying a computer program having the functions described in the above-described embodiment to a computer and one or more processors of the computer reading out and executing the program. Such a computer program may be provided to the computer by a non-transitory computer-readable storage medium that can be connected to a system bus of the computer or may be provided to the computer via a network. The non-transitory computer-readable storage medium includes, for example, an arbitrary type of disk/disc such as a magnetic disk (such as a floppy (registered trademark) disk and a hard disk drive (HDD)) and an optical disc (such as a CD-ROM, a DVD disc, and a blue-ray disc), a read only memory (ROM), a random access memory (RAM), an EPROM, an EEPROM, a magnetic card, a flash memory, an optical card, and a semiconductor drive (such as a solid state drive), and an arbitrary type of medium suitable for storing an electronic command.

What is claimed is:

1. A system comprising:
a server;
a first terminal; and
a second terminal, wherein
at least one of the first terminal and the second terminal is configured to transmit a linking demand to the server,
the server is configured to activate a correspondence relation between the first terminal and the second terminal based on the linking demand, and
activating the correspondence relation includes
in a case where a predetermined condition is not satisfied,
acquiring authentication results of both the first terminal and the second terminal, and
activating the correspondence relation between the first terminal and the second terminal in accordance with success in authentication of both the first terminal and the second terminal in the acquired authentication results of the first terminal and the second terminal, and
in a case where the predetermined condition is satisfied,
omitting authentication of at least one terminal out of the first terminal and the second terminal and acquiring an authentication result of the other terminal, and
activating the correspondence relation between the first terminal and the second terminal in accordance with success in authentication of the other terminal in the acquired authentication result.

2. A system comprising:
a management server;
a first terminal of a first target; and
a second terminal of a second target, wherein
at least one of the first terminal and the second terminal is configured to transmit a linking demand to the management server in accordance with occurrence of a use relation between the first target and the second target,
the management server is configured to set a correspondence relation between the first target and the second target based on the linking demand, and
setting the correspondence relation includes
in a case where a predetermined condition is not satisfied,
acquiring authentication results of both the first target and the second target, and
setting the correspondence relation between the first target and the second target in accordance with success in authentication of both the first target and the second target in the acquired authentication results of the first target and the second target, and
in a case where the predetermined condition is satisfied,
omitting authentication of at least one target out of the first target and the second target and acquiring an authentication result of the other target, and
setting the correspondence relation between the first target and the second target in accordance with success in authentication of the other target in the acquired authentication result.

3. The system according to claim 2, wherein
the first target is a user,
the second target is an object to be used by the user, and
the predetermined condition includes a condition that the object to be used is an object to be repeatedly and constantly used by the user.

4. The system according to claim 2,
wherein the predetermined condition includes a condition that a correspondence relation has been set in the past for the same combination of the first target and the second target.

5. The system according to claim 2,
wherein the predetermined condition includes a condition that a type of at least one of the first target and the second target is a specific type.

6. The system according to claim 2,
wherein the predetermined condition includes a condition that a correspondence relation has been set in the past for the same combination of the first target and the second target, and a type of at least one of the first target and the second target is a specific type.

7. The system according to claim 6, wherein
the first target is a user,
the second target is an object to be used by the user, and
the type of at least one of the first target and the second target being the specific type includes that the object to be used is an object to be repeatedly and constantly used by the user.

8. The system according to claim 7,
wherein the object to be used is a mobile body.

9. The system according to claim 8,
wherein the object to be constantly used is an owner-driven car.

10. The system according to claim 2, wherein
the first target is a user,
the second target is an object to be used by the user, and
authentication of at least one target out of the first target and the second target in a case where the predetermined condition is satisfied is authentication of the object to be used, and authentication of the other target is authentication of the user.

11. The system according to claim 2,
wherein transmitting the linking demand to the management server includes directly transmitting the linking demand to the management server or indirectly transmitting the linking demand to the management server via an external server.

12. The system according to claim 2,
wherein whether or not authentication of the first target and the second target is successful is determined by the management server or an external server.

13. The system according to claim 2,
wherein the first terminal and the second terminal are configured to execute data exchange upon occurrence of the use relation between the first target and the second target.

14. The system according to claim 13,
wherein the data exchange is performed through short-range wireless communication.

15. The system according to claim 2, wherein
the first terminal comprises a positioning module,
the first terminal is further configured to measure a current position of the first terminal using the positioning module of the first terminal, and
transmit a measurement result of the current position of the first terminal to the management server,
the second terminal comprises a positioning module,
the second terminal is further configured to measure a current position of the second terminal using the positioning module of the second terminal, and
transmit a measurement result of the current position of the second terminal to the management sever, and
the management server is further configured to receive the measurement results of the current positions of the first terminal and the second terminal from the first terminal and the second terminal after setting the correspondence relation between the first target and the second target,
determine whether or not the received measurement results of the current positions of the first terminal and the second terminal satisfy a condition of the use relation in real time, and
maintain setting of the correspondence relation between the first target and the second target in a case where the measurement results of the current positions of the first terminal and the second terminal satisfy the condition of the use relation and release the correspondence relation in a case where the measurement results of the current positions of the first terminal and the second terminal do not satisfy the condition of the use relation.

16. A management server comprising:
a processor configured to execute setting of a correspondence relation between a first target and a second target based on a linking demand transmitted from at least one of a first terminal of the first target and a second terminal of the second target upon occurrence of a use relation between the first target and the second target, wherein
setting the correspondence relation includes
in a case where a predetermined condition is not satisfied,
acquiring authentication results of both the first target and the second target, and
setting the correspondence relation between the first target and the second target in accordance with success in authentication of both the first target and the second target in the acquired authentication results of the first target and the second target, and
in a case where the predetermined condition is satisfied,
omitting authentication of at least one target out of the first target and the second target and acquiring an authentication result of the other target, and
setting the correspondence relation between the first target and the second target in accordance with success in authentication of the other target in the acquired authentication result.

17. The management server according to claim 16, wherein
the first target is a user,
the second target is an object to be used by the user, and
the predetermined condition includes a condition that the object to be used is an object to be repeatedly and constantly used by the user.

18. The management server according to claim 16,
wherein the predetermined condition includes a condition that a correspondence relation has been set in the past for the same combination of the first target and the second target, and a type of at least one of the first target and the second target is a specific type.
